(19) United States
(12) Patent Application Publication
(10) Pub. No.: US 2011/0046293 A1
(43) Pub. Date: Feb. 24, 2011

(54) Light diffusion film, anti-reflection film, polarizing plate and image

(75) Inventor: Kenichi Fukuda, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/926,119

(22) Filed: Oct. 27, 2010

Related U.S. Application Data
(62) Division of application No. 11/407,995, filed on Apr. 21, 2006, now abandoned.

(30) Foreign Application Priority Data
Apr. 28, 2005 (JP) 2005-132238

(51) Int. Cl. C08L 27/12

(52) U.S. Cl. 524/544

(57) ABSTRACT

A light diffusion film is provided and includes: a transparent plastic film; a light diffusion layer formed from a curable composition containing a leveling agent ant particles having an average particle diameter of 1.0 μm to 15 μm, the light diffusion layer having an average thickness of 1.0 μm to 40 μm. The light diffusion film has a haze of 3% or more and point defects, which has a shape capable of surrounding a circle having a diameter of 100 μm in the average number of 2.0/10 m² or less.

### CROSS-REFERENCE TO RELATED APPLICATIONS

This application is a divisional of application Ser. No. 11/407,995, filed Apr. 21, 2006, which in turn claims priority to Japanese Application No. 2005-132238, filed Apr. 28, 2005, the entire content of each of which is incorporated herein by reference.

### FIELD OF THE INVENTION

The present invention relates to a light diffusion film free from point defects and an anti-reflection film comprising same. More particularly, the present invention relates to a polarizing plate and an image display device comprising such a light diffusion film or anti-reflection film.

### BACKGROUND OF THE INVENTION

An anti-reflection film is disposed on the surface of the screen of various image display devices such as liquid crystal display (LCD), plasma display panel (PDP), electroluminescence display (ELD) and cathode ray tube display (CRT) to prevent the drop of contrast due to the reflection of external light rays or image.

Since point defects present on optical films such as anti-reflection film to be disposed on the surface of display for this purpose cause remarkable deterioration of fidelity of the image display device in which such an optical film is incorporated, it is keenly desired to minimize point defects on the optical films. Accordingly, it is an important assignment for the optical film manufacturers to minimize the occurrence of point defects.

Among these optical films, a light diffusion film comprises a cured layer (light diffusion layer) containing particles such as resin beads having an average particle diameter of from about 2 μm to 5 μm stacked on a transparent substrate plastic film to have surface scattering or internal scattering properties for the purpose of preventing the reflection of external light or image or enlarging the viewing angle.

JP-A-2000-181053 focuses on impurities contained in fluorine-based leveling agents and defects in surface conditions. However, JP-A-2000-181053 merely discloses that the fluorine-based copolymer contained in the photosensitive layer for photosensitive lithographic printing is related to cissing, coating unevenness, etc. but has no reference to the correlation between the fluorine-based copolymer and the point defects on the light diffusion layer containing light diffusing particles.

### SUMMARY OF THE INVENTION

An object of the invention is to provide a light diffusion film free from point defects.

Another object of the invention is to provide an anti-reflection film comprising as a substrate a light diffusion film free from point defects.

A further object of the invention is to provide a point defect-free polarizing plate which has been subjected to anti-reflection treatment.

A further object of the invention is to provide a point defect-free image display device which has been subjected to anti-reflection treatment.

As a result of extensive studies, the inventors found out that when a film has particles unevenly distributed therein such that there occurs regions having a size of 100 μm or more where particles are sparsely populated, these regions have deteriorated light diffusion properties and thus become point defects that can be easily recognized. No reports have been made on studies of elimination of point defects attributed to the maldistribution of particles, particularly on studies of correlation to agents causing the maldistribution of particles contained in the coating solution, in the aforementioned light diffusion films having a light diffusion film containing particles. In other words, when a light diffusion layer containing particles having an average particle diameter of 1 μm or more is formed on a transparent plastic film substrate to produce a light diffusion film, the impurities contained in the leveling agent in the coating solution cause the particles to be maldistributed, resulting in the occurrence of point defects. In the case where this light diffusion film is used as, e.g., optical film for image display devices such as liquid crystal display, these point defects cause remarkable deterioration of fidelity of the image display devices. It was thus found that light diffusion films having a transparent plastic film as a substrate have an extremely important assignment to remove materials causing the maldistribution of particles in the coating composition for forming the light diffusion layer, thereby eliminating or minimizing these point defects.

The inventors also found that the aforementioned objects of the invention can be accomplished by removing leveling agent impurities from a leveling agent composition or a coating composition, particularly removing by-products rich with monomer having a high affinity for coating solution from a leveling agent synthesized from a monomer comprising a group having a high affinity for coating solution and a monomer comprising a group having a low affinity for coating solution. The invention has been thus worked out.

In other words, the invention provides a light diffusion film and an anti-reflection film having the following constitutions, a method for producing same and an image display device.

1. A light diffusion film comprising: a transparent plastic film; a light diffusion layer formed from a curable composition comprising a leveling agent and particles having an average particle diameter of 1.0 μm to 15 μm, the light diffusion layer having an average thickness of 1.0 μm to 40 μm, wherein the light diffusion film has a haze of 3% or more and point defects, which has a shape capable of surrounding a circle having a diameter of 100 μm, in the average number of 2.0/10 m² or less.

2. The light diffusion film as defined in Clause 1, wherein the average number of the point defects having a shape capable of surrounding a circle having a diameter of 100 μm is an average over a continuous area of 100 m² or more.

3. The light diffusion film as defined in Clause 1 or 2, wherein the average number of the particles having an average particle diameter of 1.0 μm to 15 μm present in a circle having a diameter of 100 μm within the point defects is less than ½ of the number of those particles present in a circle having a diameter of 100 μm within a normal portion.

4. The light diffusion film as defined in any one of Clauses 1 to 3, wherein the number of fluorine atoms and/or silica atoms detected present in a circle having a diameter of 50 μm within the point defects is twice or more the number of fluorine atoms and/or silica atoms detected present in a circle having a diameter of 50 μm within a normal portion at least 10 cm or more apart from the one of the point defects.

5. The light diffusion film as defined in any one of Clauses 1 to 3, wherein the number of fluorine atoms and/or silica atoms detected present in a circle having a diameter of 50 μm within the point defects is five or more times the number of fluorine atoms and/or silica atoms detected present in a circle having a diameter of 50 μm within a normal portion at least 10 cm or more apart from the point defect portion.

6. The light diffusion film as defined in any one of Clauses 1 to 3, wherein the number of fluorine atoms and/or silica atoms detected present in a circle having a diameter of 50 μm within the point defects is ten or more times the number of fluorine atoms and/or silica atoms detected present in a circle having a diameter of 50 μm within a normal portion at least 10 cm or more apart from the point defect portion.

7. The light diffusion film as defined in any one of Clauses 1 to 6, wherein the average number of the point defects is 1.0/10 m².

8. The light diffusion film as defined in any one of Clauses 1 to 6, wherein the average number of the point defects is 0.5/10 m².

9. The light diffusion film as defined in any one of Clauses 1 to 6, wherein the average number of the point defects is 0.2/10 m².

10. The light diffusion film as defined in any one of claims 1 to 9, wherein when the light diffusion film is wound up in a form having a width of 1 m or more and a length of 1,000 m or more and is continuously examined for defects over a length of at least 1,000 m, the average number of point defects having a shape surrounding a circle having a diameter of at least 100 μm attributed to a fluorine-based and/or silicone-based leveling agent is 1/100 m².

11. The light diffusion film as defined in any one of Clauses 1 to 10, wherein the leveling agent is a copolymer comprising: a repeating unit corresponding to monomer (i); and a repeating unit corresponding to monomer (ii), and the copolymer has an average copolymerization ratio of the monomer (i) of 10 to 60 mol-%:

(i) Fluoroaliphatic group-containing monomer represented by formula (1); and

(ii) Poly(oxyalkylene)acrylate and/or poly (oxyalkylene)methacrylate:

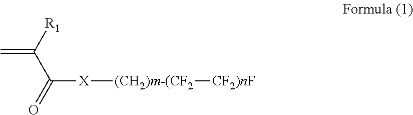

wherein R₁ represents a hydrogen atom or methyl group; X represents an oxygen atom, sulfur atom or —N(R₂)—; m represents an integer of 1 to 6; n represents an integer of 1 to 5; and R₂ represents a hydrogen atom or C₁-C₄ alkyl group.

12. The anti-reflection film as defined in Clause 11, wherein the leveling agent further comprises a repeating unit corresponding to monomer (iii):

(iii) Monomer represented by formula (2) copolymerizable with the monomers (i) and (ii):

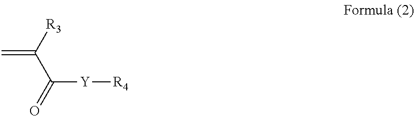

wherein R₃ represents a hydrogen atom or methyl group; Y represents a divalent connecting group; and R₄ represents a C₄-C₂₀ straight-chain, branched or cyclic alkyl group which may have substituents.

13. The light diffusion film as defined in Clause 11 or 12, wherein the copolymer is substantially free of copolymer component comprising a repeating unit corresponding to the monomer (i) in an amount of 70 mol-% or more.

14. The light diffusion film as defined in any one of Clauses 11 to 13, wherein the copolymer is a fluorine-based copolymer obtained by: synthesizing a fluorine copolymer; dissolving the fluorine copolymer in a solvent; and bringing the solution into contact with an inorganic adsorbent containing at least one of a silicon oxide, an aluminum oxide and a mixture thereof in an amount of 80% by weight or more so that the fluorine copolymer is purified.

15. The light diffusion film as defined in any one of Clauses 11 to 13, wherein the copolymer is a fluorine copolymer obtained by: synthesizing a fluorine copolymer; dissolving the fluorine copolymer in a solvent; and bringing the solution into contact with an organic adsorbent so that the fluorine copolymer is purified.

16. The light diffusion film as defined in Clause 15, wherein the organic adsorbent comprises a (modified) still-vinylbenzene copolymer or (meth)acrylic acid ester-based copolymer.

17. The light diffusion film as defined in any one of Clauses 11 to 13, wherein the copolymer is a fluorine copolymer obtained by: synthesizing a fluorine copolymer; dissolving the fluorine copolymer in a solvent, and filtering the solution through a filter having a pore diameter of 1 μm or less so that the fluorine copolymer is purified.

18. The light diffusion film as defined in any one of Clauses 1 to 7, wherein the particles having an average particle diameter of 1.0 μm to 15 μm are resin beads.

19. The light diffusion film as defined in Clause 18, wherein the resin beads have an average particle diameter of 3.0 μm to 4.0 μm.

20. The light diffusion film as defined in any one of Clauses 1 to 19, wherein the light diffusion layer is produced by: spreading a curable composition comprising a leveling agent, resin beads, a curable resin and an organic solvent; and drying and curing the curable composition.

21. The light diffusion film as defined in Clause 20, wherein the content of the leveling agent is from 0.01 to 1% by weight based on the solid content in the curable composition of the light diffusion layer.

22. The light diffusion film as defined in Clause 20 or 21, wherein the organic solvent comprises an organic solvent having a solubility parameter (SP value) of 9.5 or more.

23. The light diffusion film as defined in Clause 22, wherein the organic solvent comprises an organic solvent having a solubility parameter (SP value) of 9.5 or more in an amount of 5% by weight or more based on the total weight of the solvents.

24. The light diffusion film as defined in any one of Clauses 1 to 23, wherein the surface thereof has a roughened shape.

25. The light diffusion film as defined in any one of Clauses 1 to 24, having a haze of 10% or more.

26. The light diffusion film as defined in any one of Clauses 1 to 24, having a haze of 30% or more.

27. An anti-reflection film comprising: a light diffusion film defined in any one of Clauses 1 to 26; and a low refractive index layer having a refractive index of 1.31 to 1.49.

28. The anti-reflection film as defined in Clause 27, wherein the low refractive index layer comprises hollow particles.

29. The anti-reflection film as defined in Clause 28, wherein the hollow particles comprise hollow particulate silica.

30. A polarizing plate comprising: a polarizer; and two protective films for the polarizer, wherein at least one of the two protective films is a light diffusion film defined in any one of Clauses 1 to 26 or an anti-reflection film defined in Clause 27 or 29.

31. A polarizing plate comprising: a polarizer; and two protective films for the polarizer, wherein one of the two protective films is a light diffusion film defined in any one of Clauses 1 to 26 or an anti-reflection film defined in Clause 27 or 29, and the other of the two protective films is an optical compensation film having an optically anisotropy.

32. An image display device comprising a polarizing plate defined in Clause 30 or 31.

33. The image display device as defined in Clause 32, which is a transmission type, reflection type or transflective type liquid crystal display of any of TN, STN, IPS, VA and OCB modes.

In accordance with an exemplary embodiment of the invention, components rich with a group having a low affinity for coating solution which is a material causing the occurrence of point defects contained in a fluorine-based leveling agent or silicone-based leveling agent to be used in the light diffusion film are removed, making it possible to provide a light diffusion film free from point defects that is preferably used as a protective film for image display device.

### BRIEF DESCRIPTION OF THE DRAWINGS

FIG. 1 is a schematic sectional view diagrammatically illustrating the layer configuration of an anti-reflection film.

FIG. 2A is a schematic sectional view diagrammatically illustrating an exemplary embodiment of the application of an anti-reflection film to image display devices.

FIG. 2B is a schematic sectional view diagrammatically illustrating an exemplary embodiment of the application of an anti-reflection film to liquid crystal displays.

FIG. 3A is a schematic sectional view diagrammatically illustrating an exemplary embodiment of the application of an anti-reflection film to liquid crystal displays.

FIG. 3B is a schematic sectional view diagrammatically illustrating an exemplary embodiment of the application of an anti-reflection film to liquid crystal displays.

### DETAILED DESCRIPTION OF THE INVENTION

The light diffusion film with light diffusion layer of the invention will be further described hereinafter.

In general, a triacetyl cellulose (TAC) film to be used as substrate has a small optical anisotropy. It has thus been practiced to produce a light diffusion film for preventing the reflection of external light or image in image display devices such as liquid crystal display by spreading a light diffusion layer coating composition (coating solution) containing an ionizing radiation-curable resin, an organic solvent and light diffusing particles (resin beads, etc.) over a TAC film, drying the coat layer, and then curing the coat layer.

In order to improve the spreadability of the coating solution and provide the coating solution with uniformity in dryability and adaptability to high speed coating, it is effective to incorporate a fluorine-based leveling agent or silicone-based leveling agent in the coating solution. In general, these leveling agents have a group having a high affinity for coating solution and a group having a low affinity for coating solution in the same molecule. Examples of the group having a high affinity for coating solution include polyether groups and long-chain alkyl groups. Examples of the group having a low affinity for coating solution include perfluoro groups and polydimethyl siloxanes.

Therefore, these leveling agents can be synthesized by the copolymerization of a monomer having a group having a high affinity for coating solution and a polymerizable group in the same molecule and a monomer having a group having a low affinity for coating solution and a polymerizable group in the same molecule.

At the step of synthesis of these compounds, copolymers having a high proportion of components having a low affinity for coating solution and homopolymers and oligomers free of group having a high affinity for coating solution are produced as by-products. (These compounds will be occasionally referred simply to as “by-products”.) It is also thought that at the step of synthesis of monomer having a low affinity for coating solution, these monomers are polymerized to produce homopolymers or oligomers. In general, it is extremely difficult to remove the aforementioned by-products from these copolymers.

The inventors found that these by-products such as homopolymer cause the occurrence of point defects in the light diffusion layer containing light diffusing particles. The inventors presume the mechanism of the phenomenon as follows.

These by-products are rich with components containing a group having a low affinity for coating solution and thus have a low solubility in coating solution. Since the main product has a group having a low affinity for coating solution, i.e., group having a high affinity for by-products, the aforementioned by-products are uniformly dispersed in the main product in the state of leveling agent solution which is ready to be added to the coating solution. However, when the leveling agent solution is added to the coating solution, the concentration of the main product which has acted as a compatibilizer for the by-products and the coating solution is extremely lowered, causing the by-products to come in direct contact with the coating solution. The by-products have a low affinity for the coating solution and thus gradually form associations made of by-products alone, that is, move to stabler energy state.

When the coating solution is spread over the plastic film support, these associations then form spots having a high concentration of by-products on the coat layer. In the case where the coating solution contains resin beads as light diffusing particles, when the solvent is removed from the coating solution at the drying step, the resin beads leave away as if they roll down the concentration gradient of by-products. As a result, spots having a low density of resin beads and low light diffusion properties are formed over a wider area than a circle region having a diameter of 100 um on the dried coat layer. These spots are recognized as point defects. The resin beads which have left away occasionally are concentrated in some of point defects to form minute agglomerations.

The point defects thus formed have a lowered density of resin beads causing the diffusion of light and hence lower light diffusion properties than the normal area and thus are seen differently from the normal area when the light diffusion film for image display devices used as a display surface film is observed by reflected and/or transmitted light. Thus, these point defects cause remarkable deterioration of fidelity of the image display devices.

The driving force that causes the by-products to be concentrated in the coating solution to form associations is presumably attributed to the difference in polarity between the by-products and the coating solution. In general, a group having a low affinity for coating solution such as fluoro-substituted group has a low polarity. It is thus thought that such a group can easily form associations particularly when the coating solution contains a solvent having a high polarity. A coating solution containing a solvent having a high polarity and a solubility parameter (SP value) of 9.5 or more is remarkably inclined to this phenomenon. Examples of the solvents having a high polarity which are often used in coating solutions include cyclohexanone (SP value: 9.9).

In this light, a method which comprises the use of a coating solution free of solvent having a high polarity to eliminate point defects can be proposed. However, cyclohexanone is a solvent that can assure the adhesivity between the light diffusion layer and the triacetyl cellulose (TAC) film and can be easily handled because of its high boiling point and thus is often used for light diffusion layer coating solution in the case where TAC film is used as a substrate. It is thus difficult to exclude cyclohexanone.

An essential solution to this problem is to remove impurities having a high content of fluoroaliphatic group-containing monomers such as homopolymer present as by-products in such a leveling agent, particularly a leveling agent composed of fluorine-based copolymer. Examples of the method for removing impurities include a method which comprises removing them in the form of copolymer before being added to the coating solution (curable composition) and a method which comprises removing them after being added to the coating solution. It is more essential to remove then before being added to the coating solution.

More specifically, point defects can be drastically eliminated by the use of, as a leveling, a fluorine-based copolymer containing a repeating unit derived from fluoroaliphatic group-containing monomer represented by the formula (1) in a proportion of from 10 to 60 mol-% on the average but substantially free of copolymer component containing a repeating unit derived from fluoroaliphatic group-containing monomer in a proportion of 70 mol-% or more.

The term “substantially free of copolymer component containing a repeating unit derived from fluoroaliphatic group-containing monomer in a proportion of 70 mol-% or more” as used herein is meant to indicate that when components containing a repeating unit derived from fluoroaliphatic group-containing monomer in a high proportion are isolated from the leveling agent, no components having such a repeating unit in a proportion of 70 mol-% or more on the average can be detected, that is, these components can be detected in an amount of 0.1% or less.

It is effective to remove homopolymers contained in the monomer material produced during the synthesis of monomer which is a raw material of copolymer or remove homopolymers produced during the synthesis of copolymer. For the details of method for purifying a leveling agent which is a fluorine-based leveling agent, reference can be made to JP-A-2001-199953 and JP-A-2001-206952. In the invention, a fluorine-based leveling agent obtained by such a method involving the purification of surface active agent, too, can be used to advantage.

It was also confirmed that the application of the method for purifying a fluorine-based leveling agent for use in photosensitive lithographic printing plate disclosed in JP-A-2000-181053 to the light diffusion layer of the invention makes it possible to exert a remarkable effect. For the details of the purification method, reference will be made later.

The term “point defect” as used herein is meant to indicate one having a diameter of 100 μm or more that can be visually seen on the light diffusion layer. Such a point defect can be visually observed by transmitted or reflected light and is seen differently from the normal area. In order to observe such a point defect by transmitted or reflected light, methods assumed in various image display schemes are employed. In some detail, observation can be made under various light sources such as fluorescent lamp, tungsten lamp and artificial sunshine or by strong transmitted light or transmitted light under polarizing plate crossed Nicols depending on the usage of light diffusion film.

The term “region recognized as point defect (point defect region)” as used herein is meant to indicate a region that is seen differently from the normal area when observed visually by transmitted or reflected light. The point defects have various shapes such as circle, ellipsoid, rod and rectangle. However, these point defects are mostly in the form of trailing ellipsoid, ameba or the like. Therefore, the term “point defect” as used herein is meant to indicate a point defect having a size that can fully contain a circle having a diameter of 100 μm at minimum.

The average number of point defects on the light diffusion film of the invention is 2.0 or less per 10 m², preferably 1.0 or less per 10 m², more preferably 0.5 or less per 10 m², particularly preferably 0.2 or less per 10 m².

In the light diffusion film of the invention, the average number of the point defects preferably is an average a continuous area of 100 m² or more, more preferably 300 m² or more, still more preferably 1,000 m² or more.

These point defects can be roughly divided into two groups, i.e., point defect (foreign matter defect) having foreign matters as nuclei and point defect free of foreign matters as nuclei that can be recognized when observed visually or under optical microscope. The term “foreign matters as nuclei” as used herein is meant to indicate external foreign matters such as process dust, foreign matters from tailings of substrate film to be coated, insoluble matters and impurities in the raw material to be used in the coating solution, skinning product in the coating solution or foreign matters produced by solidification of components such as reaction product. The term “point defect having foreign matters as nuclei” as used herein is meant to indicate a point defect in which a solid matter having different components and composition ratios from the surrounding coat layer is observed. These foreign matters as nuclei can be identified by observing the surface or section of the light diffusion film under optical microscope or scanning type electron microscope.

On the other hand, the point defect free of foreign matters as nuclei can be seen as point defect when the film is visually examined but shows no foreign matters as nuclei when the surface or section of the point defect area is observed under optical microscope, electron microscope or the like.

The point defect of the invention particularly concerns one free of foreign matters as nuclei. However, agglomerated light diffusing particles are occasionally observed in the point defect.

The point defects occurring in the light diffusion film are attributed to fluorine-based and/or silicone-based leveling agents. These point defects are contained in the leveling agent as impurities. The components having a low affinity for coating solution are concentrated in spot form on the coat layer, causing the light diffusion layer to be maldistributed. Thus, areas having a low proportion of light diffusing particles are produced. These areas are shown having low light diffusion properties when visually observed by transmitted or reflected light.

Accordingly, these regions that can be recognized as point defects (point defect regions) have a lowered particle density. There are some areas where the number of light diffusing particles contained in a circle having a diameter of 100 μm in the point defect region is half or less the number of light diffusing particles contained in a circle having a diameter of 100 μm in the normal area. Referring to the number of particles having an average particle diameter of 1 μm to 15 μm in the invention, the number of particles corresponding to the interior having a diameter of 100 μm on a photograph of the light diffusion layer taken under optical microscope at 500× magnification can be counted to determine the point defects related to the invention.

As has been described, the point defects related to the invention have a siloxane group or fluorine, which has a low affinity for coating solution, concentrated therein. In order to observe the concentration of groups, TOF-SIMS (Time of Flight-Secondary Ion Mass Spectrometry) method can be used. For example, a Type TRJFTII TOF-SIMS (trade name) (produced by Phi Evans Inc.) can be used to detect fragments attributed to siloxane or fluorine substituents on the surface of point defects. For the details of TOF-SIMS method, reference can be made to “Hyoumen Bunseki Gijutsu Sensho—Niji Ion shitsuryou Bunsekiho”, compiled by Surface Science Society of Japan, Maruzen, 1999.

The point defects related to the invention can be identified also by detecting the number of fluorine atoms and/or silica atoms present in a circle having a diameter of 50 μm in the point defect region twice or more the number of fluorine atoms and/or silica atoms present in a circle having a diameter of 50 μm in a normal area 10 cm or more apart from the point defect region. When the point defects are worsened, the number of fluorine atoms and/or silica atoms are detected five or more times, more preferably 10 or more times that of the normal area.

The light diffusion film of the invention is preferably prepared by forming a light diffusion layer on a transparent substrate of continuous length. When the light diffusion film thus prepared is continuously examined for defects over at least 1,000 m while being wound in the form of a width of 1 m or more and a length of 1,000 m or more, the number of point defects, which has a shape capable of surrounding a circle having a diameter of 100 attributed to fluorine-based and/or silicone-based leveling agents is preferably 1/100 m² or less, more preferably 0.5/100 m² or less, and particularly preferably 0.3/100 m² or less.

### <Layer Configuration>

The light diffusion film of the invention or the anti-reflection film comprising the light diffusion film as a substrate may have the following known layer configuration.

Representative examples of the layer configuration include:

a: Transparent plastic film substrate/light diffusion layer
b: Transparent plastic film substrate/light diffusion layer/low refractive index layer

The aforementioned layer configuration (a) is an embodiment of the light diffusion film of the invention and the aforementioned layer configuration (b) is an embodiment of the anti-reflection film of the invention. In the embodiment (b), various layers may be provided interposed between the light diffusion layer and the low refractive index layer. Examples of these layers include high refractive index layer, middle refractive index layer, antistatic layer, moisture barrier, and adhesivity improving layer.

Examples of the layer which may be provided interposed between the transparent plastic film substrate and the layer closer to the surface than the transparent plastic film substrate include antistatic layer (to be provided in the case where there occurs a problem of attachment of dust to the surface, etc. if it is required that the surface resistivity from the display side be lowered), hard coat layer (to be provided in the case where the hardness is insufficient due to the provision of light diffusion layer alone), moisture barrier, adhesivity improving layer, and interference pattern inhibiting layer (to be provided in the case where there is a difference in refractive index between the substrate and the light diffusion layer).

The antistatic layer may be disposed at sites other than between the substrate and the overlying layer.

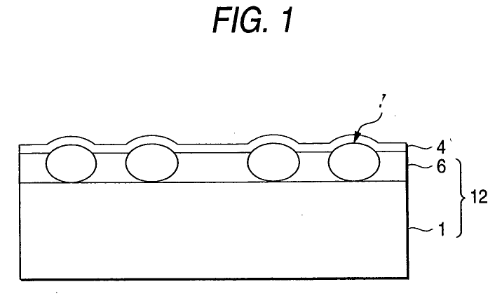

Embodiments of the anti-reflection film of the invention will be described hereinafter in connection with the attached drawings. FIG. 1 is a sectional view diagrammatically illustrating a preferred embodiment of the anti-reflection film of the invention.

The embodiment shown in FIG. 1 has a layer configuration comprising a transparent plastic film substrate 1, a light diffusion layer 6 and a low refractive index layer (outermost layer) 4 stacked on each other in this order. Particles 7 contained in the light diffusion layer are particles having an average particle diameter of 1 μm to 15 μm.

In the embodiment shown in FIG. 1, the transparent plastic film substrate 1 and the low refractive index layer 4 each have a refractive index satisfying the following relationship. In other words, the transparent plastic film substrate has a greater refractive index than the low refractive index layer.

In the layer configuration as shown in FIG. 1, the low refractive index layer 4 preferably satisfies the following numeral expression (I) to form an excellent anti-reflection film.

(m₇λ/4)×0.7<n₇d₇<(m₇λ/4)×1.3 (I)

wherein m₇ represents a positive odd number (normally 1); n₇ represents the refractive index of the low refractive index layer; d₇ represents the thickness (nm) of the low refractive index layer; and λ represents the wavelength of visible light falling within a range of from 380 nm to 680 nm.

The transparent plastic film substrate will be further described hereinafter.

### <Transparent Plastic Film Substrate (Transparent Substrate)>

Examples of the transparent plastic film to be used as the substrate of the light diffusion film of the invention include cellulose ester cellulose acylates (e.g., triacetyl cellulose, diacetyl cellulose, propionyl cellulose, butyryl cellulose, acetyl propionyl cellulose, nitrocellulose), polyamides, polycarbonates, polyesters (e.g., polyethylene terephthalate, polyethylene naphthalate, poly-1,4-cyclohexane dimethylene terephthalate, polyethylene-1,2-diphenoxyethane-4,4′-dicarboxylate, polybutylene terephthalate), polystyrenes (e.g., syndiotactic polystyrene), polyolefins (e.g., polypropylene, polyethylene, polymethyl pentene), polysulfones, polyethersulfones, polyallylates, polyetherimides, polymethyl methacrylates, and polyetherketones. Preferred among these materials are triacetyl cellulose, polycarbonates, polyethylene terephthalates and polyethylene naphthalates. In particular, in the case where the anti-reflection film is used in liquid crystal display, triacetyl cellulose is preferably used.

In the case where the transparent substrate is a triacetyl cellulose acylate film, a triacetyl cellulose acylate film prepared by subjecting a triacetyl cellulose acylate dope prepared by dissolving a triacetyl cellulose acylate in a solvent to any casting method such as single-layer casting method and multi-layer casting method is preferably used.

In particular, a triacetyl cellulose acylate film prepared from a triacetyl cellulose acylate dope prepared by dissolving a triacetyl cellulose acylate in a solvent substantially free of dichloromethane by a low temperature or high temperature dissolution method is preferred from the standpoint of environmental protection.

The triacetyl cellulose acylate film which is preferably used in the invention is exemplified in Japan Institute of Invention and Innovation's Kokai Giho No. 2001-1745.

The thickness of the aforementioned transparent substrate is not specifically limited but is preferably from 1 μm to 300 μm, preferably from 30 μm to 150 μm, particularly from 40 μm to 120 μm, most preferably from 40 μm to 100 μm.

The light transmittance of the transparent substrate is preferably 80% or more, more preferably 86% or more.

The haze of the transparent substrate is preferably as low as possible, more preferably 2.0% or less, even more preferably 1.0% or less.

The refractive index of the transparent substrate is preferably from 1.40 to 1.70.

The transparent plastic film substrate to be used in the light diffusion film of the invention is preferably used in the form of web. In order to eliminate coating streak defects, a transparent plastic film web having a roughened portion having a central line average roughness (Ra) of not greater than 1 μm or greater than 1 μm over a continuous length of less than 10 cm along the spreading direction is preferably used. More preferably, the central line average roughness (Ra) is from 0 μm to 0.8 μm and the aforementioned continuous roughened portion extends over less than 5 cm.

The transparent substrate may comprise an infrared adsorbent or ultraviolet adsorbent incorporated therein. The added amount of the infrared adsorbent is preferably from 0.01% to 20% by weight, more preferably from 0.05% to 10% by weight based on the weight of the transparent substrate.

The transparent substrate may further comprise an inactive inorganic particulate compound incorporated therein as a lubricant. Examples of the inorganic compound employable herein include SiO₂, TiO₂, BaSO₄, CaCO₃, talc, and kaolin.

The transparent substrate may be subjected to surface treatment. Examples of the surface treatment include chemical treatment, mechanical treatment, corona discharge treatment, flame treatment, ultraviolet irradiation, high frequency treatment, glow discharge treatment, active plasma treatment, laser treatment, mixed acid treatment, and ozone oxidation. Preferred among these surface treatments are glow discharge treatment, ultraviolet irradiation, corona discharge treatment and flame treatment. Particularly preferred among these surface treatments are glow discharge treatment and corona discharge treatment.

The light diffusion layer will be further described hereinafter.

### <Light Diffusion Layer>

The term “diffusion film” as used herein is meant to indicate a film having a haze of 3% or more. Haze may be attributed to either or both of surface scattering and internal scattering.

The haze can be measured according to JIS-K7136.

The light diffusion layer is formed for the purpose of providing the film with hard coat properties for enhancing surface scattering properties or internal scattering properties, preferably scratch resistance. Accordingly, a coating solution for the light diffusion layer comprises a curable resin capable of providing hard coat properties, a light diffusing particles for providing light diffusion properties, a leveling agent for enhancing spreadability, uniformalizing dryability and providing adaptability for high speed spreading and an organic solvent.

### <Light Diffusing Particles>

The average particle diameter of the light diffusing particles to be used in the light diffusion film of the invention is preferably from 1.0 μm to 15 μm, more preferably from 2.0 μm to 10.0 μm, even more preferably from 3.0 μm to 8.0 μm. When the average particle diameter of the light diffusing particles falls below 1.0 μm, the distribution of angle of light scattering is wide, causing the blurring of letters on the display to disadvantage. On the other hand, when the average particle diameter of the light diffusing particles exceeds 15 μm, it is necessary that the thickness of the light diffusion layer be raised, giving problems such as increased curling and added material cost.

Specific examples of the light diffusing particles include particulate resins (preferably in the form of bead) such as particulate poly(meth)acrylate, particulate crosslinked poly(meth)acrylate, particulate polystyrene, particulate crosslinked polystyrene, particulate poly(acryl-styrene), particulate melamine resin and particulate benzoguanamine resin. Preferred among these particulate resins are particulate crosslinked polystyrene, particulate crosslinked poly(meth)acrylate, and particulate crosslinked poly(acryl-styrene). By properly adjusting the refractive index of the curable resin according to that of the light diffusing particles selected from the aforementioned group, the internal haze, surface haze and central line average roughness can be adjusted to a preferred range. In some detail, a combination of a curable resin (refractive index after curing: 1.50 to 1.53) mainly composed of a trifunctional or higher (meth)acrylate monomer and a light diffusing particles composed of a crosslinked poly(meth)acrylate polymer having an acryl content of from 50 to 100% by weight is preferably used. In particular, a combination of the aforementioned curable resin and a light diffusing particles (refractive index: 1.48 to 1.54) composed of a crosslinked poly(styrene-acryl) copolymer is preferably used.

The distribution of particle diameter of the light diffusing particles is preferably sharp. The S value indicating the distribution of particle diameter of the particles is represented by the following equation and is preferably 2.0 or less, more preferably 1.0 or less, particularly preferably 0.7 or less.

S=[D(0.9)−D(0.1)]/D(0.5)

wherein D(0.1) represent 10% of integrated value of particle diameter calculated in terms of volume; D(0.5) represent 50% of integrated value of particle diameter calculated in terms of volume; and D(0.9) represent 90% of integrated value of particle diameter calculated in terms of volume.

Two or more light diffusing particles having different particle diameters may be used in combination. A light diffusing particles having a large particle diameter may be used to provide anti-glare properties while a light diffusing particles having a small particle diameter may be used to eliminate surface roughness.

The aforementioned light diffusing particles is incorporated in the light diffusion layer thus formed in an amount of from 3 to 30% by weight, preferably from 5 to 20% by weight based on the total solid content in the light diffusion layer. When the content of the light diffusing particles falls below 3% by weight, the resulting light diffusion layer lacks light diffusion properties. When the content of the light diffusing particles exceeds 30% by weight, the resulting light diffusion layer is subject to problems such as blurred image and surface clouding and glittering.

The density of the light diffusing particles is preferably from 10 to 1,000 mg/m², more preferably from 100 to 700 mg/m².

The refractive index of the curable resin with respect to the light diffusing particles in the invention is preferably from 1.45 to 1.70, more preferably from 1.48 to 1.65. In order to predetermine the refractive index within the aforementioned range, the kind and mixing proportion of the curable resin and the light diffusing particles may be properly predetermined. How to predetermine these factors can be easily and previously known experimentally.

In the invention, the absolute value of difference in refractive index between the curable resin and the light diffusing particles (refractive index of light diffusing particles—refractive index of curable resin) is preferably from 0.001 to 0.030, more preferably from 0.001 to 0.020, even more preferably from 0.001 to 0.015. When this difference exceeds 0.030, the resulting light diffusion film is subject to problems such as blurred letters, lowered dark room contrast and surface clouding.

For the quantitative evaluation of the refractive index of the curable resin, the refractive index of the curable resin is directly measured by means of an Abbe refractometer. Alternatively, the curable resin may be subjected to reflection spectroscopy or spectral ellipsometry. For the measurement of the refractive index of the light diffusing particles, two solvents having different refractive indexes are mixed in various mixing proportions to prepare solvents having various refractive indexes. The light diffusing particles is then dispersed in each of these solvents in the same amount. These solvents are each then measured for turbidity. The solvent the turbidity of which is found to be minimum is then measured for refractive index by means of an Abbe refractometer.

The thickness of the light diffusion layer is preferably from 1.0 μm to 40 μm, more preferably from 2.0 μm to 30 μm, still more preferably from 3.0 μm to 20 μm. When the thickness of the light diffusion layer is too small, the resulting light diffusion film lacks hardness. When the thickness of the light diffusion layer is too great, the resulting light diffusion film exhibits deterioration curling resistance or embrittlement resistance and thus may exhibit a deteriorated workability. Thus, the thickness of the light diffusion layer preferably falls within the aforementioned range.

### <Curable Resin>

The curable resin is preferably a binder polymer having a saturated hydrocarbon chain or polyether chain as a main chain, more preferably a binder polymer a saturated hydrocarbon chain as a main chain. The binder polymer preferably has a crosslinked structure.

The binder polymer which has a saturated hydrocarbon chain as a main chain is preferably a polymer of ethylenically unsaturated monomers. The binder polymer having a saturated hydrocarbon chain as a main chain and a crosslinked structure is preferably a (co)polymer of monomers having two or more ethylenically unsaturated groups.

In order to provide the binder polymer with a higher refractive index, a high refractive index monomer comprising an aromatic ring or at least one atom selected from the group consisting of halogen atoms other than fluorine, sulfur atom, phosphorus atom and nitrogen atom in the monomer structure or a monomer having a fluorenone skeleton in its molecule may be selected.

Examples of the monomer having two or more ethylenically unsaturated groups include esters of polyvalent alcohols with (meth)acrylic acids [e.g., ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-chlorohexane tetramethacrylate, polyurethane polyacrylate, polyester polyacrylate], ethylene oxide-modification products or caprolactone-modification products thereof, vinylbenzene and derivatives thereof [e.g., 1,4-vinylbenzene, 4-vinylbenzoic acid-2-acryloyl ethylester, 1,4-vinylcyclohexanone], vinylsulfones [e.g., divinylsulfone], acrylamides [e.g., methylene bisacrylamide], and methacrylamides. These monomers may be used in combination of two or more thereof.

Specific examples of the high refraction monomers include (meth)acrylates having fluorene skeleton, bis(4-methacryloylthiophenyl)sulfide, vinyl naphthalene, vinyl phenyl sulfide, and 4-methacryloxy phenyl-4-methoxyphenylthioether. These monomers, too, may be used in combination of two or more thereof.

The polymerization of these monomers having ethylenically unsaturated groups may be carried out by irradiation with ionizing radiation or heating in the presence of a photoradical polymerization initiator or heat radical polymerization initiator.

Accordingly, the aforementioned light diffusion layer can be formed by preparing a coating solution containing a curable resin-forming monomer (curable resin) such as the aforementioned ethylenically unsaturated monomer, a photoradical polymerization initiator or heat radical polymerization initiator, a light diffusing particles, a leveling agent described later, and optionally an inorganic filler described later, spreading the coating solution over a transparent substrate, and then subjecting the coated material to polymerization reaction by ionizing radiation or heat so that it is cured.

Examples of the photoradical polymerization initiator employable herein include acetophenones, benzoins, benzophenones, phosphine oxides, ketals, anthraquinones, thioxanthones, azo compounds, peroxides, 2,3-alkyldione compounds, disulfide compounds, fluoroamine compounds, aromatic sulfoniums, lophine dimers, onium salts, borates, active esters, active halogens, inorganic complexes, and coumarines.

Examples of the acetophenones include 2,2-ethoxyacetophenone, 2,2-diethoxyacetophenone, p-methylacetophenone, 1-hydroxy-dimethylphenylketone, 1-hydroxy-dimethyl-p-isopropylphenyl ketone, 1-hydroxycyclohexyl phenylketone, 2-methyl-4-methylthio-2-morpholinopropiophenone, 2-benzyl-2-dimethylamino-1-(4-morpholinophenyl)-butanone, 4-phenoxydichloroacetophenone, and 4-t-butyl-dichloro acetophenone.

Examples of the benzoins include benzoin, benzoinmethyl ether, benzomethyl ether, benzoinisopropyl ether, benzyldimethyl ketal, benzoinbenzenesulfonic acid ester, benzoin toluenesulfonic acid ester, benzoinmethyl ether, benzomethyl ether, and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone), and 3,3′,4,4′-tetra(t-butylperoxycarbonyl)benzophenone.

Examples of the phosphine oxides include 2,4,6-trimethylbenzoyl diphenyl phosphine oxide.

Examples of the active esters include 1,2-octanedione, 1-[4-(phenylthio)-,2-(O-benzoyloxim)], sulfonic acid esters, and cyclic active ester compounds. Examples of the onium salts include aromatic diazonium salts, aromatic iodonium salts, and aromatic sulfonium salts.

Examples of the borates include ionic complexes with cationic dyes.

As the active halogens there have been known S-triazine and oxathiazole compounds. Examples of these compounds include 2-(p-methoxyphenyl)-4-,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetoacetate)amino)phenyl)-4,6-bis(trichloromethyl)-s-triazine, and 2-trihalomethyl-5-(p-methoxyphenyl)-1,3,4-oxanediazole.

Examples of the inorganic complexes include bis (η⁵-2,4-cyclopentadiene-1-il)-bis(2,6-difluoro-3-(1H-pyrrole-1-il)phenyl)titanium.

Examples of the coumarines include 3-ketocoumarine.

These initiators may be used singly or in admixture.

Various examples are disclosed also in Kazuhiro Takausu, “Saishin UV Koka Gijutsu (Modern UV-curing Technique)”, TECHNICAL INFORMATION INSTITUTION CO., LTD., page 159, 1991.

Preferred examples of commercially available photo-cleavable photoradical polymerization initiators include Irgacure (651, 184, 819, 907, 1870 (CGI-403/Irg184=7/3), 500, 369, 1173, 2959, 4265, 4263) and OXE01, produced by Ciba Specialty Chemicals Co., Ltd., KAYACURE (DETX-S, BP-100, BDMK, CTX, BMS, 2-EAQ, ABQ, CPTX, EPD, ITX, QTX, BTC, MCA), produced by Nippon Kayaku Corporation, and Escacure (KIP100F, KB1, EB3, BP, X33, KT046, KT37, KIP150, TZT), produced by Sartomer Company.

The photopolymerization initiator is preferably used in an amount of from 0.1 to 15 parts by weight, more preferably from 1 to 10 parts by weight based on 100 parts by weight of polyfunctional monomer.

In addition to the photopolymerization initiator, a photosensitizer may be used. Specific examples of the photosensitizer employable herein include n-butylamine, triethylamine, tri-n-butylphosphine, Michler's ketone, and thioxanthone.

One or more auxiliaries such as azide compound, thiourea compound and mercapto compound may be used in combination.

Examples of the commercially available photosensitizers include KAYACURE (DMBI, EPA), produced by Nippon Kayaku Corporation.

As the heat radical polymerization initiator there may be used an organic or inorganic peroxide, an organic azo or diazo compound or the like.

Specific examples of organic peroxides include benzoyl peroxide, halogen benzoyl peroxide, lauroyl peroxide, acetyl peroxide, dibutyl peroxide, cumene hydroxperoxide, and butyl hydroperoxide. Specific examples of inorganic peroxides include hydrogen peroxide, ammonium persulfate, and potassium persulfate. Specific examples of azo compounds include 2,2′-azobis (isobutylonitrile), 2,2′-azobis(propionitrile), and 1,1′-azobis(cyclohexanecarbonitrile). Specific examples of diazo compounds include diazoaminobenzene, and p-nitrobenzenediazonium.

The polymer having a polyether as a main chain is preferably a ring-opening polymerization product of polyfunctional epoxy compound. The ring-opening polymerization of polyfunctional epoxy compound can be carried out by irradiation with ionizing radiation or heating in the presence of a photo-acid generator or heat-acid generator.

Accordingly, a coating solution containing a polyfunctional epoxy compound, a photo-acid generator or heat-acid generator, a light diffusing particles, a leveling agent described later and an inorganic filler is prepared. The coating solution thus prepared is spread over a transparent substrate, and then irradiated with ionizing radiation or heated to undergo polymerization reaction and curing leading to the formation of a light diffusion layer.

Instead of or in addition to the incorporation of monomer having two or more ethylenically unsaturated groups, a monomer having a crosslinkable functional group may be used to incorporate a crosslinkable functional group in the polymer whereby the reaction of the crosslinkable functional group causes the incorporation of a crosslinked structure in the binder polymer.

Examples of the crosslinkable functional group include isocyanate groups, epoxy groups, aziridine groups, oxazoline groups, aldehyde groups, carbonyl groups, hydrazine groups, carboxyl groups, methylol groups, and active methylene groups. A vinylsulfonic acid, an acid anhydride, a cyano acrylate derivative, a melamine, an etherified methylol, an ester, an urethane or a metal alkoxide such as tetramethoxysilane may be used as a monomer for the incorporation of a crosslinked structure. A functional group which exhibits crosslinkability as a result of decomposition reaction such as blocked isocyanate group may be used. In other words, the crosslinkable functional group to be used in the invention may be not immediately reactive but may be reactive as a result of decomposition reaction.

These binder polymers having a crosslinkable functional group may form a crosslinked structure when heated after being spread.

In order to adjust the refractive index thereof so that the have value attributed to internal scattering is reduced, the light diffusion layer may contain an inorganic filler made of an oxide of at least one metal selected from the group consisting of silicon, titanium, zirconium, aluminum, indium, zinc, tin and antimony having an average primary particle diameter of 0.2 μm or less, preferably 0.1 μm or less, more preferably 0.06 μm or less in addition to the aforementioned light diffusing particles. The inorganic filler normally has a higher specific gravity than organic materials and thus can enhance the density of the coating composition, making it possible to exert an effect of retarding the sedimentation of the light diffusing particles.

The inorganic filler to be used in the light diffusion layer is preferably subjected to silane coupling treatment or titanium coupling treatment on the surface thereof. A surface treatment agent having a functional group capable of reacting with the binder seed on the surface of the filler is preferably used.

The amount of these inorganic fillers to be added is preferably from 10% to 90%, more preferably from 20% to 80%, particularly from 30% to 75% based on the total weight of the light diffusion layer.

The inorganic filler has a particle diameter sufficiently smaller than the wavelength of light and thus causes no scattering. The dispersion having these fillers dispersed in a binder polymer acts as an optically uniform material.

The light diffusion layer may also comprise an organosilane compound incorporated therein. The added amount of the organosilane compound is preferably from 0.001 to 50% by weight, more preferably from 0.01 to 20% by weight, even more preferably from 0.05 to 10% by weight, particularly preferably from 0.1 to 5% by weight based on the total solid content in the layer in which it is incorporated.

### <Leveling Agent for Light Diffusion Layer>

The light diffusion layer coating solution of the invention comprises either or both of fluorine-based and silicone-based leveling components (also referred to as “fluorine-based leveling agent” and “silicon-based leveling agent”, respectively) incorporated therein to improve spreadability, uniformalize dryability and provide adaptability to high speed spreading.

Preferred examples of the silicone-based leveling agent include those containing a plurality of dimethyl silyloxy units as repeating units and having substituents at the end of chain and/or in side chains thereof. The compound chain containing dimethyl silyloxy as repeating unit may contain structural units other than dimethyl silyloxy. The substituents may be the same or different. It is preferred that there be a plurality of substituents. Preferred examples of the substituents include groups containing acryloyl group, methacryloyl group, vinyl groups, aryl group, cinnamoyl group, epoxy group, oxetanyl group, hydroxyl group, fluoroalkyl group, polyoxyalkylene group, carboxyl group, amino group, etc.

The molecular weight of the silicone-based leveling agent is not specifically limited but is preferably 100,000 or less, particularly 50,000 or less, most preferably from 3,000 to 30,000. The content of silicon atoms in the silicone-based leveling agent, too, is not specifically limited but is preferably 18.0% by weight or more, particularly from 25.0 to 37.8% by weight, most preferably from 30.0 to 37.0% by weight.

Preferred examples of the silicone-based leveling agent include those disclosed in JP-A-2004-42278, paragraph [0068]. However, the invention is not limited to these compounds.

As the fluorine-based leveling agent there is preferably used a compound having a fluoroalkyl group. The fluoroalkyl group preferably has from 1 to 20 carbon atoms, more preferably from 1 to 10 carbon atoms, and may have a straight-chain structure [e.g., —CF₂CH₃, —CH₂(CF₂)₄H, —CH₂(CF₂)₈CF₃, —CH₂CH₂(CF₂)₄H], a branched structure [e.g., —CH(CF₃)₂, —CH₂CF(CF₃)₂, —CH(CH₃)CF₂CF₃, —CH(CH₃)(CF₂)₅CF₂H] or an alicyclic structure (preferably 5-membered or 6-membered ring such as perfluorocyclohexyl group, perfluorocyclopentyl group or alkyl group substituted thereby). The fluoroalkyl group may had an ether bond (e.g., —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H). A plurality of the fluoroalkyl groups may be incorporated in the same molecule.

The fluorine-based compound may be used in the form of polymer or oligomer with a fluorine-free compound. The fluorine-based compound may be used without any limitation on the molecular weight. The content of fluorine atoms in the fluorine-based compound is not specifically limited but is preferably 20% by weight or more, particularly from 30 to 70% by weight, most preferably from 40 to 70% by weight. Preferred examples of the fluorine-based compound include R-2020, M-2020, R3833 and M-3833 (produced by DAIKIN INDUSTRIES, Ltd.), and Megafac F-171, Megafac F-172, Megafac F-179A, Megafac F-780F, Diffenser MCF-300 (produced by DAINIPPON INK AND CHEMICALS, INCORPORATED). However, the invention is not limited to these products.

Among these additives, the fluoroalkyl group-containing copolymer is particularly preferably incorporated in the coating composition. The fluoroalkyl group-containing copolymer is desirable because it can exert an effect of eliminating surface defects such as coating unevenness, drying unevenness and point defect of optical film even when used in a smaller amount.

In order to form a film such as low refractive index layer on the coat layer, the additive preferably contains substituents contributing to the formation of bond to the low refractive layer or the compatibility with the low refractive layer. These substituents may be the same or different. It is preferred that there be a plurality of these substituents. Preferred examples of these substituents include acryloyl group, methacryloyl group, vinyl group, aryl group, cinnamonyl group, epoxy group, oxetanyl group, hydroxyl group, polyoxyalkylene group, carboxyl group, and amino group.

It is also preferred that the structure of the following fluoroalkyl group-containing copolymer be properly selected to cause the copolymer maldistributed on the surface of the functional layer to be extracted with the solvent of the upper layer during the spreading of the upper layer coating solution (e.g., low refractive index layer) so that the copolymer is not present on the surface of the functional layer (interface of functional layer) during the formation of the anti-reflection film of the invention. Further, the adjustment of the added amount of the fluoroaliphatic group-containing copolymer, too, is effective for the enhancement of the aforementioned effect.

In some detail, a fluoroaliphatic group-containing copolymer containing a fluoroaliphatic group-containing monomer polymerizing unit in an amount of 10% by weight or more is added to the coating solution so that the fluoroaliphatic group-containing copolymer is segregated (that is, maldistributed) on the surface of the functional layer. In order to render the functional layer adhesive to the upper layer, the solvent of the coating solution for forming the upper layer is spread over on the functional layer containing the fluoroaliphatic group-containing copolymer, and then dried so that the surface free energy of the functional layer changes by 1 mN/m or more, particularly 3 mN/m or more.

When the reduction of the surface energy is prevented at the time of coating the light diffusion layer with the low refractive index layer, the deterioration of anti-reflection properties can be prevented. The purpose can be accomplished also by using a coating solution having a low surface tension obtained by the incorporation of a fluorine-based polymer to enhance the uniformity in surface conditions and spreading the coating solution at a high speed to maintain a high productivity during the spreading of the light diffusion layer and subjecting the light diffusion layer thus formed to surface treatment such as corona treatment, UV treatment, heat treatment, saponification and solvent treatment, particularly preferably corona treatment, so that the reduction of the surface free energy can be prevented to control the surface energy of the light diffusion layer before the spreading of the low refractive index layer within the above defined range.

As the fluoroalkyl group-containing copolymer (hereinafter occasionally referred to as “fluorine-based polymer”) there is preferably used a copolymer having a fluoroalkyl group having two or more perfluoroalkyl groups in its side chains.

In particular, a copolymer containing a repeating unit (polymerizable unit) corresponding to the following monomer (i) and a repeating unit (polymerizable unit) corresponding to the following monomer (ii) and a vinyl-based monomer copolymerizable therewith are useful.

(i) Fluoroaliphatic group-containing monomer represented by the following formula (1); and
(ii) Poly(oxyalkylene)acrylate and/or poly (oxyalkylene)methacrylate

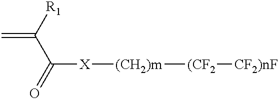

In the formula (1), R₁ represents a hydrogen atom or methyl group; X represents an oxygen atom, sulfur atom or —N(R₂)— (in which R₂ represents a hydrogen atom or C₁-C₄ alkyl group such as methyl, ethyl, propyl and butyl, preferably hydrogen atom or methyl group. X is preferably an oxygen atom.

In the formula (1), m represents an integer of from 1 to 6, particularly preferably 2.

In the formula (1), n represents an integer of from 1 to 5, preferably from 1 to 3. A mixture of fluoroaliphatic group-containing monomers wherein n is from 1 to 3 may be used. It is particularly preferred that n is 2 or 3.

Specific examples of the fluoroaliphatic group-containing monomer represented by the formula (1) include Compounds F-1 to F-64 disclosed in JP-A-2004-163610, [0027]-[0030], but the invention is not limited thereto.

The poly(oxyalkylene)acrylate and/or poly (oxyalkylene)methacrylate will be further described hereinafter.

The polyoxyalkylene group can be represented by (OR)ₓ in which R is preferably a C₂-C₄ alkyl group such as —CH₂CH₂—, —CH₂CH₂CH₂—, —CH(CH₃)CH₂— and —CH(CH₃)CH(CH₃)—.

The oxyalkylene unit (—OR—) in the aforementioned poly(oxyalkylene) group may be the same as in poly(oxypropylene), may have two or more oxyalkylenes distributed irregularly therein, may be a straight-chain or branched oxypropylene or oxyethylene unit or may be present like block of straight-chain or branched oxypropylene unit or block of oxyethylene unit.

This poly(oxyalkylene) chain may also have one or chain bonds (e.g., —CONH-Ph-NHCO—, —S—: Ph represents a phenylene group) connected to each other. In the case where the chain bond has a valency of 3 or more, this poly(oxyalkylene) chain provides a means of providing a branched oxyalkylene unit. In the case where this copolymer is used in the invention, the molecular weight of the poly(oxyalkylene) group is preferably from 250 to 3,000.

The poly(oxyalkylene) acrylate and methacrylate can be produced by reacting a commercially available hydroxypoly(oxyalkylene) material such as “Pluronic” (produced by ASAHI DENKA Co., Ltd.), Adekapolyether (produced by ASAHI DENKA Co., Ltd.), “Carbowax” (produced by Glico Products Co., Ltd.), “Toriton” (produced by Rohm and Haas Co., Ltd.) and P.E.G (produced by DAI-ICHI KOGYO SEIYAKU CO., LTD.) with acrylic acid, methacrylic acid, acryl chloride, methacryl chloride or acrylic anhydride by a known method. Alternatively, a poly(oxyalkylene)diacrylate produced by a known method may be used.

As the fluorine-based polymer of the invention there is preferably used a copolymer of the monomer represented by the formula (1) with a polyoxyalkylene (meth)acrylate. More preferably, the fluorine-based polymer of the invention contains a polyoxyethylene (meth)acrylate to have an enhanced solubility in the coating solution.

A particularly preferred embodiment of the fluorine-based polymer of the invention is a polymer obtained by the copolymerization of three or more monomers, e.g., the monomer represented by the formula (1), polyoxyethylene (meth)acrylate, polyoxyalkylene (meth)acrylate. The polyoxyalkylene (meth)acrylate is a monomer different from the polyoxyethylene (meth)acrylate.

A more desirable embodiment of the fluorine-based polymer of the invention is a terpolymer of a polyoxyethylene (meth)acrylate, a polyoxypropylene (meth)acrylate and the monomer represented by the formula (1).

The copolymerizing proportion of the polyoxyethylene (meth)acrylate is preferably from 0.5 mol-% to 20 mol-%, more preferably from 1 mol-% to 10 mol-% based on the total amount of the monomers.

The fluorine-based polymer to be used herein preferably contains repeating units corresponding to the monomers (i) and (ii) and a repeating unit corresponding to a monomer of the following formula (2) copolymerizable therewith.

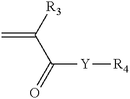

In the formula (2), R₃ represents a hydrogen atom or methyl group, and Y represents a divalent connecting group. Preferred examples of the divalent connecting group Y include oxygen atom, sulfur atom, and —N(R₅)—. R₅ is preferably a hydrogen atom or a C₁-C₄ alkyl group, preferably methyl, ethyl, propyl or butyl. R₅ is more preferably a hydrogen atom or methyl group.

Y is more preferably an oxygen atom, —N(H)— or —N(CH₃)—.

R₄ represents a C₄-C₂₀ straight-chain, branched or cyclic alkyl group which may have substituents. Examples of the substituents on R₄ include hydroxyl groups, alkylcarbonyl groups, arylcarbonyl groups, carboxyl groups, alkylether groups, arylether groups, halogen atoms such as fluorine atom, chlorine atom and bromine atom, nitro groups, cyano groups, and amino groups. However, the invention is not limited to these substituents. Examples of the C₄-C₂₀ straight-chain, branched or cyclic alkyl group include butyl, pentyl, hexyl, heptyl, octyl, nonyl, decyl, undecyl, dodecyl, tridecyl, tetradecyl, pentadecyl, octadecyl and eicosanyl groups which may be straight-chain or branched, monocyclic cycloalkyl groups such as cyclohexyl group and cycloheptyl group, and polycyclic cycloalkyl groups such as bicycloheptyl group, bicyclodecyl group, tricycloundecyl group, tetracyclododecyl group, adamanthyl group, norbornyl group and tetracyclodecyl group.

Specific examples of the monomer represented by the formula (2) include A-1 to A-130 disclosed in JP-A-2004-163610, [0033]-[0041]. However, the invention is not limited to these compounds.

The fluorine-based polymer to be used herein can be reacted with the monomer represented by the formula (1), a poly(oxyalkylene)acrylate and/or poly (oxyalkylene)methacrylate and the monomer represented by the formula (2) to be used optionally. In addition, monomers copolymerizable with these monomers can be reacted with the fluorine-based polymer.

The copolymerizing proportion of the copolymerizable monomer is preferably 20 mol-% or less, more preferably 10 mol-% or less based on the total amount of monomers.

As these monomers there are preferably used those disclosed in “Polymer Handbook”, 2nd ed., J. Brandrup, Wiley Interscience (1975), Chapter 2, pp. 1 to 483. Examples of these monomers include compounds having one addition-polymerizable unsaturated bond selected from the group consisting of acrylic acid, methacrylic acid, acrylic acid esters, methacrylic cid esters, acrylamides, methacrylamides, allyl compounds, vinyl ethers and vinyl esters.

Specific examples of these monomers include the following compounds.

Acrylic acid esters: methyl acrylate, ethyl acrylate, propyl acrylate, chloroethyl acrylate, 2-hydroxyethyl acrylate, trimethylolpropane monoacrylate, benzyl acrylate, methoxybenzyl acrylate, furfuryl acrylate, tetrahydrofurfuryl acrylate;

Methacrylic acid esters: methyl methacrylate, ethyl methacrylate, propyl methacrylate, chloroethyl methacrylate, 2-hydroxyethyl methacrylate, trimethylolpropane monomethacrylate, benzyl methacrylate, methoxybenzyl methacrylate, furfuryl methacrylate, tetrahydrofurfuryl methacrylate;

Acrylamides: acrylamide, N-alkylacrylamide (containing a C₁-C₃ alkyl group such as methyl, ethyl and propyl), N,N-dialkylacrylamide (containing a C₁-C₃ alkyl group), N-hydroxyethyl-N-methylacrylamide, N-2-acetamideethyl-N-acetylacrylamide;

Methacrylamides: methacrylamide, N-alkyl methacrylamide (containing a C₁-C₃ alkyl group such as methyl, ethyl and propyl), N,N-hydroxyethyl-N-methylmethacrylamide, N-2-acetamideethyl-N-acetylmethacrylamide;

Allyl compounds: allyl esters (e.g., allyl acetate, allyl caproate, allyl caprylate, allyl laurate, allyl palmitate, allyl stearate, allyl benzoate, allyl acetoacetate, allyl lactate), allyloxy ethanol;

Vinylethers: alkylvinyl ethers (e.g., hexylvinyl ether, octylvinyl ether, decylvinyl ether, ethylhexylvinyl ether, methoxyethylvinyl ether, ethoxyethylvinyl ether, chloroethylvinyl ether, 1-methyl-2,2-dimethylpropylvinyl ether, 2-ethylbutylvinyl ether, hydroxyethylvinyl ether, diethylene glycol vinyl ether, dimethylaminoethylvinyl ether, diethylaminoethylvinyl ether, butylaminoethylvinyl ether, benzylvinyl ether, tetrahydrofufurylvinyl ether;

Vinylesters: vinyl butyrate, vinyl isobutyrate, vinyl trimethylacetate, vinyl diethylacetate, vinyl varate, vinyl caproate, vinyl chloroacetate, vinyl dichloroacetate, vinyl methoxyacetate, vinyl butoxyacetate, vinyl lactate, vinyl-β-phenylbutyrate, vinyl cyclohexyl carboxylate;

Itaconic acid dialkyls: dimethyl itaconate, diethyl itaconate, dibutyl itaconate;

Fumaric acid dialkylesters or monoalkylesters: dibutyl fumarate;

Others: crotonic acid, itaconic acid, acrylonitrile, methacrylonitrile, maleilonitrile, styrene

The amount of the fluoroaliphatic group-containing monomer represented by the formula (1) to be incorporated in the fluorine-based polymer to be used herein is 5 mol-% or more, preferably from 5 to 65 mol-%, more preferably from 10 to 60 mol-% based on the respective monomer of the fluorine-based polymer.

The amount of the poly(oxyalkylene)acrylate and/or poly(oxyalkylene)methacrylate is 10 mol-% or more, preferably from 15 to 70 mol-%, more preferably from 20 to 60 mol-% based on the respective monomer of the fluorine-based polymer.

The amount of the monomer represented by the formula (2) is 3 mol-% or more, preferably from 5 to 50 mol-%, more preferably from 10 to 40 mol-% based on the respective monomer of the fluorine-based polymer.

The weight-average molecular weight of the fluorine-based polymer to be used herein is preferably from 3,000 to 100,000, more preferably from 6,000 to 80,000.

The added amount of the fluorine-based polymer to be used herein is preferably from 0.001 to 8% by weight, more preferably from 0.005 to 5% by weight, even more preferably from 0.01 to 1% by weight based on the light diffusion layer-forming coating composition (coating components excluding solvent). When the added amount of the fluorine-based polymer falls below than 0.001% by weight, the resulting effect is insufficient. When the added amount of the fluorine-based polymer exceeds 5% by weight, the coat layer cannot be sufficiently dried.

The fluorine-based polymer of the invention can be produced by any known commonly used method. For example, the aforementioned monomers such as (meth)acrylate having a fluoroaliphatic group and (meth)acrylate having a polyoxyalkylene group may be subjected to polymerization in the presence of a general-purpose radical polymerization initiator in an organic solvent. Alternatively, other addition-polymerizable unsaturated compounds may be added as necessary.

A dropwise addition polymerization method involving polymerization with the dropwise addition of monomers and initiator into the reactor according to the polymerizability of the monomers can be used to obtain a polymer having a uniform composition.

Specific examples of the structure of the fluorine-based polymer of the invention will be given below, but the invention is not limited thereto. The figure in the following formulae each indicate the molar fraction of the various monomer components. Mw indicates the weight-average molecular weight of the monomer.

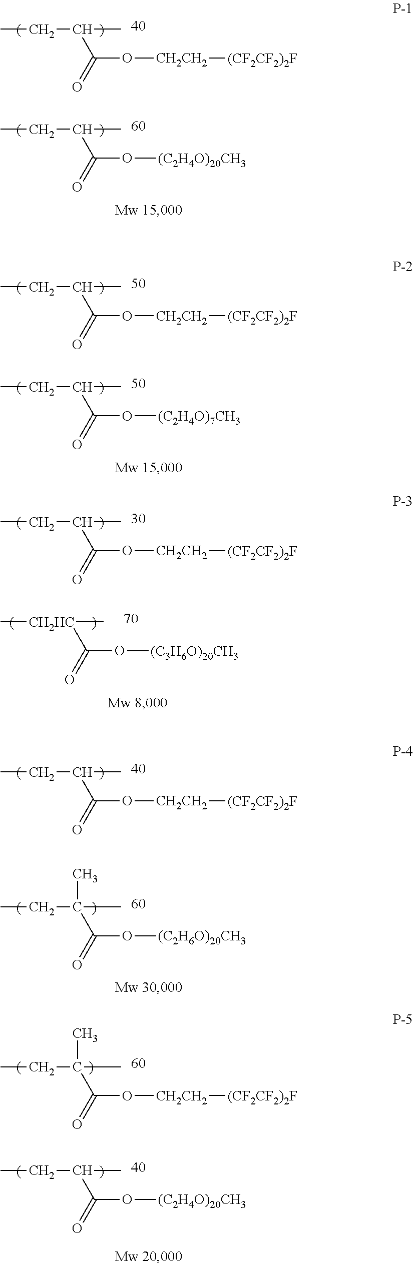

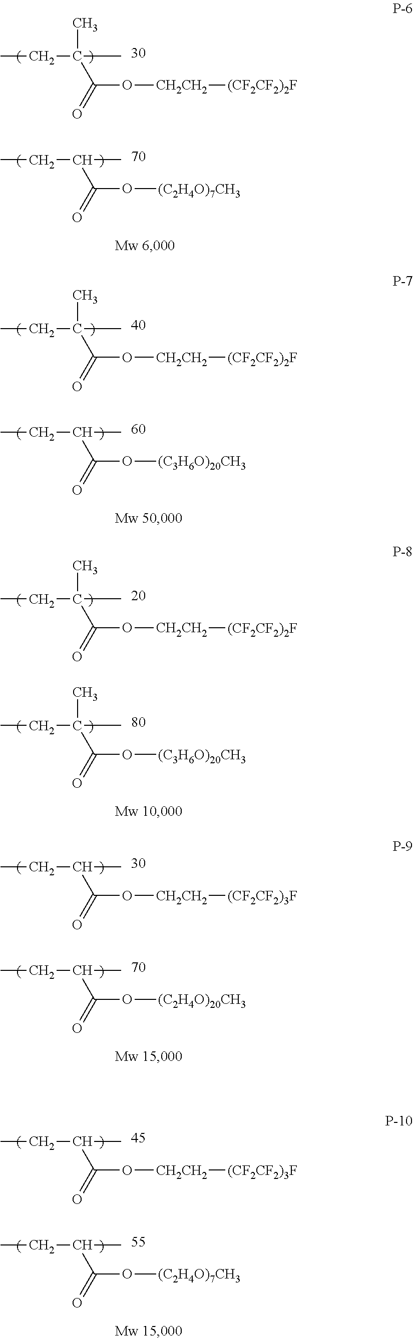

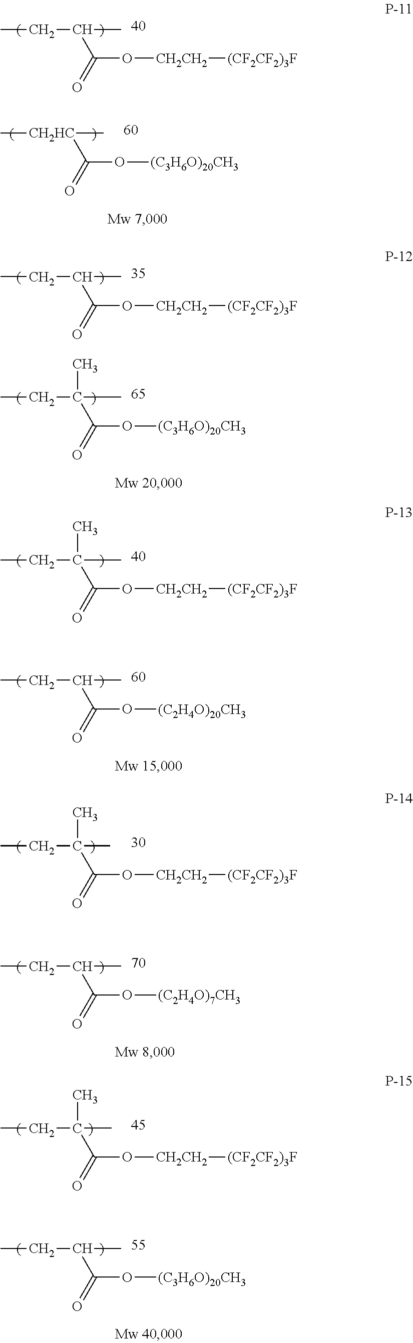

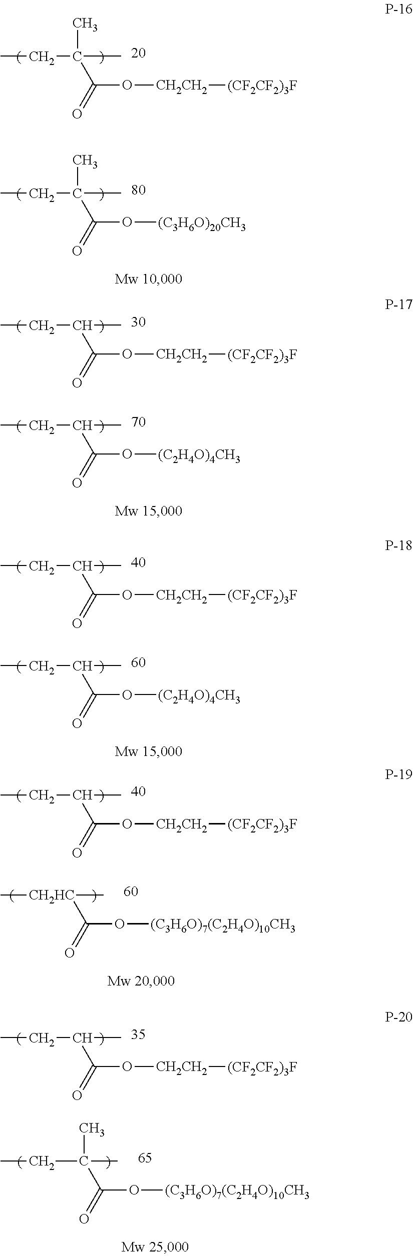

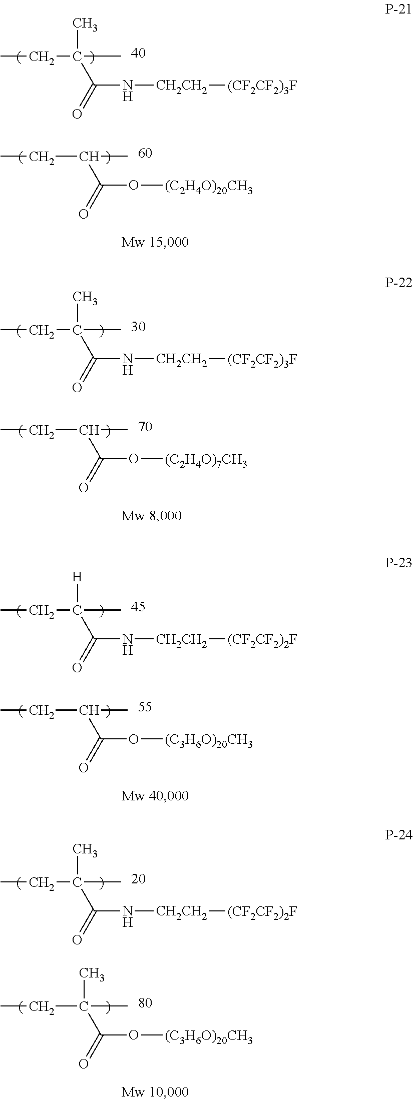

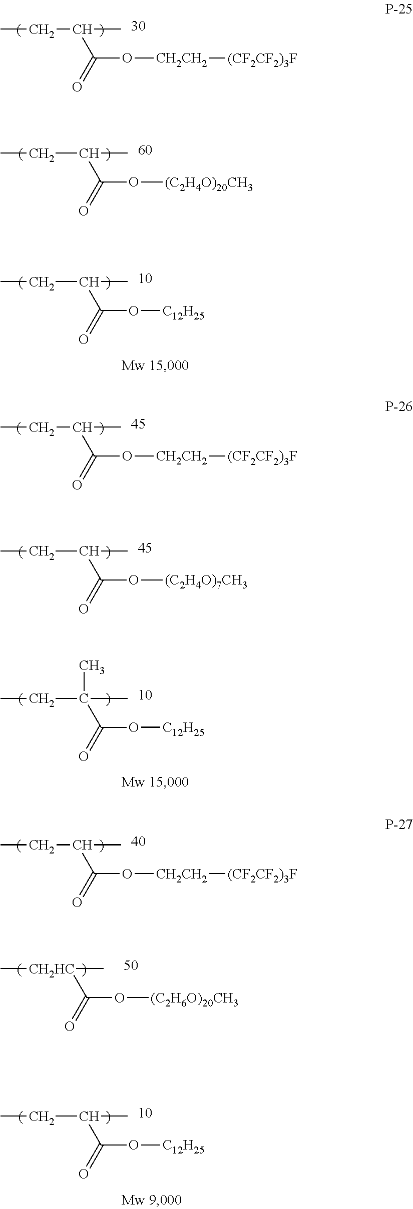

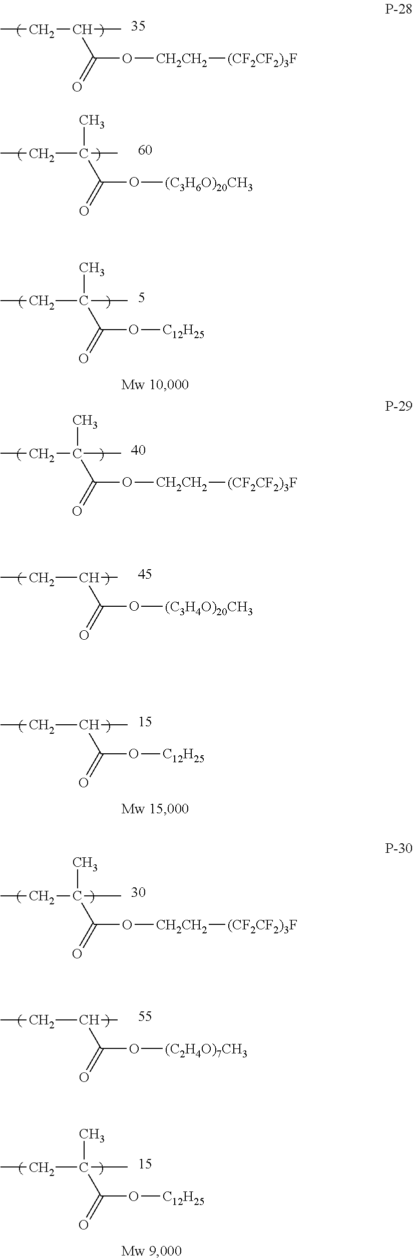

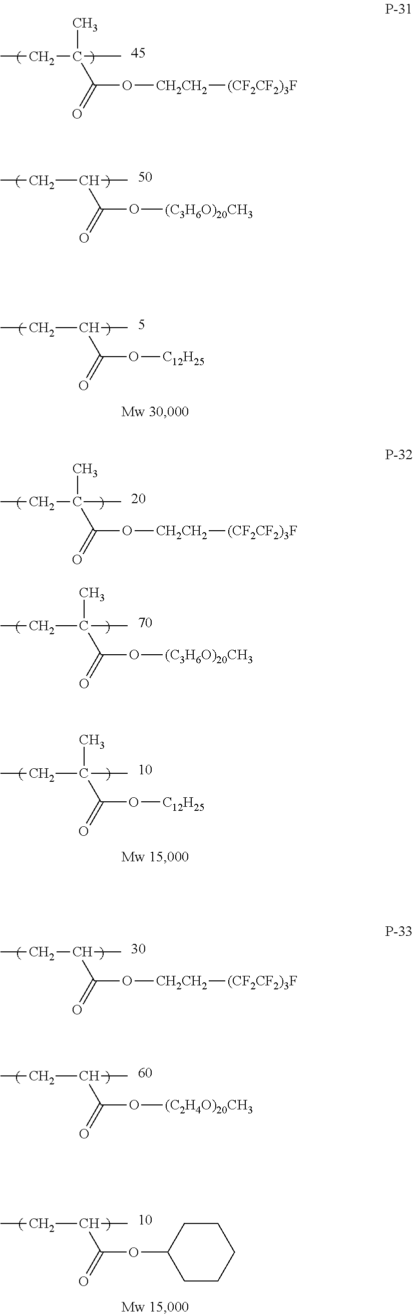

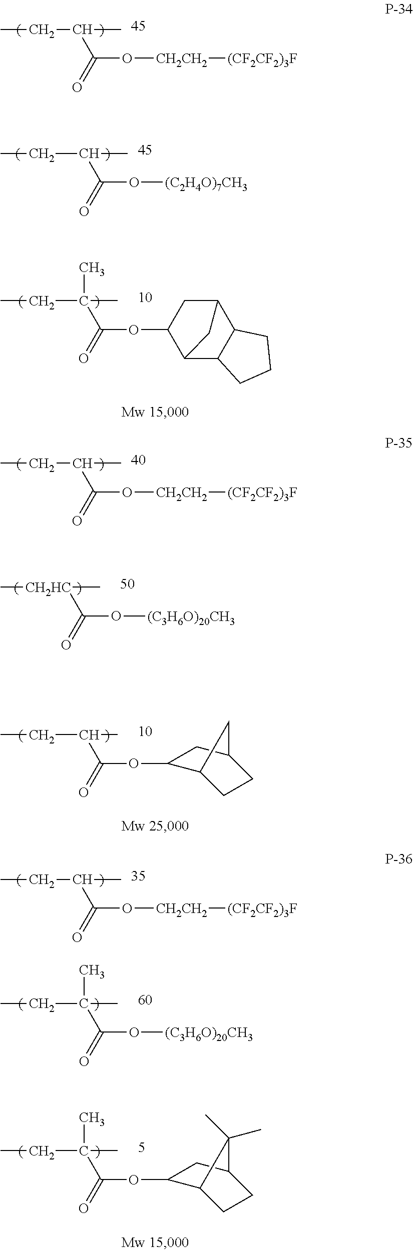

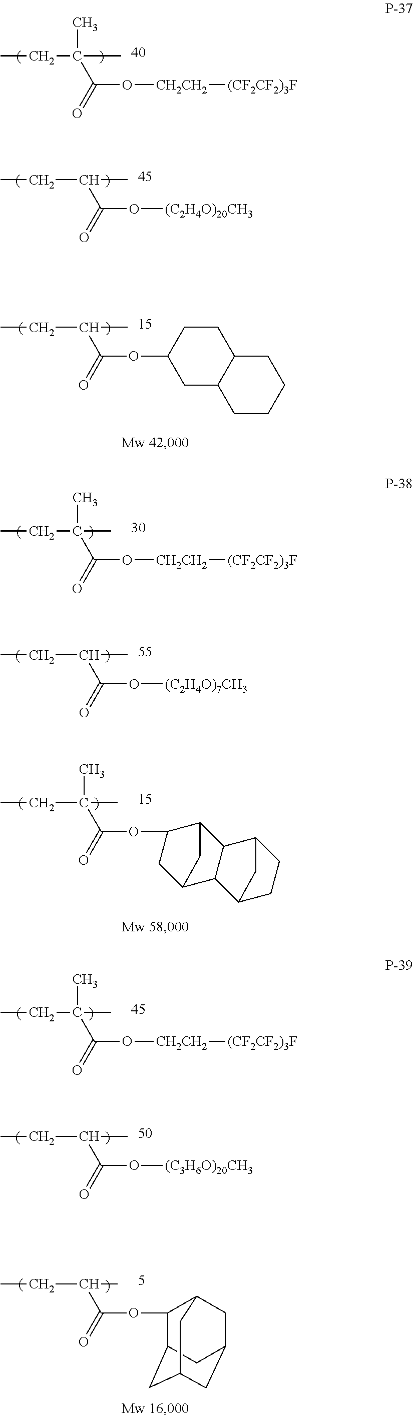

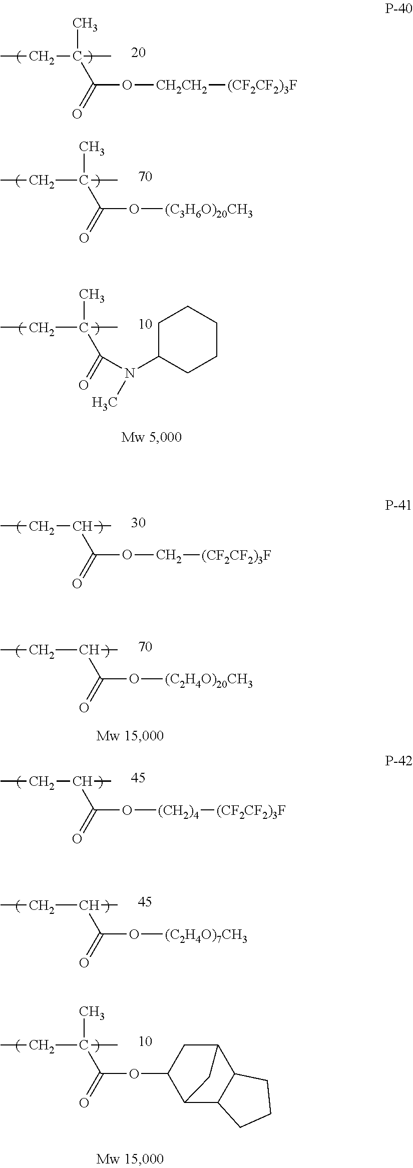

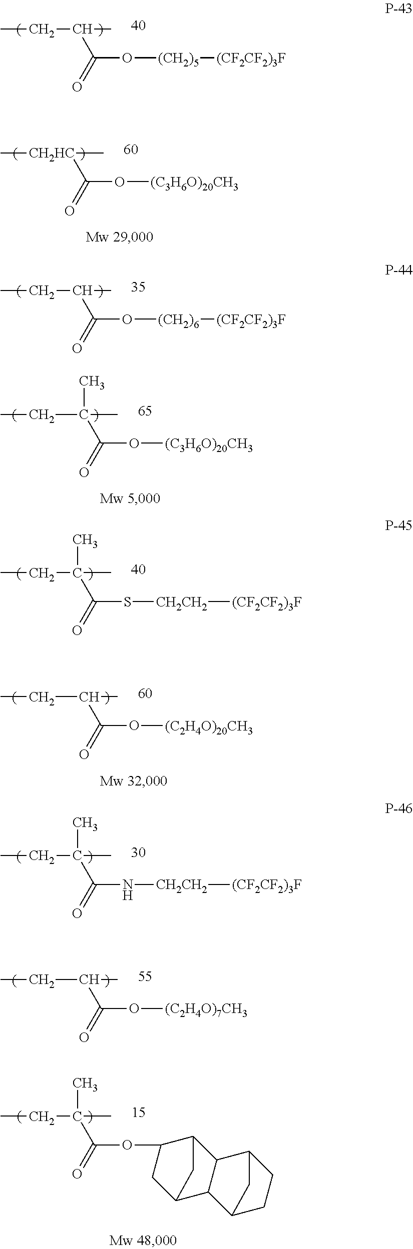

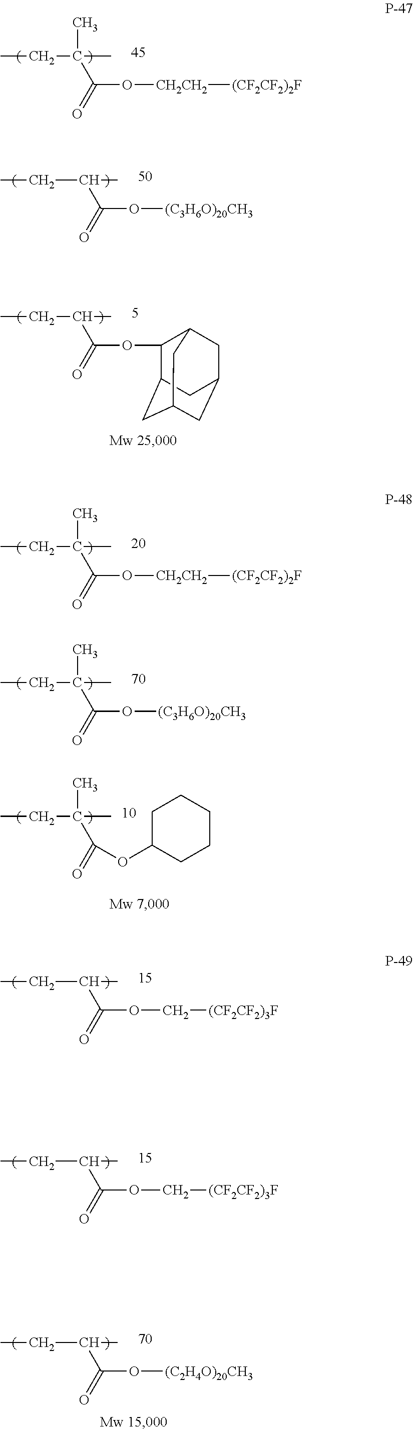

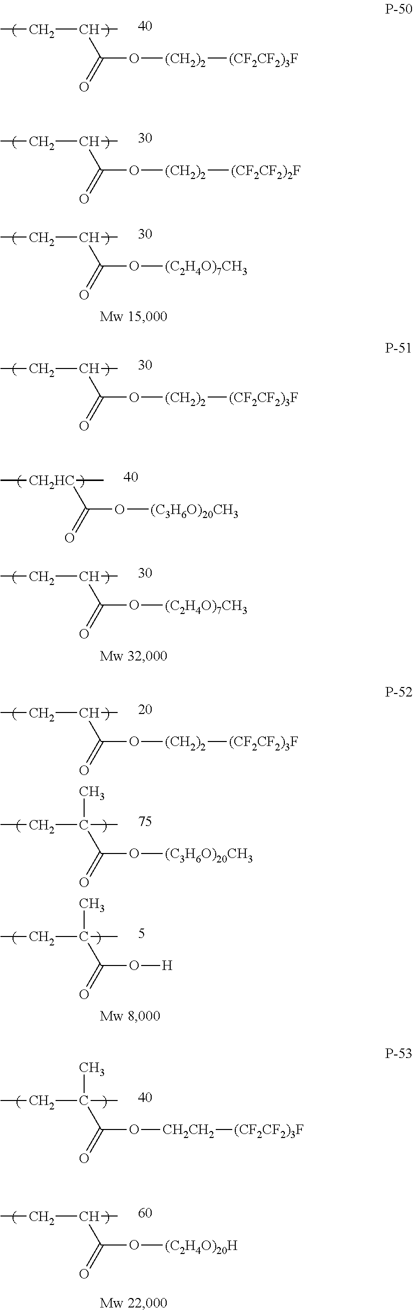

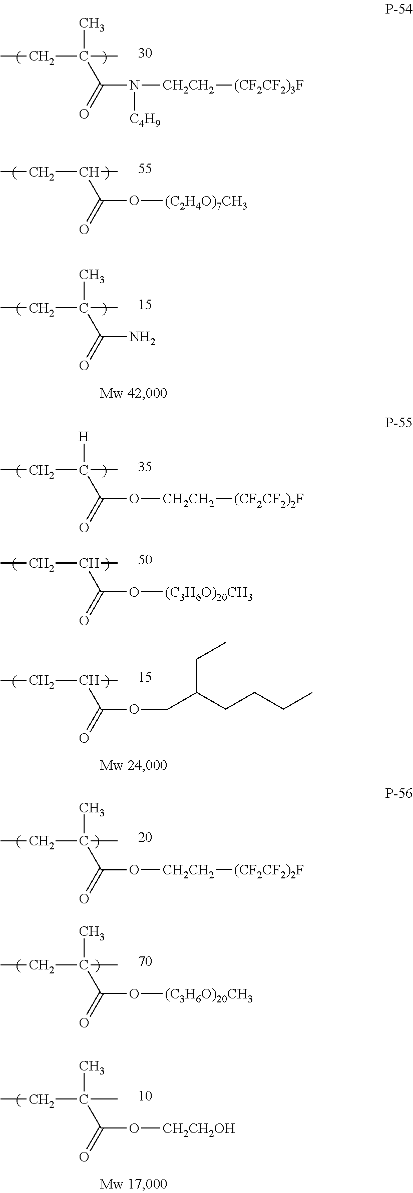

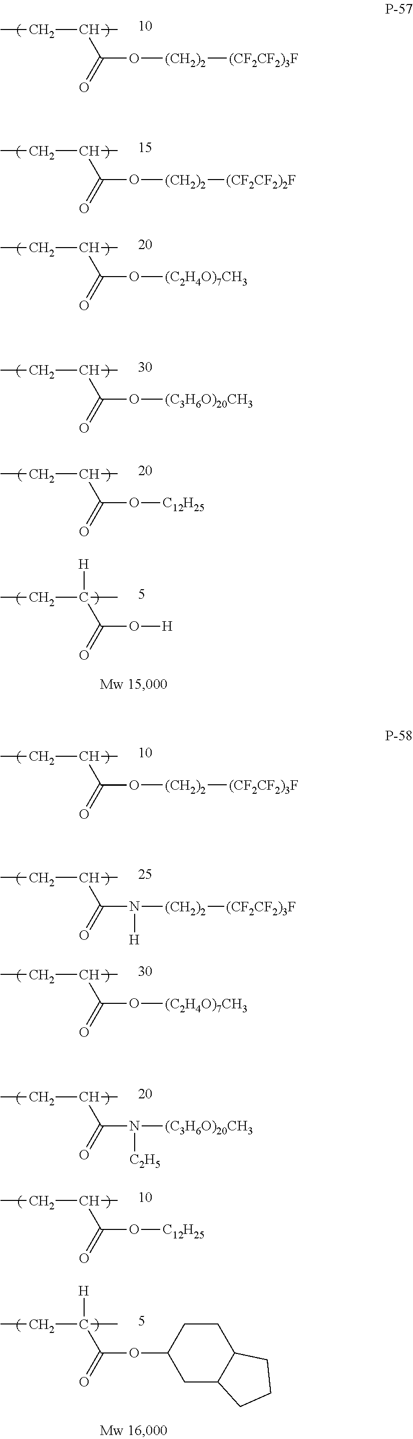

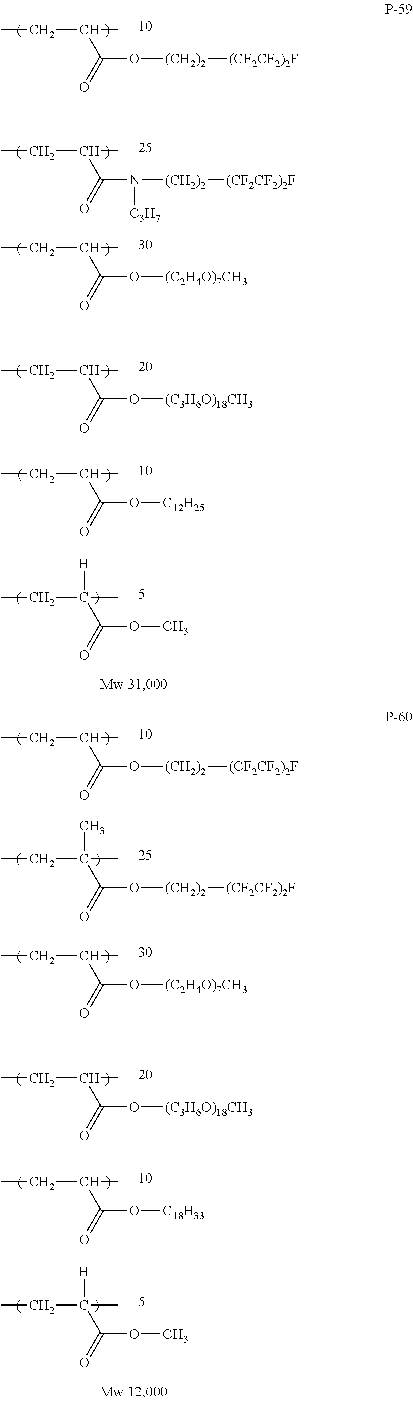

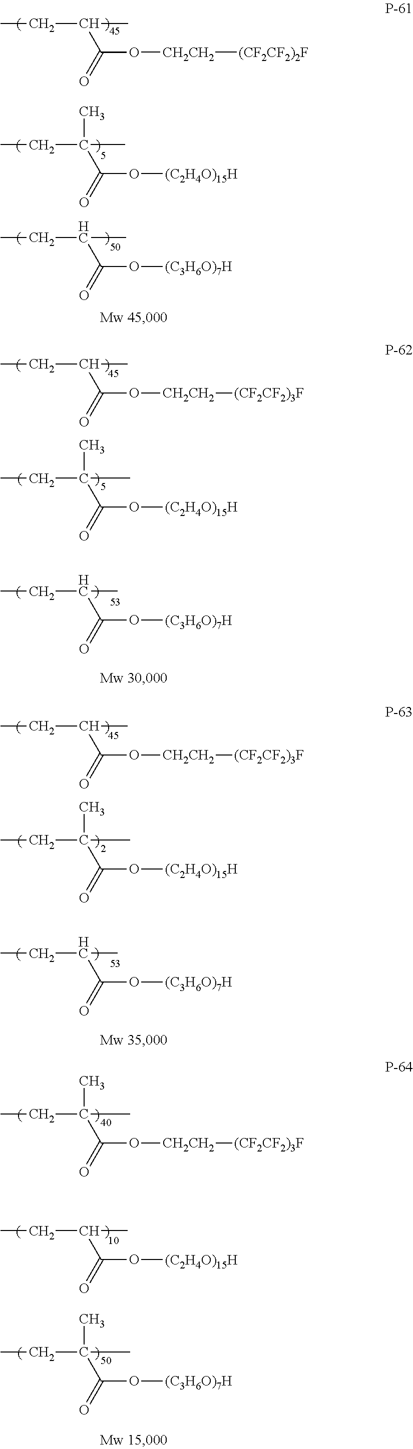

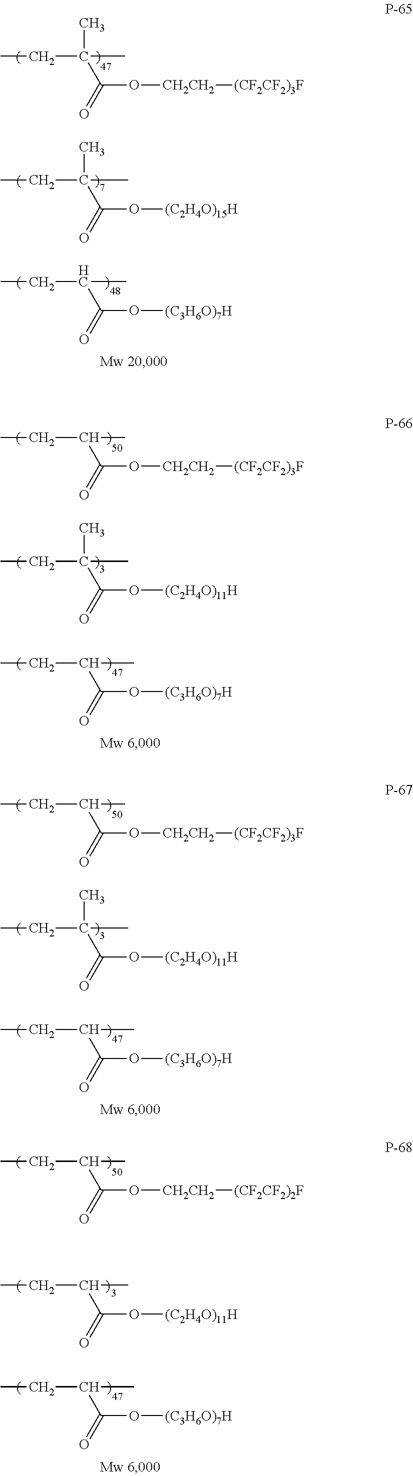

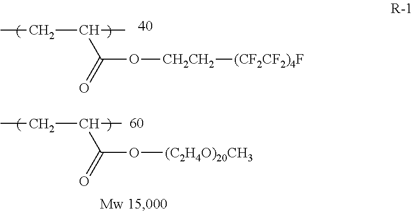

### <Method for Purifying Fluorine-Based Copolymer>

The fluorine-based copolymer to be used in the invention is preferably substantially free of copolymer components containing much repeating units corresponding to the monomer of the formula (1), which is a group having a low affinity for coating solvent, preferably copolymer components containing the repeating units in a proportion of 70 mol-% or more, more preferably 80 mol-% or more. The term “substantially free” as used herein is meant to indicate that when components having much repeating units derived from fluoroaliphatic group-containing monomer are separated from the leveling agent, those containing the repeating units in a content of 70 mol-% or more on the average cannot be detected, that is, the content of the repeating units is 0.1% or less.

The purification of the aforementioned fluorine-based polymer of the invention may be carried out by any method so far as the copolymer components rich with a group having a low affinity for the coating solution can be removed. In the invention, however, the following purification method is preferably used.

The copolymer components rich with a group having a low affinity for the coating solution in the copolymer include polymers produced at the step of synthesis of monomers having a low affinity group and polymers produced during the synthesis of the copolymer. The polymers produced at the step of synthesis of monomers are preferably removed as monomers at the purification step before being used at the copolymerization step.

Proposed examples of the method of purifying the copolymer (leveling agent) comprising the fluoroaliphatic group-containing monomers of the invention as constituent units include (1) a method which comprises dissolving the copolymer in a solvent, and then bringing the solution into contact with an inorganic adsorbent so that it is purified, (2) a method which comprises bringing the solution into an organic synthetic adsorbent so that it is purified, and (3) a method which comprises filtering the solution through a filter having a pore diameter of 1 μm or less so that it is purified.

Examples of the solvent in which the aforementioned fluorine-based copolymer is dissolved during purification include alcohols such as methyl alcohol, ethyl alcohol, n-propyl alcohol, iso-propyl alcohol, n-butyl alcohol, iso-butyl alcohol and diacetoalcohol, ketones such as acetone, methyl ethyl ketone, methyl propyl ketone, methyl butyl ketone, methyl amyl ketone, methyl hexyl ketone, diethyl ketone, diisobutyl ketone, cyclohexanone, methyl cyclohexanone and acetyl acetone, hydrocarbons such as benzene, toluene, xylene, cyclohexane and methoxybenzene, acetic acid esters such as ethyl acetate, n-propyl acetate, iso-propyl acetate, n-butyl acetate, iso-butyl acetate, ethyl butyl acetate and hexyl acetate, halides such as methylene dichloride, ethylene dichloride and monochlorobenzene, ethers such as isopropyl ether, n-butyl ether, dioxane, dimethyl dioxane and tetrahydrofurane, polyvalent alcohols such as ethylene glycol, methyl cellosolve, cellosolve acetate, butyl cellosolve, butyl cellosolve acetate, methoxymethoxy ethanol, diethylene glycol monomethyl ether, diethylene glycol dimethyl ether, diethylene glycol dimethyl ethylether, diethylene glycol diethylether, propylene glycol, propylene glycol monomethyl ether, propylene glycol monomethyl ether acetate, propylene glycol monobutyl ether, 1-methoxy-2-propanol and 3-methyl-3-methoxybutanol, derivatives thereof, and special solvents such as dimethyl sulfoxide, N,N-dimethylformamide and N,N-dimethylacetamide. These solvents may be used singly or in admixture to advantage. The concentration of the solution is not specifically limited but is from about 1 to 60% by weight, preferably from about 2 to 40% by weight.

### (1) Purification by Inorganic Adsorbent

As the inorganic adsorbent to be used in the invention there is preferably used one containing a silicon oxide, aluminum oxide or a mixture thereof in a proportion of 80% or more. The inorganic adsorbent may be a hydrate and may further contain an oxide of Fe, P, Ti, Ca, Mg, Na, K, etc. Any known inorganic adsorbents may be used.

Examples of the inorganic adsorbent employable herein include active alumina, diatomaceous earth, active clay, silica gel, and zeolite. These materials may be used singly or in combination of two or more thereof.

The amount of the adsorbent to be used with respect to the material to be purified is not specifically limited, but the weight ratio of adsorbent to material to be purified is preferably from 1/1,000 to 1,000/1, particularly preferably from 1/100 to 100/1. The contact of the adsorbent with the fluorine-based copolymer is carried out by any method involving the enhancement of dispersibility. However, a method involving agitation, shaking or ultrasonic vibration is normally used. The contact time is normally preferably from 10 minutes to 10 hours. The temperature during contact is not specifically limited but is preferably from 0° C. to 100° C. The adsorbent with which the fluorine-based copolymer has come in contact is then separated from the fluorine-based copolymer. In some detail, the adsorbent is filtered through a filter material so that it is separated from the fluorine-based copolymer. Such a filter material is not specifically limited but may be cellulose, PTFE, polypropylene, SUS, polybutylene terephthalate, glass or the like. The filtration method may involve any of spontaneous filtration, pressure filtration, vacuum filtration and centrifugal filtration.

### (2) Purification by Organic Adsorbent

Among nonpolar or micropolar crosslinked copolymers, those having a developed specific surface area and pore volume are called synthetic adsorbent and are preferably used as organic adsorbent in the invention. More desirable are synthetic adsorbents made of (modified) styrene-divinylbenzene copolymer or (meth)acrylic acid ester-based copolymer.

Examples of the synthetic adsorbent made of (modified) styrene-divinylbenzene copolymer or (meth)acrylic acid ester-based copolymer include Amberlite XAD-2, Amberlite XAD-4, Amberlite XAD-7, Amberlite XAD-8, Amberlite XAD-9, Amberlite XAD-10, Amberlite XAD-11 and Amberlite XE-284 (produced by Rohm and Haas Company), and Diaion HP10, Diaion HP20, Diaion HP21, Diaion HP30, Diaion HP40, Diaion HP50, Diaion HP1MG, Diaion HP2MG, Sepabead SP800, Sepabead SP900, Sepabead SP206 and Sepabead SP207 (produced by Mitsubishi Chemical Corporation). However, the invention is not limited to these compounds.

The amount of the adsorbent to be used with respect to the material to be purified is not specifically limited, but the weight ratio of adsorbent to material to be purified is preferably from 1/1,000 to 1,000/1, particularly preferably from 1/100 to 100/1. The contact of the adsorbent with the fluorine-based copolymer is carried out by any method involving the enhancement of dispersibility. However, a method involving agitation, shaking or ultrasonic vibration is normally used. The contact time is normally preferably from 10 minutes to 10 hours. The temperature during contact is not specifically limited but is preferably from 0° C. to 100° C. The adsorbent with which the fluorine-based copolymer has come in contact is then separated from the fluorine-based copolymer. The separation of the adsorbent from the fluorine-based copolymer can be carried out by the method as described with reference to the inorganic adsorbent.

### (3) Purification by Filtration Through Filter Having a Pore Diameter of 1 μM or Less

The copolymer containing a fluoro-substituted (meth)acrylate as a constituent unit in a proportion of from 1 to 80% by weight may be dissolved in a solvent, and then filtered through a filter having a pore diameter of 1 μm or less so that it is purified. The pore diameter of the filter is preferably 0.5 μm or less, more preferably 0.1 μm or less.

As the filter to be used herein there may be any filter having a pore diameter of 1 μm or less. Examples of the material constituting the filter include cellulose, PTFE, polypropylene, SUS, and polybutylene terephthalate. The filter may be in the form of membrane, membrane cartridge, pleats cartridge, depth cartridge or the like. The filtration operation may involve any of spontaneous, filtration, pressure filtration, vacuum filtration and centrifugal filtration. The material is preferably allowed to stand at a low temperature where the material to be removed is separated out to enhance the purification efficiency. For example, the material is preferably allowed to stand at a temperature of from −15° C. to 30° C. for 5 to 10 hours. As mentioned above, the fluorine-based copolymer dissolved in a solvent may be adsorbed to the adsorbent, and then further filtered through a filter having a pore diameter of 1 μm or less so that it is purified.

The silicone-based leveling agent, too, may be purified in the same manner as mentioned above to remove a group having a low affinity for coating solution such as polydimethysiloxane therefrom.

The light diffusion layer preferably comprises a resin such as urethane, cellulose acetate butyrate, cellulose acetate propionate and acrylic resin (e.g., methyl polymethacrylate) incorporated therein for the purpose of adjusting the viscosity of the coating solution.

Further, the coating composition for forming the light diffusion layer of the invention may comprise a thixotropic agent incorporated therein. Examples of the thixotropic agent employable herein include silica and mica having a particle size of 0.1 μm or less. In general, the content of these additives is preferably from about 1 to 10 parts by weight based on 100 parts by weight of ultraviolet-curing resin.

Since there are many cases where the coating solution of the light diffusion layer of the invention is wet-spread directly over the transparent substrate, the solvent to be used in the coating composition is an important factor. Examples of the requirements for the solvent include sufficient dissolution of various solutes, no dissolution of the light diffusion particles, no occurrence of unevenness in coating and drying during the steps of coating to drying, no dissolution of support (necessary for the prevention of defects such as deterioration of flatness and whitening) and swelling of support to the least extent (necessary for adhesion).

In some detail, in the case where as the substrate there is used a triacetyl cellulose, various ketones (e.g., methyl ethyl ketone, acetone, methyl isobutyl ketone, cyclohexanone) and various cellosolves (e.g., ethyl cellosolve, butyl cellosolve, propylene glycol monomethyl ether) are preferably used. By adding a solvent having a hydroxyl group to the main solvent selected from the group consisting of these solvents in a small amount, the anti-glare properties (light diffusion properties) can be adjusted to advantage in particular. The solvent having a hydroxyl group to be used in a small amount preferably has a lower vapor pressure at a temperature within a range of from 20° C. to 30° C. than the main solvent because it can remain longer than the main solvent at the step of drying the coating composition to enhance anti-glare properties. A preferred example of combination is a combination of methyl isobutyl ketone (vapor pressure at 21.7° C.:16.5 mmHg) as main solvent and a propylene glycol (vapor pressure at 20.0° C.:0.08 mmHg) as a solvent to be used in a small amount. The weight mixing ratio of the main solvent to the solvent having a hydroxyl group to be used in a small amount is preferably from 99:1 to 50:50, more preferably from 95:5 to 70:30. When the mixing ratio exceeds 50:50, the resulting coating solution exhibits a raised dispersion of stability and surface properties at the drying step after coating to disadvantage.

In general, by-products rich with a group having a low affinity for coating solution present in fluorine-based leveling agent (fluorine-based surface active agent) or silicone-based leveling agent (silicone-based surface active agent) have a low polarity and thus can be difficultly dissolved in an organic solvent having a high polarity, causing easy occurrence of point defects. Accordingly, the invention is more advantageous with a light diffusion layer composed of a curable composition containing an organic solvent having a high polarity.

The polarity of the organic solvent can be represented by solubility parameter (SP value). From the aforementioned standpoint of view, the light diffusion layer-forming curable composition of the invention is preferably composed of a curable composition containing a solvent having SP value of 9.5 or more, more preferably 9.8 or more.

In the case where the light diffusion layer-forming curable composition contains a solvent having SP value of 9.5 or more in the invention, the content of the solvent is preferably 5% by weight or more, more preferably 10% by weight or more, even more preferably 15% by weight or more based on the total weight of the solvents.

### <Solubility Parameter (SP Value)>

The solubility parameter (SP value) of the invention is a value determined by the equation σ=[(ΔH−RT)/VL]^{1/2} (in which σ represents solubility parameter; ΔH represents heat of evaporation; VL represents molar volume; and R represents gas constant). ΔH is a value calculated from the boiling point by the equation ΔH298=23.7Tb+0.020Tb²−2950 (in which Tb indicates boiling point) according to Hiderbrand rule. Accordingly, the solubility parameter, too, is a value at 298° K. Specific examples of the solubility parameter determined by Hiderbrand rule are disclosed in J. BRANDRUP, E. H. IMMERGUT, and, E. A. GRULKE “POLYMER HANDBOOK FORTH EDITION” VII/688-694 (1998), JOHN WILEY & SONS, INC. For the details of method of calculating solubility parameter according to Hiderbrand rule, reference can be made to J. H. Hilderbrand, “Solubility of Nonelectrolytes”, 424-427 (1950), Reinhold Publishing Co. SP value of representative compounds will be set forth in Table 1 below.

TABLE 1

| Solvent | SP value |
|---|---|
| Dimethyl siloxane | 5.5 |
| Neopentane | 6.3 |
| Diisopropyl ether | 6.9 |
| Pentane | 7.0 |
| Diethyl ether | 7.4 |
| Octane | 7.6 |
| Diisobutyl ketone | 7.8 |
| Diethylamine | 8.0 |
| Dicyclohexane | 8.2 |
| Methyl isobutyl ketone | 8.4 |
| Dipentene | 8.5 |
| 2-Heptane | 8.5 |
| Butyl acetate | 8.5 |
| Carbon tetrachloride | 8.6 |
| Propyl benzene | 8.6 |
| Xylene | 8.8 |
| p-Chlorotoluene | 8.8 |
| Butyl aldehyde | 9.0 |
| Benzene | 9.2 |
| Styrene | 9.3 |
| Methyl ethyl ketone | 9.3 |
| Acetone | 9.9 |
| Cyclohexanone | 9.9 |
| Isopentyl alcohol | 10.0 |
| o-Dichlorobenzene | 10.0 |
| Acetic acid | 10.1 |
| m-Cresol | 10.2 |
| 1-Octanol | 10.3 |
| Cyclopentane | 10.4 |
| t-Butyl alcohol | 10.6 |
| Pyridine | 10.7 |
| 2-Butanol | 10.8 |
| 1-Pentanol | 10.9 |
| 1-Butanol | 11.4 |
| Cyclohexanol | 11.4 |
| Isopropyl alcohol | 11.5 |
| 1-Methoxy-2-propanol | 11.7 |
| Acetonitrile | 11.9 |
| Benzyl alcohol | 12.1 |
| Diethylene glycol | 12.1 |
| Ethanol | 12.7 |
| Methanol | 14.5 |
| Ethylene glycol | 14.6 |
| Glycerol | 16.5 |
| Water | 23.4 |

A low refractive index layer can be formed on the light diffusion layer of the invention to prepare an anti-reflection film having light diffusion properties (hereinafter simply referred to as “anti-reflection film”).

### <Low Refractive Index Layer>

The low refractive index layer of the invention preferably contains a fluorine-containing compound. It is particularly preferred that a low refractive index layer mainly composed of a fluorine-containing compound be formed. The low refractive index layer mainly composed of a fluorine-containing compound can act as a protective layer or stainproofing layer. The term “mainly composed of fluorine-containing compound” as used herein is meant to indicate that the weight proportion of the fluorine-containing compound is highest in the constituent components contained in the low refractive index layer and the content of the fluorine-containing compound is preferably 50% by weight or more, more preferably 60% by weight or more based on the total weight of the low refractive index layer.

The low refractive index layer containing the fluorine-containing compound may be prepared by either gas phase method (e.g., vacuum metallizing method, sputtering method, ion plating method, plasma CVD method) or coating method. However, the coating method is preferred because the low refractive index layer can be prepared at low cost.

In the case where the coating method is employed, the fluorine-containing compound to be incorporated in the low refractive index layer is preferably formed by crosslinking or polymerization reaction of a fluorine-containing compound having a crosslinkable or polymerizable functional group and the crosslinkable or polymerizable functional group is preferably an ionizing radiation-curable functional group. The fluorine-containing compound to be incorporated in the low refractive index layer will be further described hereinafter.

### (Fluorine-Containing Compound)

The refractive index of the fluorine-containing compound to be incorporated in the low refractive index layer is preferably from 1.35 to 1.50, more preferably from 1.36 to 1.47, even more preferably from 1.38 to 1.45.

Examples of the fluorine-containing compound employable herein include fluorine-containing polymers, fluorine-containing silane compounds, fluorine-containing surface active agents, and fluorine-containing ethers.

Examples of the fluorine-containing polymers employable herein include those synthesized by the crosslinking or polymerization reaction of ethylenically unsaturated monomers containing fluorine atoms. Examples of the ethylenically unsaturated monomers containing fluorine atoms employable herein include fluoroolefins (e.g., fluoroethylene, vinylidene fluoride, tetafluoroethylene, hexafluoropropylene, perfluoro-2,2-dimethyl-1,3-dioxol), fluorinated vinyl ethers, and esters of fluorine-substituted alcohol with acrylic or methacrylic acid.

As the fluorine-containing polymer there may be used also a copolymer comprising a repeating structural unit containing fluorine atom and a repeating structural unit free of fluorine atom.

The aforementioned copolymer may be obtained by the polymerization reaction of an ethylenically unsaturated monomer containing fluorine atom with an ethylenically unsaturated monomer free of fluorine atom.

Examples of the ethylenically unsaturated monomer free of fluorine atom include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrenes and derivatives thereof (e.g., styrene, divinylbenzene, vinyl toluene, α-methylstyrene), vinyl ethers (e.g., methyl vinyl ether), vinyl esters (e.g., vinyl acetate, vinyl propionate, vinyl cinnamate), acrylamides (e.g., N-tert-butylacrylamide, N-cyclohexylacrylamide), and methacrylamides, and acrylonitriles.

Examples of the fluorine-containing silane compounds include silane compounds containing perfluoroalkyl group.

The fluorine-containing surface active agent has some or whole of hydrogen atoms in the hydrocarbon constituting the hydrophobic moiety substituted by fluorine atom. Thus, the hydrophilic moiety of the fluorine-containing surface active agent may be anionic, cationic, nonionic or amphoteric.

The fluorine-containing ether is a compound which is commonly used as a lubricant. As the fluorine-containing ether there may be used a perfluoropolyether or the like.

As the fluorine-containing compound to be incorporated in the low refractive index layer there is particularly preferably used a fluorine-containing polymer having a crosslinked or polymerized structure incorporated therein. The fluorine-containing polymer having a crosslinked or polymerized structure incorporated therein is obtained by the crosslinking or polymerization of a fluorine-containing compound having a crosslinking or polymerizable functional group.

The fluorine-containing compound having a crosslinking or polymerizable functional group can be obtained by introducing a crosslinking or polymerizable functional group into a fluorine-containing compound free of crosslinking or polymerizable functional group as a side chain. The crosslinking or polymerizable functional group is preferably a functional group which undergoes reaction when irradiated with light (preferably ultraviolet rays) or electron beam (EB) or heated to cause the fluorine-containing polymer to have a crosslinked or polymerized structure. Examples of the crosslinking or polymerizable functional group include (meth)acryloyl, isocyanate, epoxy, aziridine, oxazoline, aldehyde, carbonyl, hydrazine, carboxyl, methylol, and active methylene. As the fluorine-containing compound having a crosslinking or polymerizable functional group there may be used any commercially available product.

The fluorine-containing compound to be incorporated in the low refractive index layer preferably contains as a main component a copolymer comprising a repeating unit derived from fluorine-containing vinyl monomer and a repeating unit having (meth)acryloyl group in side chain. The proportion of the component derived from the copolymer is preferably 50% by weight or more, more preferably 70% by weight or more, particularly 90% by weight or more based on the total weight of the outermost layer. The aforementioned copolymer which is preferably incorporated in the outermost layer will be described hereinafter.

Examples of the fluorine-containing vinyl monomer include fluoroolefins (e.g., fluoroethylene, vinylidene fluoride, tetrafluoroethylene, hexafluoroethylene, hexafluoroporopylene), partly or fully-fluorinated alkylester derivatives of (meth)acrylic acids (e.g., Biscoat 6FM (trade name, produced by Osaka Organic Chemical Industry Ltd.) and M-2020 (trade name, produced by DAIKIN INDUSTRIES, ltd.)), and fully or partly-fluorinated vinyl ethers. Preferred among these fluorine-containing vinyl monomers are perfluoroolefins. Particularly preferred among these fluorine-containing vinyl monomers is hexafluoropropylene from the standpoint of refractive index, solubility, transparency and availability.

The fluorine-containing vinyl monomer is preferably incorporated in such an amount that the fluorine content in the copolymer is from 20% to 60% by weight, more preferably from 25% to 55% by weight, particularly from 30% to 50% by weight.

The aforementioned copolymer has a repeating unit having (meth)acryloyl group. The method for the introduction of (meth)acryloyl group is not specifically limited. Examples of the method for the introduction of (meth)acryloyl group include (i) a method which comprises synthesizing a polymer a nucleophilic group such as hydroxyl group and amino group, and then reacting the polymer with (meth)acrylic acid chloride, (meth) acrylic acid anhydride, mixed acid anhydride comprising (meth)acrylic acid and methanesulfonic acid or the like, (ii) a method which comprises reacting the aforementioned polymer having a nucleophilic group with (meth)acrylic acid in the presence of a catalyst such as sulfuric acid, (iii) a method which comprises reacting the aforementioned polymer having a nucleophilic group with a compound having an isocyanate group such as methacryloyloxy propyl isocyanate and a (meth)acryloyl group in combination, (iv) a method which comprises synthesizing a polymer having an epoxy group, and then reacting the polymer with a (meth)acrylic acid, (v) a method which comprises reacting a polymer having carboxyl group with a compound having an epoxy group such as glycidyl methacrylate and a (meth)acryloyl group in combination, and (vi) a method which comprises polymerizing a vinyl monomer having 3-chloropropionic acid ester moiety, and then subjecting the polymer to dehydrochlorination. In particular, a (meth)acryloyl group is preferably introduced into the polymer having hydroxyl group by the method (i) or (ii).

The repeating unit having (meth)acryloyl group in its side chain preferably accounts for from 5% to 90% by weight, more preferably from 30% to 70% by weight, particularly from 40% to 60% by weight of the aforementioned copolymer.

The aforementioned copolymer may be properly copolymerized with other vinyl monomers besides the aforementioned repeating unit derived from fluorine-containing vinyl monomer and repeating unit having (meth)acryloyl group in its side chain from the standpoint of adhesivity to underlying layer such as transparent substrate, Tg of polymer (contributing to film hardness), solubility in solvent, transparency, slipperiness, dustproofness, stainproofness, etc. These vinyl monomers may be used in combination of two or more thereof. These vinyl monomers are preferably incorporated in an amount of from 0 to 65 mol-%, more preferably from 0 to 40 mol-%, particularly from 0 to 30 mol-% based on the weight of the copolymer.

The vinyl monomer unit employable herein is not specifically limited. Examples of the vinyl monomer unit employable herein include olefins (e.g., ethylene, propylene, isoprene, vinyl chloride, vinylidene chloride), acrylic acid esters (e.g., methyl acrylate, ethyl acrylate, 2-ethylhexyl acrylate, 2-hydroxyethyl acrylate), methacrylic acid esters (e.g., methyl methacrylate, ethyl methacrylate, butyl methacrylate, 2-hydroxyethyl methacrylate), styrene derivatives (e.g., styrene, p-hydroxymethyl styrene, p-methoxy styrene), vinyl ethers (e.g., methyl vinyl ether, ethyl vinyl ether, cyclohexyl vinyl ether, hydroxyethyl vinyl ether, hydroxy butyl vinyl ether), vinyl esters (e.g., vinyl acetate, vinyl propionate, vinyl cinnamate), unsaturated carboxylic acids (e.g., acrylic acid, methacrylic acid, crotonic acid, maleic acid, itaconic acid), acrylamides (e.g., N,N-dimethyl acrylamide, N-tert-butyl acrylamide, N-cyclohexyl acrylamide), methacrylamides (e.g., N,N-dimethyl methacrylamide), and acrylonitrile derivatives.

A preferred form of the copolymer comprising a repeating unit derived from fluorine-containing vinyl monomer and a repeating unit having (meth)acryloyl group in its side chain to be used in the invention is represented by the following formula (3).

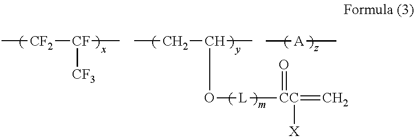

In the formula (3), L represents a connecting group having from 1 to 10 carbon atoms, preferably from 1 to 6 carbon atoms, particularly from 2 to 4 carbon atoms, which may have a straight-chain, branched or cyclic structure and may have hetero atoms selected from the group consisting of oxygen, nitrogen and sulfur.

Preferred examples of the connecting group include *—(CH₂)₂—O—**, *—(CH₂)₂—NH—**, *—(CH₂)₄—O—**, *—(CH₂)₆O—**, *—(CH₂)₂—O—(CH₂)₂—O—**, —CONH—(CH₂)₃—O—**, *—CH₂CH(OH)CH₂—O—**, and *—CH₂CH₂OCONH(CH₂)₃—O—** (The symbol * indicates the connecting site on the polymer main chain side. The symbol ** indicates the connecting site on the (meth)acryloyl group side.). The suffix m represents 0 or 1.

In the formula (3), X represents a hydrogen atom or methyl group. X is preferably a hydrogen atom from the standpoint of curing reaction.

In the formula (3), A represents a repeating unit derived from an arbitrary vinyl monomer. The repeating unit A is not specifically limited so far as it is a constituent of monomer copolymerizable with hexafluoropropylene. The repeating unit A can be properly selected from the standpoint of adhesivity to underlying layer such as transparent support, Tg of polymer (contributing to film hardness), solubility in solvent, transparency, slipperiness, dustproofness, stainproofness, etc. The repeating unit A may be composed of a single or a plurality of vinyl monomers.

Preferred examples of the repeating unit A include vinyl ethers such as methyl vinyl ether, ethyl vinyl ether, t-butyl vinyl ether, cyclohexyl vinyl ether, isopropyl vinyl ether, hydroxyethyl vinyl ether, hydroxy butyl vinyl ether, glycidyl vinyl ether and allyl vinyl ether, vinyl esters such as vinyl acetate, vinyl propionate and vinyl butyrate, (meth)acrylates such as methyl (meth)acrylate, ethyl (meth)acrylate, hydroxyethyl (meth)acrylate, glycidyl (meth)acrylate, allyl (meth)acrylate and (meth)acryloyloxy propyl trimethoxysilane, styrene derivatives such as styrene and p-hydroxymethylstyrene, unsaturated carboxylic acids such as crotonic acid, maleic acid and itaconinc acid, and derivatives thereof. Preferred among these repeating units are vinyl ether derivatives and vinyl ester derivatives. Particularly preferred among these repeating units are vinyl ether derivatives.

The suffixes x, y and z each represent the molar percentage of the respective constituent. The suffixes x, y and z satisfy the relationships 30≦x≦60, 5≦y≦70 and 0≦z≦65, preferably 35≦x≦55, 30≦y≦60 and 0≦z≦20, particularly 40≦x≦55, 40≦y≦55 and 0≦z≦10.

A particularly preferred form of the aforementioned copolymer is represented by the following formula (4):

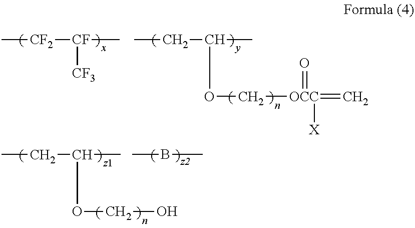

In the formula (4), X, x and y and their preferred range are as defined in the formula (3).

The suffix n represents an integer of 2 to 10, preferably 2 to 6, particularly from 2 to 4.

B represents a repeating unit derived from an arbitrary vinyl monomer. The repeating unit B may be composed of a single composition or a plurality of compositions. Examples of the repeating unit B include those listed with reference to A in the formula (3).

The suffixes z1 and z2 each represent the molar percentage of the respective repeating unit. The suffixes z1 and z2 satisfy the relationships 0≦z1≦65 and 0≦z2≦65, preferably 0≦z1≦30 and 0≦z2≦10, particularly 0≦z1≦10 and 0≦z2≦5.

It is particularly preferred that the copolymer represented by the formula (4) satisfy the relationships 40≦x≦60, 30≦y≦60 and z2=0.

The copolymer represented by the formula (3) or (4) can be synthesized, e.g., by introducing a (meth)acryloyl group into a copolymer containing a hexafluoropropylene component and a hydroxyalkyl vinyl ether component by any of the aforementioned methods.

Specific examples of the copolymer useful in the invention include those listed in JP-A-2004-45462, paragraphs [0043]-[0047] Methods for the synthesis of these copolymers, too, are described in detail in the above cited patent.

The synthesis of the copolymer to be used in the invention is carried out by any of various methods other than described above, e.g., method which comprises synthesizing a precursor such as hydroxyl group-containing polymer by any polymerization method such as solution polymerization, precipitation polymerization, suspension polymerization, bulk polymerization and emulsion polymerization, and then subjecting the precursor to the aforementioned polymer reaction to introduce a (meth)acryloyl group into the precursor. The polymerization reaction can be effected in a known process such as batchwise process, half-continuous process and continuous process.

Examples of the method for the initiation of polymerization include a method involving the use of a radical polymerization initiator, and a method involving the irradiation with light rays or radiation. For the details of these polymerization methods and polymerization initiating methods, reference can be made to Teiji Tsuruta, “Kobunshi Gosei Hoho (Polymer Synthesis Methods)”, revised edition, THE NIKKAN KOGYO SHINBUN LTD., 1971, and Takayuki Otsu and Masayoshi Kinoshita, “Kobunshi Gosei no Jikkenho (Experimental Methods of Polymer Synthesis)”, Kagakudojin, 1972, pp. 124-154.

Particularly preferred among the aforementioned polymerization methods is solution polymerization using a radical polymerization initiator. Examples of the solvent to be used in solution polymerization include various organic solvents such as ethyl acetate, butyl acetate, acetone, methyl ethyl ketone, methyl isobutyl ketone, cyclohexanone, tetrahydrofurane, dioxane, N,N-dimethylformamide, N,N-dimethyl acetamide, benzene, toluene, acetonitrile, methylene chloride, chloroform, dichloroethane, methanol, ethanol, 1-propanol, 2-propanol, and 1-butanol. These organic solvents may be used singly or in combination of two or more thereof or in admixture with water.

The polymerization temperature needs to be predetermined in connection with the molecular weight of the polymer thus produced, the kind of the initiator, etc. and may be from not higher than 0° C. to not lower than 100° C. but is preferably from 50° C. to 100° C.

The reaction pressure can be properly predetermined but normally is preferably from 1 to 100 kg/cm², particularly from 1 to 30 kg/cm². The reaction time is from about 5 hours to 30 hours.

Preferred examples of the reprecipitating solvent for the polymer thus obtained include isopropanol, hexane, and methanol.

The composition to be used in the preparation of the low refractive index layer of the invention is preferably in the form of coating compound. The coating compound is prepared by dissolving a fluorine-containing compound as an essential constituent, optionally with various additives and a radical polymerization initiator, in a proper solvent. During this procedure, the solid content concentration is properly predetermined depending on the purpose but is preferably from about 0.01% to 60% by weight, more preferably from about 0.5% to 50% by weight, particularly from about 1% to 20% by weight.

The low refractive index layer may comprise additives such as filler (e.g., inorganic particles, organic particles), lubricant (e.g., polysiloxane such as dimethyl silicone), organosilane compound and derivative thereof, binder and surface active agent incorporated therein depending on the purpose. It is particularly preferred that a filler (e.g., inorganic particles, organic particles) or a lubricant (e.g., polysiloxane compound such as dimethyl silicone) be incorporated in the low refractive index layer.

The filler, lubricant and other additives which are preferably incorporated in the low refractive index layer will be described hereinafter.

### (Preferred Filler for Low Refraction Layer)

A filler (e.g., inorganic particles, organic particles) is preferably added to enhance the physical strength (e.g., scratch resistance) of the low refractive index layer. The filler to be incorporated in the low refractive index layer is preferably an inorganic particles. Preferred examples of the inorganic particles employable herein include silicon dioxide (silica), and fluorine-containing particles (e.g., magnesium fluoride, calcium fluoride, barium fluoride), which have a low refractive index. Particularly preferred among these inorganic particles are silicon dioxide (silica).

The weight-average particle diameter of the primary particles of filler is preferably from 1 nm to 150 nm, more preferably from 1 n to 100 nm, most preferably from 1 nm to 80 nm. The filler is preferably dispersed more finely in the low refractive index layer. The filler is preferably in the form of grain, sphere, cube, spindle, short fiber or ring (hollow) or in amorphous form. Particularly preferred among these forms are spherical, amorphous and hollow. The filler may be either crystalline or noncrystalline.

The filler may be subjected to physical surface treatment such as plasma discharge treatment or chemical surface treatment with a surface active agent, coupling agent or the like to enhance its dispersion stability in the dispersion or coating compound or enhance its affinity or bonding to the constituents of the low refractive index layer. Particularly preferred among these surface treatments is surface treatment with a coupling agent. As such a coupling agent there is preferably used an alkoxy compound (e.g., titanate coupling agent, silane coupling agent). Particularly preferred among these coupling agents is silane coupling agent.

The surface treatment of the filler is preferably effected prior to the preparation of the low refractive index layer. The surface treatment with a coupling agent, if effected, is preferably carried out by adding a coupling agent to the coating compound which is being prepared.

It is preferred that the filler be previously dispersed in a medium (e.g., solvent).

The amount of the filler to be added is preferably from 5% to 70% by weight, more preferably from 10% to 50% by weight, particularly from 20% to 40% by weight based on the total weight of the low refractive index layer. When the added amount of the filler is too small, the effect of enhancing physical strength (e.g., scratch resistance) is eliminated. When the added amount of the filler is too great, the low refractive index layer can be clouded.

The average particle diameter of the filler is preferably from 20% to 100%, more preferably from 30% to 80%, particularly from 30% to 50% of the thickness of the low refractive index layer.

The particulate silicon dioxide, if incorporated in the low refractive index layer, is particularly preferably a hollow particulate silicon dioxide.

The refractive index of the hollow particulate silicon dioxide is preferably from 1.17 to 1.40, more preferably from 1.17 to 1.35, even more preferably from 1.17 to 1.30. The refractive index of the hollow particulate silicon dioxide used herein means the refractive index of the entire particles rather than the refractive index of only the shell silica constituting the hollow particulate silicon dioxide. Supposing that the radius of the bore of the particle is a and the radius of the shell of the particle is b, the percent void x represented by the following numerical formula (II) is preferably from 10% to 60%, more preferably from 20% to 60%, most preferably from 30% to 60%.

x=(4πa³/3)/(4πb³/3)×100 (II)

When the hollow particulate silica has a lower refractive index and a greater percent void, the thickness of the shell is reduced, reducing the strength of the grain. Therefore, particles having a refractive index of less than 1.17 cannot be established from the standpoint of scratch resistance.

For the measurement of the refractive index of the hollow particulate silica, an Abbe refractometer (produced by ATAGO CO., LTD.) was used.

For the details of the method for producing hollow silica, reference can be made to JP-A-2001-233611 and JP-A-2002-79616.

The spread of the hollow silica is preferably from 1 mg/m² to 100 mg/m², more preferably from 5 mg/m² to 80 mg/m², even more preferably from 10 mg/m² to 60 mg/m². When the spread of the hollow silica is too small, the effect of reducing refractive index or enhancing scratch resistance is eliminated. When the spread of the hollow silica is too great, the surface of the low refractive index layer is slightly roughened, deteriorating external appearance such as black tone and density and integrated reflectance.

The average particle diameter of the hollow silica is preferably from 30% to 150%, more preferably from 35% to 80%, even more preferably from 40% to 60% of the thickness of the low refractive index layer. In other words, when the thickness of the low refractive index layer is 100 nm, the particle diameter of the hollow silica is preferably from 30 nm to 150 nm, more preferably from 35 nm to 80 nm, even more preferably from 40 nm to 60 nm.

When the particle diameter of the particulate silica is too small, the proportion of the bore portion is reduced, making it possible to expect the reduction of refractive index. When the particle diameter of the particulate silica is too great, the surface of the low refractive index layer is slightly roughened, deteriorating external appearance such as black tone and density and integrated reflectance. The particulate silica may be either crystalline or amorphous. The particulate silica is preferably monodisperse. The particulate silica is most preferably in spherical form but may be amorphous without any problem.

The average particle diameter of the hollow silica can be determined on electron microphotograph.

In the invention, a particulate silica free of bore may be used in combination with the hollow silica. The particle size of the silica free of bore is preferably from 30 nm to 150 nm, more preferably from 35 nm to 80 nm, most preferably from 40 nm to 60 nm.

At least one of particulate silica materials having an average particle diameter of less than 25% of the thickness of the low refractive index layer (hereinafter referred to as “low particle diameter particulate silica”) is preferably used in combination with a particulate silica having the above defined particle diameter (hereinafter referred to as “large particle diameter particulate silica”).

The large particle diameter particulate silica can be present in the gap between the large particle diameter silica particles and thus can act as a retainer for the large particle diameter particulate silica.

The average particle diameter of the small particle diameter particulate silica is preferably from 1 nm to 20 nm, more preferably from 5 nm to 15 nm, particularly from 10 nm to 15 nm. The use of such a particulate silica is advantageous in material cost and retainer effect.

### <Preferred Lubricant for Low Refractive Index Layer>

A lubricant is preferably added from the standpoint of enhancement of physical properties (e.g., scratch resistance) of the low refractive index layer.

Examples of the lubricant employable herein include fluorine-containing ether compounds (e.g., perfluoropolyether, derivatives thereof), and polysiloxane compounds (e.g., dimethyl polysiloxane, derivatives thereof). Preferred among these lubricants are polysiloxane compounds.

A preferred example of the polysiloxane compounds is a compound containing a plurality of dimethyl silyloxy groups as repeating unit and having substituents at least at the end thereof and/or in its side chains.

The compound containing dimethyl silyloxy groups as repeating unit may contain structural units (substituents) other than dimethyl silyloxy group. These substituents may be the same or different. A plurality of these substituents are preferably present.

Preferred examples of these substituents include those containing (meth)acryloyl groups, vinyl groups, aryl groups, cinnamoyl groups, epoxy groups, oxetanyl groups, hydroxyl groups, fluoroalkyl groups, polyoxyalkylene groups, carboxyl groups, and amino groups.

The molecular weight of the lubricant is not specifically limited but is preferably 100,000 or less, particularly 50,000 or less, most preferably from 3,000 to 30,000. The content of silicon atom in the siloxane compound is not specifically limited but is preferably 5% by weight or more, particularly from 10% to 60% by weight, most preferably from 15% to 50% by weight.

Particularly preferred examples of the lubricant include polysiloxane compounds having a crosslinking or polymerizable functional group represented by the following formula (A) and derivatives thereof (e.g., crosslinking or polymerization products of polysiloxane compound represented by the formula (A), reaction products of polysiloxane compound represented by the formula (A) with compound having a crosslinking or polymerizable functional group other than polysiloxane compound).

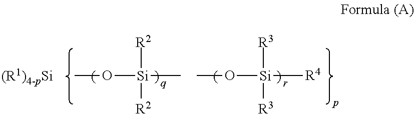

In the formula (A), R¹ to R⁴ each independently represent a C₁-C₂₀ substituent, with the proviso that a plurality of these groups, if any, may be the same or different and at least one of R¹, R³ and R⁴ represents a crosslinking or polymerizable functional group.

The suffix p represents an integer that satisfies the relationship 1≦p≦4. The suffix q represents an integer that satisfies the relationship 10≦q≦500. The suffix r represents an integer that satisfies the relationship 0≦r≦500. The polysiloxane moiety surrounded by the parenthesis { } may be a random copolymer or block copolymer.

The low refractive index layer to be used in the invention preferably contains at least any of polysiloxane compound having a crosslinking or polymerizable functional group represented by the formula (A) and derivatives thereof and cured materials containing fluorine-containing compound.

The content of any of the polysiloxane compound and/or derivatives thereof is preferably from 0.1% to 30% by weight, more preferably from 0.5% to 15% by weight, particularly from 1% to 10% by weight based on the weight of the fluorine-containing compound.

The crosslinking or polymerizable functional group which is preferably incorporated in the polysiloxane compound and/or derivatives thereof may be a functional group that can undergo crosslinking or polymerization reaction with other constituents of the outermost layer (e.g., fluorine-containing compound, binder) to form a bond. Examples of the functional group employable herein include groups having active hydrogen atom (e.g., hydroxyl group, carboxyl group, amino group, carbamoyl group, mercapto group, β-ketoester group, hydrosilyl group, silanol group), cationically polymerizable groups (e.g., epoxy group, oxetanyl group, oxazolyl group, vinyl group, vinyloxy group), groups having an unsaturated double bond capable of undergoing crosslinking or polymerization with radical seed (e.g., (meth)acryloyl group, allyl group), hydrolyzable silyl groups (e.g., alkoxysilyl group, acyloxysilyl group), acid anhydrides, isocyanate groups, and groups substitutable by nuecleophilic agent (e.g., active halogen atom, sulfonic acid ester).

These crosslinking or polymerizable functional groups may be properly selected according to the constituents of the low refractive index layer. An ionizing radiation-curing functional group is preferably used.

The crosslinking or polymerizable functional group in the formula (A) preferably undergoes crosslinking or polymerization reaction with the crosslinking or polymerizable functional group in the fluorine-containing compound. Particularly preferred examples of the functional group include cationic ring-opening polymerization-reactive groups (particularly epoxy group, oxetanyl group, etc.), and radical polymerization-reactive groups (particularly (meth) acryloyl group).

The substituent represented by R² in the formula (A) is a C₁-C₂₀ substituted or unsubstituted organic group. Preferred examples of the C₁-C₂₀ substituted or unsubstituted organic group include C₁-C₁₀ alkyl groups (e.g., methyl group, ethyl group, hexyl group), fluorinated alkyl groups (e.g., trifluoromethyl group, pentafluoroethyl group), and C₆-C₂₀ aryl groups (e.g., phenyl group, naphthyl group). More desirable among these organic groups are C₁-C₅ alkyl groups, fluorinated alkyl groups, and phenyl groups. Particularly preferred among these organic groups is methyl group. These organic groups may be further substituted by these organic groups.

In the case where R¹, R², R³ and R⁴ in the formula (A) each are not a crosslinking or polymerizable functional group, they may each be the aforementioned organic group.

The suffix x represents an integer that satisfies the relationship 1≦p≦4. The suffix q represents an integer that satisfies the relationship 10≦q≦500, preferably from 50≦q≦400, particularly from 100≦q≦300. The suffix r represents an integer that satisfies the relationship 0≦r≦500, preferably from 0≦r≦q, particularly from 0≦r≦0.5q.

Referring to the polysiloxane structure of the compound represented by the formula (A), the repeating unit (—OSi(R²)₂—) may be a homopolymer composed of a single substituent (R²) or a random copolymer or block copolymer composed of repeating units having different substituents in combination.

The weight-average molecular weight of the compound represented by the formula (A) is preferably from 10³ to 10⁶, more preferably from 5×10³ to 5×10⁵, particularly from 10⁴ to 10⁵.

As the polysiloxane compound represented by the formula (A) there may be used a commercially available product such as KF-100T, X-22-169AS, KF-102, X-22-37011E, X-22-164B, X-22-164C, X-22-5002, X-22-173B, X-22-174D, X-22-167B, X-22-161AS, X-22-174DX, X-22-2426, X-22-170DX, X-22-176D, X-22-1821 (produced by SHIN-ETSU CHEMICAL CO., LTD.), AK-5, AK-30, AK-32 (produced by TOAGOSEI CO., LTD.), and SILAPLANE FM-0275, FM-0721, FM-0725, FM-7725, DMS-U22, RMS-033, RMS-083, UMS-182 (produced by CHISSO CORPORATION). Alternatively, the polysiloxane compound represented by the formula (A) can be prepared by introducing crosslinking or polymerizable functional groups into the hydroxyl group, amino group, mercapto group, etc. contained in commercially available polysiloxane compounds.

Specific examples of preferred polysiloxane compound represented by the formula (A) include Compounds S-(1) to S-(32) disclosed in JP-A-2003-329804, [0041]-[0045], but the invention is not limited thereto.

The added amount of at least any of the polysiloxane compound represented by the formula (A) and/or derivatives thereof is preferably from 0.05% to 30% by weight, more preferably from 0.1% to 20% by weight, even more preferably from 0.5% to 15% by weight, particularly from 1% to 10% by weight based on the total solid content of the outermost layer.

### (Low Refractive Index Layer and Method for the Formation Thereof)

The low refractive index layer is preferably prepared by spreading a coating compound prepared by dissolving or dispersing the aforementioned fluorine-containing compound, optionally with the aforementioned filler and at least any of the aforementioned polysiloxane compound and/or derivatives thereof, in a solvent.

Preferred examples of the solvent employable herein include ketones (e.g., acetone, methyl ethyl ketone, methyl isobutyl ketone, cyclohexanone), esters (e.g., ethyl acetate, butyl acetate), ethers (e.g., tetrahydrofurane, 1,4-dioxane), alcohols (e.g., methanol, ethanol, isopropyl alcohol, butanol, ethylene glycol), aromatic hydrocarbons (e.g., toluene, xylene), and water.

Particularly preferred among these solvents are ketones, aromatic hydrocarbons, and esters. Most desirable among these solvents are ketones. Particularly preferred among these ketones are methyl ethyl ketone, methyl isobutyl ketone, and cyclohexanone. The content of the ketone-based solvents in all the solvents contained in the coating compound is preferably 10% by weight or more, more preferably 30% by weight or more, even more preferably 60% by weight or more.

Two or more solvents may be used in combination.

So far as the fluorine-containing compound contains a crosslinking or polymerizable functional group, the low refractive index layer is preferably prepared by the crosslinking or polymerization reaction of the fluorine-containing compound at the same time or after the spreading of the low refractive index layer coating compound.

In the case where the fluorine-containing compound has a radical-crosslinking or polymerizable functional group, the fluorine-containing compound preferably undergoes crosslinking or polymerization reaction in the presence of a radical polymerization initiator, particularly photoradical polymerization initiator. In the case where the fluorine-containing compound has a cationically crosslinking or polymerizable functional group, the fluorine-containing compound preferably undergoes crosslinking or polymerization reaction in the presence of a cationic polymerization initiator, particularly photocationic polymerization initiator.

As the radical polymerization initiator there is preferably used a compound which generates radical when acted upon by heat or light. In particular, a photoradical polymerization initiator is preferred as the photoradical polymerization initiator there is preferably used one disclosed above with reference to the antistatic layer.

A photocleavable photoradical polymerization initiator is particularly preferred. For the details of photocleavable photoradical polymerization initiators, reference can be made to Kazuhiro Takausu, “Saishin UV Koka Gijutsu (Modern UV-curing Technique)”, TECHNICAL INFORMATION INSTITUTION CO., LTD., page 159, 1991.

The photopolymerization initiator is preferably used in an amount of from 0.1 to 15 parts by weight, more preferably from 1 to 10 parts by weight based on 100 parts by weight of the fluorine-containing compound.

These photopolymerization initiators may be preferably used in combination with a photosensitizer. Examples of the photosensitizer employable herein include n-butylamine, triethylamine, tri-n-butylphosphine, Michler's ketone, and thioxanthone.

A commercially available photosensitizer, too, is preferably used. Examples of the photosensitizer employable herein include sensitizers disclosed with reference to the antistatic layer.

A binder is preferably added from the standpoint of enhancement of physical strength (e.g., scratch resistance) of the low refractive index layer and adhesivity of the low refractive index layer to the adjacent layer.

In the case where the fluorine-containing compound is a compound having a crosslinking or polymerizable functional group, the binder is preferably one having a functional group that undergoes crosslinking or polymerization with the fluorine-containing compound.

In particular, in the case where the fluorine-containing compound is one having a photo-crosslinking or photopolymerizable functional group, the binder is preferably a polyfunctional monomer having a photo-crosslinking or photopolymerizable functional group. Specific examples of the photopolymerizable polyfunctional monomer having a photopolymerizable functional group include those listed with reference to the light diffusion layer. Two or more polyfunctional monomers may be used in combination.

The cured low refractive index layer is preferably a cured layer formed by a fluorine-containing compound having a crosslinking or polymerizable functional group, a polysiloxane compound represented by the formula (A) and/or derivative thereof, and/or a binder that undergoes crosslinking or polymerization with a fluorine-containing compound having a crosslinking or polymerizable functional group.

The low refractive index layer is preferably prepared by spreading a coating compound having a fluorine-containing compound and other constituents of outermost layer dissolved or dispersed therein, accompanied by or followed by the crosslinking or polymerization reaction thereof involving irradiation with light or electron beam or heating.

In the case where irradiation with ultraviolet rays is effected, ultraviolet rays emitted by a light source such as ultrahigh pressure mercury vapor lamp, high pressure mercury vapor lamp, carbon arc, xenon arc, metal halide lamp, etc. may be used.

The preparation of the low refractive index layer is preferably effected in an atmosphere having an oxygen concentration of 4 vol-% or less if the outermost layer is formed by the crosslinking or polymerization reaction of an ionizing radiation-curing compound.

By preparing the low refractive index layer in an atmosphere having an oxygen concentration of 4 vol-% or less, the physical strength (e.g., scratch resistance), chemical resistance and weathering resistance of the low refractive index layer and the adhesivity of the low refractive index layer to the adjacent layer can be enhanced.

The crosslinking or polymerization reaction of the ionizing radiation-curing compound is preferably effected in an atmosphere having an oxygen concentration of 3 vol-% or less, more preferably 2 vol-% or less, particularly 1 vol-% or less, most preferably 0.5 vol-% or less.

The reduction of the oxygen concentration in the atmosphere to 4 vol-% or less is preferably carried out by replacing the atmosphere (nitrogen concentration: about 79 vol-%; oxygen concentration: about 21 vol-%) by other gases, particularly nitrogen (nitrogen purge).

The thickness of the low refractive index layer is preferably from 30 nm to 200 nm, more preferably from 50 nm to 150 nm, particularly from 60 nm to 120 nm.

The thickness of the outermost layer, if formed on the low refractive index layer (e.g., as a stainproof layer), is preferably from 3 nm to 50 nm, more preferably from 5 nm to 35 nm, particularly from 7 nm to 25 nm.

The low refractive index layer preferably has a surface dynamic friction coefficient of 0.25 or less, more preferably 0.17 or less, particularly 0.15 or less to enhance the physical strength of the anti-reflection film. The term “dynamic friction coefficient” as used herein is meant to indicate the dynamic friction coefficient of the surface of the low refractive index layer with respect to a stainless steel sphere having a diameter of 5 mm developed when the stainless steel sphere is moved along the surface of the low refractive index layer at a speed of 60 cm/min under a load of 0.98 N.

In order to enhance the stainproofness of the anti-reflection film, the contact angle of the low refractive index layer with respect to water is preferably 90° or more, more preferably 95° or more, particularly 100° or more.

It is preferred that the contact angle of the low refractive index layer with respect to water undergo no change, preferably a change of 10° or less, particularly 5° or less between from and after saponification.

The haze of the low refractive index layer is preferably as small as possible, more preferably 3% or less, even more preferably 2% or less, particularly 1% or less.

The strength of the low refractive index layer is preferably H or more, more preferably 2H or more, most preferably 3H or more as determined by pencil hardness test according to HS K-5400. The abrasion of the low refractive index layer from before test to after test is preferably as small as possible as determined by Taber test according to JIS K-5400.

The low refractive index layer may comprise a surface active agent, an antistatic agent, a coupling agent, a thickening agent, a coloring inhibitor, a coloring agent (pigment, dye), an anti-foaming agent, leveling agent, a fire retardant, an ultraviolet absorber, an infrared absorber, an adhesivity-providing agent, a polymerization inhibitor, an oxidation inhibitor, a surface modifier, etc. incorporated therein besides the aforementioned components (e.g., fluorine-containing compound, polymerization initiator, photosensitizer, filler, lubricant, binder).

In the case where the low refractive index layer is disposed under the outermost layer, it preferably contains a silicon compound.

The refractive index of the low refractive index layer is preferably from 1.20 to 1.55, more preferably from 1.31 to 1.49, even more preferably from 1.35 to 1.48, particularly from 1.37 to 1.45.

In the case where the low refractive index layer is disposed under the outermost layer, the low refractive index layer is prepared by a coating method or a gas phase method (vacuum metallizing method, sputtering method, ion plating method, plasma CVD method). The coating method is preferably used because the low refractive index layer can be produced at low cost.

In the case where the low refractive index layer is prepared by a coating method, a compound selected from the group consisting of silicon compound represented by the following formula (1) and derivatives thereof (e.g., hydrolyzate and crosslinked silicon compound produced by the condensation thereof) can be used to prepare the low refractive index layer. In this case, a crosslinked or polymerizable silicon compound is preferably used to prepare the low refractive index layer.

(X¹)ₐ(Y¹)_{b}S(Z¹)_{4-a-b} (I)

wherein X¹ represents a C₁-C₁₂ organic group (e.g., alkyl, aryl, halogenated alkyl, halogenated aryl, alkenyl, epoxy group, (meth)acryloxy group, mercapto group, amino group, cyano group); Y¹ represents a C₁-C₃ hydrocarbon group; Z¹ represents a halogen atom or alkoxy group (e.g., OCH₃, OC₂H₅, OC₃H₇); and the suffixes a and b may be the same or different and each represent an integer of from 0 to 2.

Specific examples of the silicon compound of the formula (1) include tetraalkoxysilanes such as methyl silicate and ethyl silicate, trialkoxysilanes or triacyloxysilanes such as methyl trimethoxysilane, methyl triethoxysilane, methyl trimethoxyethoxysilane, methyl triacetoxysilane, methyl tributoxysilane, ethyl trimethoxysilane, vinyl trimethoxysilane, vinyl triethoxysilane, vinyl triacetoxysilane, vinyl trimethoxyethoxysilane, phenyl trimethoxysilane, phenyl triethoxysilane, phenyl triacetoxysilane, γ-chloropropyltrimethoxysilane, γ-chloropropyltriethoxy silane, γ-chloropropyltriacetoxysilane, 3,3,3-trifluoropropyltrimethoxysilane, γ-glycidoxypropyl trimethoxysilane, γ-glycidoxypropyl triethoxysilane, γ-(β-glycidoxyethoxy)propyltrimethoxysilane, β-(3,4-epoxycyclohexyl)ethyltrimethoxysilane, β-(3,4-epoxy cyclohexyl)ethyltriethoxysilane, γ-methacryloxyopropyltrimethoxysilane, γ-amiopropyltrimethoxysilane, γ-amiopropyltriethoxy silane, γ-mercaptopropyltrimethoxysilane, γ-mercapto propyltriethoxysilane, N-β-(aminoethyl)-γ-aminopropyltrimethoxysilane and β-cyanoethyl triethoxysilane, and dialkoxysilanes or diacyloxysilanes such as dimethyldimethoxysilane, dimethyldiethoxysilane, phenylmethyldimethoxy silane, phenyldimethyldiethoxysilane, γ-glycidoxy propylmethyldimethoxysilane, γ-glycidoxypropylmethyl diethoxysilane, γ-glycidoxypropylphenyldimethoxy silane, γ-glycidoxypropylphenyldiethoxy silane, γ-chloropropylmethyldimethoxysilane, γ-chloropropyl methyldiethoxysilane, dimethyldiacetoxysilane, γ-methacrylooxypropylmethyldimethoxysilane, γ-methacrylooxypropylmethyldiethoxysilane, γ-mercapto propylmethyldimethoxysilane, γ-mercaptopropylmethyl diethoxysilane, γ-aminopropylmethyldimethoxy silane, γ-aminopropylmethyldiethoxysilane, methylvinyl dimethoxysilane and methylvinyldimethoxysilane. However, the invention is not specifically limited to these silicon compounds.

In the case where hardness is needed in particular, an ionizing radiation-curable silicon compound, particularly a silicon compound having a molecular weight of 5,000 or less containing a plurality of functional groups that undergoes crosslinking or polymerization reaction when irradiated with an ionizing radiation is preferably used. Examples of such an ionizing radiation-curable silicon compound employable herein include single-ended vinyl-functional polysilanes, double-ended vinyl-functional polysilanes, single-ended vinyl-functional polysiloxanes, double-ended vinyl-functional polysiloxanes, and vinyl-functional polysilanes and vinyl-functional polysiloxanes obtained by the reaction of these compounds. Silicon compounds containing epoxy group or (meth)acryloyl group are preferably used. These silicon compounds may be used singly or in combination of two or more thereof.

These silicon compounds are preferably cured with various curing agents in the presence of various catalysts. Examples of these curing agents and catalysts include various acids and bases containing Lewis acids and bases, and neutral and basic salts prepared therefrom, e.g., organic carboxylic acid, chromic acid, hypochlorous acid, boric acid, bromic acid, selenious acid, thiosulfuric acid, orthosilicic acid, thiocyanic acid, nitrous acid, aluminic acid, salt of carbonic acid with metal, particularly with alkali metal or ammonium, aluminum, zirconium and titanium alkoxide, complexes thereof. Particularly preferred among these compounds are aluminum chelate compounds such as ethyl acetoacetate aluminum diisopropylate, aluminum trisethyl acetoacetate, alkyl acetoacetate aluminum diisopropylate, aluminum monoacetyl acetonate bisethyl acetoacetate and aluminum trisacetyl acetate.

The low refractive index layer preferably comprises an inorganic particles made of LiF, MgF₂, SiO₂ or the like incorporated therein. Particularly preferred among these materials is SiO₂.

### (Organosilane Compound)

The organosilane compound which can be particularly preferably incorporated in the various layers of the anti-reflection film in the invention will be further described hereinafter.

From the standpoint of enhancing the physical properties (e.g., scratch resistance) of film and the adhesivity of film to adjacent layer, an organosilane compound and/or derivatives thereof can be incorporated in any of the layers on the transparent substrate.

As the organosilane compound and/or derivatives thereof there may be used a compound represented by the following formula (a) and/or derivatives thereof. Preferred examples of these compounds include organosilane compounds containing hydroxyl group, mercapto group, carboxyl group, epoxy group, alkyl group, alkoxysilyl group, acyloxy group and acylamino group. Particularly preferred among these compounds are organosilane compounds containing epoxy group, polymerizable acyloxy group (e.g., (meth)acryloyl) and polymerizable acylamino group (e.g., acrylamino, methacrylamino).

(R¹⁰)ₛ—Si(Z)₋₄₋ₛ (a)

In the formula (a), R¹⁰ represents a substituted or unsubstituted alkyl or aryl group. Examples of the alkyl group include methyl, ethyl, propyl, isopropyl, hexyl, decyl, and hexadecyl. The alkyl group preferably has from 1 to 30, more preferably from 1 to 16, particularly from 1 to 6-carbon atoms. Examples of the aryl group include phenyl, and naphthyl. Preferred among these aryl groups is phenyl.

Z represents a hydroxyl group or hydrolyzable group. Examples of these groups include alkoxy groups (preferably alkoxy groups having from 1 to 5 carbon atoms such as methoxy and ethoxy), halogen atoms (e.g., Cl, Br, I), and groups represented by R¹²COO (in which R¹² is preferably a hydrogen atom or C₁-C₅ alkyl group such as CH₃COO and C₂H₅COO). Preferred among these groups are alkoxy groups. Particularly preferred among these alkoxy groups are methoxy and ethoxy.

The suffix s represents an integer of from 1 to 3, preferably 1 or 2, particularly 1.

The plurality of R¹⁰'s or X's, if any, may be the same or different.

The substituents on R¹⁰ are not specifically limited but may be halogen atoms (e.g., fluorine, chlorine, bromine), hydroxyl groups, mercapto groups, carboxyl groups, epoxy groups, alkyl groups (e.g., methyl, ethyl, i-propyl, propyl, t-butyl), aryl groups (e.g., phenyl, naphthyl), aromatic heterocyclic groups (e.g., furyl, pyrazolyl, pyridyl), alkoxy groups (e.g., methoxy, ethoxy, i-propoxy, hexyloxy), aryloxy groups (e.g., phenoxy), alkenyl groups (e.g., vinyl, l-propenyl), acyloxy groups (e.g., acetoxy, acryloyloxy, methacryloxy), alkoxycarbonyl groups (e.g., methoxycarbonyl, ethoxycarbonyl), aryloxycarbonyl groups (e.g., phenoxycarbonyl), carbamoyl groups (e.g., carbamoyl, N-methylcarbamoyl, N,N-dimethylcarbamoyl, N-methyl-N-octylcarbamoyl), and acylamino groups (acetylamino, benzoylamino, acrylamino, methacryl amino). These substituents may be further substituted by these substituents.

Even more desirable among these substituents are hydroxyl groups, mercapto groups, carboxyl groups, epoxy groups, alkoxysilyl groups, acyloxy groups, and acylamino groups. Particularly preferred among these substituents are crosslinking or polymerizable functional groups. Preferred among these crosslinking or polymerizable functional groups are epoxy groups, polymerizable acyloxy groups ((meth)acryloyl), and polymerizable acylamino groups (acrylamino, methacrylamino). These substituents may be further substituted by the aforementioned substituents.

At least one of the plurality of R¹⁰'s, if any, is preferably a substituted or unsubstituted alkyl or aryl group. Preferred among the organosilane compounds represented by the formula (a) and derivatives thereof are an organosilane compound having a vinyl-polymerizable substituent represented by the following formula (b) and/or derivatives thereof.

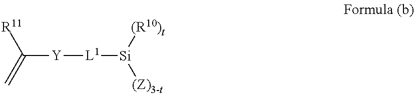

In the formula (b), R¹¹ represents a hydrogen atom, methyl group, methoxy group, alkoxycarbonyl group, cyano group, fluorine atom or chlorine atom. Examples of the alkoxycarbonyl group include methoxycarbonyl group, and ethoxycarbonyl group. Preferred among these groups are hydrogen atom, methyl group, methoxy group, methoxycarbonyl group, cyano group, fluorine atom, and chlorine atom. More desirable among these groups are hydrogen atom, methyl group, methoxycarbonyl group, fluorine atom, and chlorine atom. Particularly preferred among these groups are hydrogen atom and methyl group.

Y represents a single bond, *—COO—**, *—CONH—**, *—O—** or *—NH—CO—NH—**, preferably single bond, *—COO—** or *—CONH—**, more preferably single bond or *—COO—**, particularly *—COO—**. The symbol * indicates the position at which the group is connected to ═C(R¹¹)—. The symbol ** indicates the position at which the group is connected to L¹.

L¹ represents a divalent connecting chain. Specific examples of the divalent connecting chain include substituted or unsubstituted alkylene or arylene group, substituted or unsubstituted alkylene group having a connecting group (e.g., ether, ester, amide) therein, and substituted or unsubstituted arylene group having a connecting group therein. Preferred among these divalent connecting chains are substituted or unsubstituted alkylene or arylene group, and substituted or unsubstituted alkylene group having a connecting group therein. More desirable among these divalent connecting chains are unsubstituted alkylene group, unsubstituted arylene group, and substituted or unsubstituted alkylene group having a connecting group therein. Particularly preferred among these divalent connecting chains are unsubstituted alkylene group, and substituted or unsubstituted alkylene group having a connecting group therein. Examples of the substituents on these groups include halogen atoms, hydroxyl groups, mercapto groups, carboxyl groups, epoxy groups, alkyl groups, and aryl groups. These substituents may be further substituted.

The suffix t represents 0 or 1. The suffix t is preferably 0.

R¹⁰ is as defined in the formula (a). R¹⁰ is preferably a substituted or unsubstituted alkyl or aryl group, more preferably unsubstituted alkyl or aryl group.

Z is as defined in the formula (a). Z is preferably a halogen atom, hydroxyl group or unsubstituted alkoxy group, more preferably chlorine, hydroxyl group or unsubstituted C₁-C₆ alkoxy group, even more preferably hydroxyl group or C₁-C₃ alkoxy group, particularly methoxy group. A plurality of Z's, if any, may be the same or different.

Two or more of the compounds of the formulae (a) and (b) may be used in combination.

Specific examples of the compounds represented by the formulae (a) and (b) include M-1 to M-60 disclosed in JP-A-2004-170901, paragraph [0036]-[0044], but the invention is not limited thereto.

Particularly preferred among these compounds are (M-1), (M-2) and (M-5).

In the invention, the derivatives of the organosilane compounds represented by the formulae (a) and (b) mean hydrolyzates and partial condensates of the organosilane compounds represented by the formulae (a) and (b). Preferred derivatives (hydrolyzates and/or partial condensates) of organosilane compounds to be used in the invention will be described below.

The hydrolyzation reaction and/or condensation reaction of organosilane compound are normally effected in the presence of a catalyst. Examples of the catalyst employable herein include inorganic acids such as hydrochloric acid, sulfuric acid and nitric acid, organic acids such as oxalic acid, acetic acid, formic acid, methanesulfonic acid and toluenesulfonic acid, inorganic bases such as sodium hydroxide, potassium hydroxide and ammonia, organic bases such as triethylamine and pyridine, metal alkoxides such as triisopropoxy aluminum and tetrabutoxy zirconium, and metal chelate compounds comprising a metal such as zirconium, titanium and aluminum as a central metal. Preferred among these inorganic acids are hydrochloric acid and sulfuric acid. Preferred among these organic acids are those having an acid dissociation constant (pKa value (25° C.)) of 4.5 or less in water. More desirable among these acids are hydrochloric acid, sulfuric acid and organic acid having an acid dissociation constant of 3.0 or less in water. Particularly preferred among these acids are hydrochloric acid, sulfuric acid and organic acid having an acid dissociation constant of 2.5 or less in water. Even more desirable among these acids are those having an acid dissociation constant of 2.5 or less in water. In some detail, methanesulfonic acid, oxalic acid, phthalic acid and malonic acid are more desirable, particularly oxalic acid.

The hydrolysis/condensation reaction of organosilane can be effected free from solvent or in a solvent. However, an organic solvent is preferably used to uniformly mix the components. For example, alcohols, aromatic hydrocarbons, ethers, ketones and esters are preferably used.

As the solvent there is preferably used one capable of dissolving the organosilane and the catalyst therein. An organic solvent is preferably used as a coating compound or part thereof. An organic solvent which doesn't impair solubility or dispersibility when mixed with other materials is preferably used.

Among these organic solvents, an alcohol such as monovalent alcohol and divalent alcohol may be used. A preferred example of the monovalent alcohol is a C₁-C₈ saturated aliphatic alcohol.

Specific examples of these alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether, ethylene glycol monoethyl ether acetate.

Specific examples of the aromatic hydrocarbon include benzene, toluene, and xylene. Specific examples of the ethers include tetrahydrofurane, and dioxane. Specific examples of the ketones include acetone, methyl ethyl ketone, methyl isobutyl ketone, and diisobutyl ketone. Specific examples of the esters include ethyl acetate, propyl acetate, butyl acetate, and propylene carbonate.

These organic solvents may be used singly or in admixture of two or more thereof. The concentration of solid content in the reaction is not specifically limited but is normally from 1% to 90% by weight, preferably from 20% to 70% by weight.

In some detail, the hydrolysis/condensation reaction of the organosilane compound is effected with water added in an amount of from 0.3 to 2 mols, preferably from 0.5 to 1 mol per mol of the hydrolyzable group with stirring at a temperature of from 25° C. to 100° C. in the presence or absence of the aforementioned solvent in the presence of a catalyst.

In the invention, the hydrolysis reaction is preferably effected at a temperature of from 25° C. to 100° C. with stirring in the presence of an alcohol represented by the formula R¹³OH (in which R¹³ represents a C₁-C₁₀ alkyl group) and a compound represented by the formula R¹⁴COCH₂COR¹⁵ (in which R¹⁴ represents a C₁-C₁₀ alkyl group and R¹⁵ represents a C₁-C₁₀ alkyl group or C₁-C₁₀ alkoxy group) as a ligand and a metal selected from the group consisting of zirconium, titanium and aluminum as a central metal.

As the metal chelate compound there may be used one having an alcohol represented by the formula R¹³OH (in which R¹³ represents a C₁-C₁₀ alkyl group) and a compound represented by the formula R¹⁴COCH₂COR¹⁵ (in which R¹⁴ represents a C₁-C₁₀ alkyl group and R¹⁵ represents a C₁-C₁₀ alkyl group or C₁-C₁₀ alkoxy group) as a ligand and a metal selected from the group consisting of zirconium, titanium and aluminum as a central metal without any limitation. Two or more metal chelate compounds may be used in combination. The metal chelate compound to be used in the invention is preferably selected from the group consisting of compounds represented by the following formulae:

Zr(OR¹³)/ₚ₁(R¹⁴COCHCOR¹⁵)ₚ₂;

Ti(OR¹³)_{q1}(R¹⁴COCHCOR¹⁵)_{q2}; and

Al(OR¹³)ᵣ₁(R¹⁴COCHCOR¹⁵)ᵣ₂

The metal chelate compound of the invention acts to accelerate the condensation reaction of hydrolyzate and/or partial condensate of the organosilane compound.

R¹³ and R¹⁴ in the metal chelate compound may be the same or different and each represent a C₁-C₁₀ alkyl group such as ethyl, n-propyl, i-propyl, n-butyl, sec-butyl, t-butyl and n-pentyl or phenyl. R¹⁵ represents the same C₁-C₁₀ alkyl group as defined above or C₁-C₁₀ alkoxy group such as methoxy, ethoxy, n-propoxy, i-propoxy, n-butoxy, sec-butoxy and t-butoxy. The suffixes p1, p2, q1, q2, r1 and r2 in these formulae each represent an integer determined to satisfy the numerical formulae: P1+p2=4, q1+q2=4 and r1+r2=3.

Specific preferred examples of these metal chelate compounds include tri-n-butoxy ethyl acetoacetate zirconium, diisopropoxy bis(acetylacetate)titanium, diisopropoxyethyl acetoacetate aluminum, and tris(ethyl acetoacetate)aluminum. These metal chelate compounds may be used singly or in combination of two or more thereof.

The metal chelate compound is used preferably in an amount of from 0.01 to 50% by weight, more preferably from 0.1 to 50% by weight, even more preferably from 0.5 to 10% by weight based on the aforementioned organosilane compound. When the amount of the metal chelate compound falls below 0.01% by weight, the condensation reaction of the organosilane compound proceeds slowly, making it likely that the durability of the coat layer can be deteriorated. On the other hand, when the amount of the metal chelate compound exceeds 50% by weight, the storage stability of the composition containing the hydrolyzate and/or partial condensate of organosilane compound and the metal chelate compound can be deteriorated to disadvantage.

To the composition containing the aforementioned organosilane compound and/or derivatives thereof (hydrolyzate, partial condensate) and optionally the metal chelate compound are preferably added a β-diketone compound and/or a β-ketoester compound.

### <Spreading>

The preparation of the light diffusion film or anti-reflection film of the invention can be carried out by spreading a curable coating solution over a transparent substrate by any known method such as dipping method, spinner method, spraying method, roll coater method, gravure method, wire bar method, slot extrusion coater method (single layer, multilayer) and slide coater method, drying the coat layer, and then irradiating the coat layer with ultraviolet rays so that it is cured.

Drying is preferably effected under the conditions such that the dried coat layer contains an organic solvent in a concentration of 5% by weight or less, more preferably 2% by weight or less, even more preferably 1% by weight or less. The drying conditions are affected by the thermal strength of the substrate, the conveying speed, the length of drying step, etc. The content of the organic solvent is preferably as low as possible from the standpoint of enhancement of percent polymerization.

### <Light Diffusion Film>

The light diffusion film of the invention preferably has a surface dynamic friction coefficient of 0.25 or less, more preferably 0.17 or less, particularly 0.15 or less on the outermost layer side thereof to improve the physical strength (e.g., scratch resistance). The term “dynamic friction coefficient” as used herein is meant to indicate the dynamic friction coefficient of the surface of the low refractive index layer with respect to a stainless steel sphere having a diameter of 5 mm developed when the stainless steel sphere is moved along the surface of the low refractive index layer at a speed of 60 cm/min under a load of 0.98 N.

The haze of the light diffusion film is 3% or more, preferably 10% or more, more preferably 30% or more. On the other hand, the upper limit of the haze of the light diffusion film is preferably 70% or less. The higher the haze of the light diffusion film is, the more remarkable are point defects attributed to the maldistribution of particles. On the other hand, when the haze of the light diffusion film is too high, the image sharpness is deteriorated.

The reflectance of the light diffusion film of the invention is preferably as low as possible, more preferably 3.0% or less, even more preferably 2.5% or less, still more preferably 2.0% or less, particularly preferably 1.5% or less.

The anti-reflection film preferably has a contact angle of 90° or more, more preferably 95° or more, particularly preferably 100° or more with respect to water on the outermost layer side thereof to enhance the stainproofness thereof.

The light diffusion film or anti-reflection film of the invention thus produced can be provided with a known adhesive layer thereon so that it is used as a surface film for various display materials or can be used to prepare a polarizing plate which is then used in a liquid crystal displays. In this case, the polarizing plate is disposed on the outermost surface of the display with an adhesive layer provided on one side thereof. The light diffusion film or anti-reflection film of the invention is preferably used as at least one of two sheets of protective film between which the polarizing layer in the polarizing plate is interposed.

The light diffusion film or anti-reflection film of the invention can also act as a protective film to reduce the production cost of the polarizing plate. Further, the anti-reflection film of the invention can be used as an outermost layer to prevent the reflection of external light rays, etc., making it possible to provide a polarizing plate excellent also in scratch resistance, stainproofness, etc.

In order to use the light diffusion film or anti-reflection film of the invention as one of two sheets of surface protective film for polarizing plate to prepare a polarizing plate, the light diffusion film or anti-reflection film is preferably subjected to hydrophilicization on the side of the transparent substrate opposite the anti-reflection structure, i.e., on the side thereof where it is stuck to the polarizing layer to improve the adhesion of the adherend surface thereof.

### <Saponification>

### (1) Alkaline Solution Dipping Method

This is a method which comprises dipping the light diffusion film or anti-reflection film in an alkaline solution under proper conditions to saponify the entire surface of the film having reactivity with alkali. This method is advantageous in cost because it requires no special facilities. The alkaline solution is preferably an aqueous solution of sodium hydroxide. The concentration of the alkaline solution is preferably from 0.5 to 3 mol/l, particularly from 1 to 2 mol/l. The temperature of the alkaline solution is preferably from 30° C. to 75° C., particularly from 40° C. to 60° C.

The aforementioned combination of saponifying conditions is preferably a combination of relatively mild conditions but can be predetermined by the material and configuration of the light diffusion film or anti-reflection film and the target contact angle.

It is preferred that the light diffusion film or anti-reflection film which has been dipped in the alkaline solution be thoroughly washed with water or dipped in a dilute acid to neutralize the alkaline component so that the alkaline component is not left in the film.

When the light diffusion film or anti-reflection film is saponified, the transparent substrate is hydrophilicized on the side thereof opposite the light diffusion film or anti-reflection layer. The protective film for polarizing plate is used in such an arrangement that the hydrophilicized surface of the transparent substrate comes in contact with the polarizing layer.

The hydrophilicized surface of the transparent substrate is effective for the improvement of the adhesion to the adhesive layer mainly composed of polyvinyl alcohol.

Referring to saponification, the contact angle of the surface of the transparent substrate on the side thereof opposite the light diffusion layer or low refractive layer with respect to water is preferably as small as possible from the standpoint of adhesion to the polarizer. On the other hand, since the dipping method is subject to damage by alkali even on the surface of the transparent substrate on the light diffusion or low refractive layer side thereof, it is important to use minimum required reaction conditions. In the case where as an index of damage of light-scattering layer by alkali there is used the contact angle of the surface of the transparent substrate on the side thereof opposite the light diffusion layer, the contact angle is preferably from 10° to 50°, more preferably from 30° to 50°, even more preferably from 40° to 50°, if the transparent substrate is a triacetyl cellulose film in particular. When the contact angle is 50° or more, there arises a problem with contact with the polarizing layer to disadvantage. On the contrary, when the contact angle is less than 10°, the resulting anti-reflection layer undergoes too much damage and is subject to loss of physical strength to disadvantage.

### (2) Alkaline Solution Coating Method

As a method of avoiding the damage of the various layers in the aforementioned dipping method there is preferably used an alkaline solution coating method which comprises spreading an alkaline solution only over the surface of the transparent substrate on the side thereof opposite the light diffusion layer or anti-reflection layer, and heating, rinsing and drying the coat layer under proper conditions. The term “spreading” as used herein is meant to indicate that the alkaline solution or the like comes in contact with only the surface of the transparent substrate to be saponified. Besides spreading, spraying and contact with a belt or the like impregnated with an alkaline solution are included. Since the use of these methods requires the provision of separate facilities and steps for spreading the alkaline solution, this method is inferior to the dipping method (1) from the standpoint of cost. However, since the coating method involves the contact with only the surface of the transparent substrate to be saponified, it is advantageous in that the opposite side of the transparent substrate can be made of a material which is easily affected by alkaline solution. For example, the vacuum deposit or sol-gel layer is subject to various effects such as corrosion, dissolution and exfoliation by alkaline solution and is preferably not formed by the dipping method but may be formed by the coating method without any problems because it requires no contact with the alkaline solution.

Both the aforementioned saponification methods (1) and (2) can be conducted after the formation of the various layers on the substrate unwound from the roll. Therefore, these saponification methods can be each conducted as a continuous step following the aforementioned step of producing the light diffusion film or anti-reflection film. Further, by subsequently conducting the step of sticking the film to a polarizing layer of continuous length unwound, the polarizing plate can be prepared more efficiently than the similar process conducted in the form of sheet.

(3) Method which Comprises Saponifying Light Diffusion Film or Anti-Reflection Film Protected by Laminate Film

In the case where the light diffusion layer and/or low refractive index layer has an insufficient resistance to alkaline solution as in the aforementioned method (2), a method may be effected which comprises laminating the final layer thus formed with a laminate film on the final layer side thereof, dipping the layered product in an alkaline solution to hydrophilicize only the triacetyl cellulose side, which is opposite the final layer side, and then peeling the laminate film off the light diffusion layer. In accordance with this method, too, hydrophilicization required only for protective film for polarizing plate can be made on only the side of the triacetyl cellulose film opposite the final layer without any damage on the light diffusion layer and low refractive layer. As compared with the aforementioned method (2), the method (3) involves the disposal of the laminate film but is advantageous in that it requires no special apparatus for spreading an alkaline solution.

(4) Method which Comprises Dipping the Layered Product in an Alkaline Solution after the Formation Of Light Diffusion Layer

In the case where the layered product is resistant to an alkaline solution up to the light diffusion layer but the low refractive layer is insufficiently resistant to an alkaline solution, the layered product may be dipped in an alkaline solution after the formation of the light diffusion layer so that the both sides thereof are hydrophilicized, followed by the formation of the low refractive layer on the light diffusion layer. This method requires complicated productions steps but is advantageous in that the adhesion between the light diffusion layer and the low refractive layer can be enhanced if the low refractive layer is a layer having a hydrophilic group such as fluorine-containing sol-gel layer.

(5) Method which Comprises Forming a Light Diffusion Film or Anti-Reflection Film on a Saponified Triacetyl Cellulose Film

A light diffusion layer and a low refractive layer may be formed on any one side of a triacetyl cellulose film which has been previously saponified by dipping in an alkaline solution directly or with other layers interposed therebetween. When the triacetyl cellulose film is dipped in an alkaline solution to undergo saponification, the adhesion between the light diffusion layer or other layers and the triacetyl cellulose film which has been hydrophilicized by saponification can be deteriorated. In this case, the triacetyl cellulose film which has been saponified may be subjected to treatment such as corona discharge and glow discharge only on the side thereof where the light diffusion layer or other layers are formed so that the hydrophilicized surface can be removed before the formation of the hard coat layer or other layers. Further, in the case where the hard coat layer or other layers have a hydrophilic group, the interlayer adhesion may be good.

A polarizing plate comprising the light diffusion film or anti-reflection film of the invention and a liquid crystal display comprising the polarizing plate will be described hereinafter.

### [Polarizing Plate]

A preferred polarizing plate of the invention has a light diffusion film or anti-reflection film of the invention as at least one of the protective films for polarizing layer (polarizing plate protective film). The polarizing plate protective film preferably has a contact angle of from 10° to 50° with respect to water on the surface of the transparent substrate opposite the light diffusion layer or anti-reflection layer, i.e., on the side thereof where it is stuck to the polarizing layer as previously mentioned.

The use of the light diffusion film or anti-reflection film of the invention as a protective film for polarizing plate makes it possible to prepare a polarizing plate having a light diffusion or anti-reflection capacity excellent in physical strength and light-resistance and drastically reduce the cost and thickness of display device.

Further, the constitution of a polarizing plate comprising a light diffusion film or anti-reflection film of the invention as one protective film for polarizing plate and an optical compensation film having an optical anisotropy described later as the other protective film for polarizing layer makes it possible to prepare a polarizing plate that provides a liquid crystal display with an improved contrast in the daylight and a drastically raised horizontal and vertical viewing angle.

### [Optical Compensation Layer]

The polarizing plate may comprise an optical compensation layer (retarder layer) incorporated therein to improve the viewing angle properties of a liquid crystal display screen.

As the optical compensation layer there may be used any material known as such. In respect to the rise of viewing angle, there is preferably used an optical compensation layer having an optically anisotropic layer made of a compound having a discotic structural unit wherein the angle of the discotic compound with respect to the transparent support changes with the distance from the transparent support.

This angle preferably changes with the rise of the distance from the transparent support side of the optically anisotropic layer composed of discotic compound.

In the case where the optical compensation layer is used as a protective film for polarizing layer, the optical compensation layer is preferably saponified on the side thereof on which it is stuck to the polarizing layer. The saponification of the optical compensation layer is preferably conducted in the same manner as mentioned above.

### [Polarizing Layer]

As the polarizing layer there may be used a known polarizing layer or a polarizing layer cut out of a polarizing layer of continuous length having an absorption axis which is neither parallel to nor perpendicular to the longitudinal direction. The polarizing layer of continuous length having an absorption axis which is neither parallel to nor perpendicular to the longitudinal direction is prepared by the following method.

This is a polarizing layer stretched by tensing a continuously supplied polymer while being retained at the both ends thereof by a retainer. In some detail, the polarizing layer can be produced by a stretching method which comprises stretching the film by a factor of from 1.1 to 20.0 at least in the crosswise direction in such a manner that the difference in longitudinal progress speed of retainer between at both ends is 3% or less and the direction of progress of film is deflexed with the film retained at the both ends thereof such that the angle of the direction of progress of film at the outlet of the step of retaining both ends of the film with respect to the substantial direction of film stretching is from 20° to 70°. In particular, those obtained under the aforementioned conditions wherein the inclination angle is 45° are preferably used from the standpoint of productivity.

For the details of the method of stretching polymer film, reference can be made to JP-A-2002-86554, paragraphs [0020]-[0030].

### <Image Display Device, Liquid Crystal Display>

The light diffusion film and anti-reflection film of the invention can be applied to an image display device such as liquid crystal display (LCD), plasma display panel (PDP), electroluminescence display (ELD) and cathode ray tube display device (CRT). The light diffusion film and anti-reflection film of the invention have a transparent support and thus can be bonded to the image display surface of the image display device on the transparent substrate side thereof.

An embodiment of the application of the anti-reflection film 12 of the invention to image display devices or liquid crystal displays will be described in connection with the attached drawings.

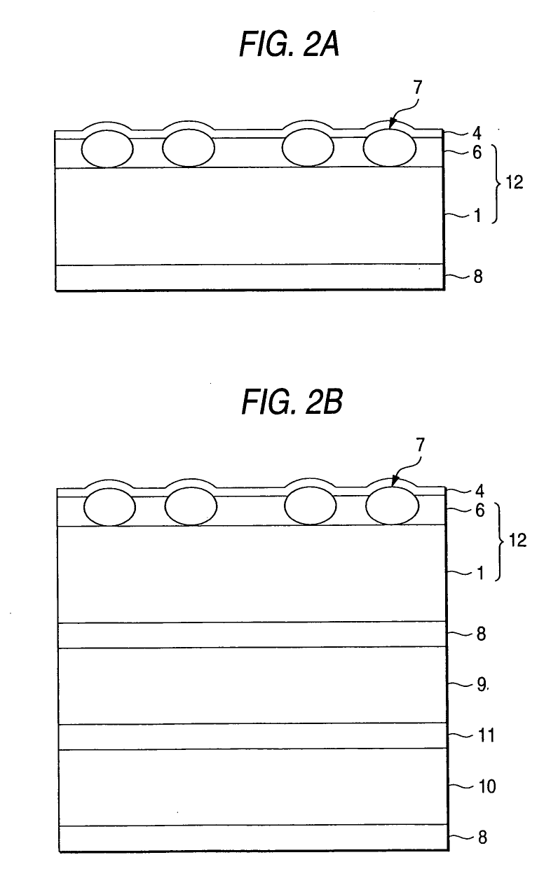

FIG. 2A is a schematic sectional view diagrammatically illustrating an embodiment of the application of the anti-reflection film 12 of the invention to image display devices. The anti-reflection film 12 is bonded to the display surface of an image display device on the transparent substrate 1 side thereof, which is opposite the low refractive index layer 4 as outermost layer, with an adhesive layer 8 interposed therebetween.

On the other hand, in the case where the anti-reflection film 12 of the invention is incorporated in a polarizing plate, the polarizing plate thus prepared may be applied to liquid crystal displays in any of the following arrangements.

FIG. 2B is a schematic sectional view diagrammatically illustrating an embodiment of the incorporation of the anti-reflection film 12 of the invention in a polarizing plate comprising a polarizer 11 and two sheets of protective films 9, 10 for protecting the respective side thereof. In this arrangement, the anti-reflection film 12 is bonded to the protective film 9 with an adhesive layer 8 interposed therebetween. The other protective film 10 is bonded to a liquid crystal cell (not shown) with an adhesive layer 8 interposed therebetween.

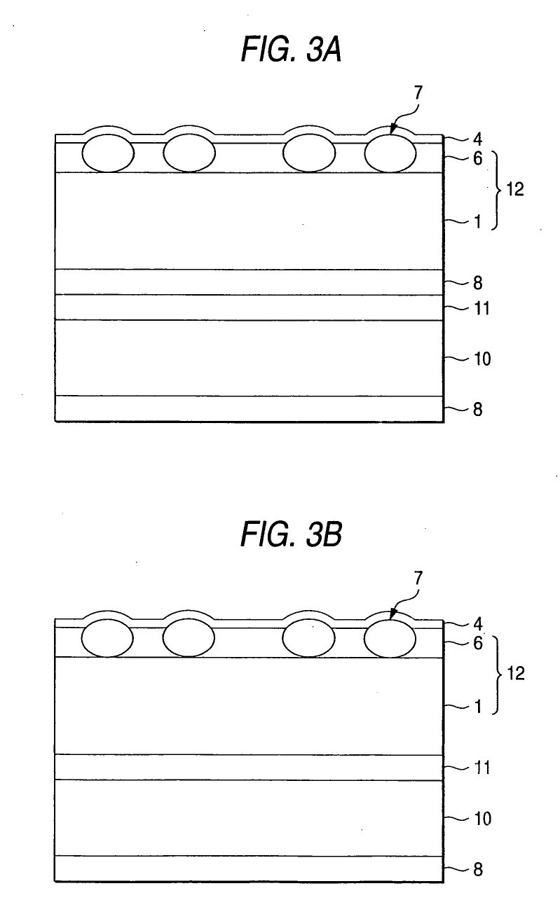

FIGS. 3C and 3D each are a schematic sectional view diagrammatically illustrating an embodiment of the incorporation of the anti-reflection film 12 of the invention as a protective film for polarizing plate. The anti-reflection film 12 is bonded to the polarizer 11 on the substrate 1 side thereof optionally with an adhesive layer 8 interposed therebetween. By bonding the protective film 10 of side opposite to the anti-reflection film 12 of the polarizer 11 to a liquid crystal cell (not shown) via an adhesive layer 8 interposed therebetween, the polarizing plate is applied to liquid crystal displays (bonded with an adhesive layer: FIG. 3C; bonded free from adhesive layer: FIG. 3D).

The light diffusion film or anti-reflection film of the invention, if used as one of polarizing layer surface protective films, is preferably used in transmission type, reflection type or transflective type liquid crystal displays of mode such as twisted nematic (TN), supertwisted nematic (STN), vertical alignment (VA), in-plane switching (IPS) and optically compensated bend cell (OCB). The light diffusion film or anti-reflection film of the invention may be preferably used in the mode of VA, IPS, OCB or the like for large-sized liquid crystal television sets or like purposes. The light diffusion film or anti-reflection film of the invention may also be preferably used in the mode of TN, STN or the like for small and middle-sized display devices having a low definition. Particularly preferred examples of large-sized liquid crystal television sets for which the light diffusion film or anti-reflection film of the invention can be used include those comprising a screen having a diagonal of 20 inch or more and having a definition of XGA or less (1,024×768 or less in a display device having an aspect ratio of 3:4).

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode, CAP mode) (as disclosed in Preprints of Symposium on Japanese Liquid Crystal Society Nos. 58 to 59, 1988 and (4) liquid crystal cell of SURVALVAL mode (as reported in LCD International 98).

An OCB mode liquid crystal cell is a liquid crystal cell of bend alignment mode wherein rod-shaped liquid crystal molecules are oriented in substantially opposing directions (symmetrically) from the upper part to the lower part of the liquid crystal cell as disclosed in U.S. Pat. Nos. 4,583,825 and 5,410,422. In the OCB mode liquid crystal cell, rod-shaped liquid crystal molecules are oriented symmetrically with each other from the upper part to the lower part of the liquid crystal cell. Therefore, the bend alignment mode liquid crystal cell has a self optical compensation capacity. Accordingly, this liquid crystal mode is also called OCB (optically compensatory bend) liquid crystal mode. The bend alignment mode liquid crystal display is advantageous in that it has a high response.

In ECB mode liquid crystal cell, rod-shaped liquid crystal molecules are oriented substantially horizontal when no voltage is applied thereto. The ECB mode liquid crystal cell is used mostly as a color TFT liquid crystal display. For details, reference can be made to many literatures, e.g., “EL, PDP, LCD Displays”, Toray Research Center, 2001.

### EXAMPLES

The invention will be further described in the following examples, but the invention is not limited thereto. The terms “parts” and “%” as used hereinafter are by weight unless otherwise specified.

### Curable Composition

### Purification Examples 1 to 5; Purification Example 20

A solvent of an unpurified fluorine-based copolymer in a solvent was allowed to stand under temperature and time conditions set forth in Table 2, and then subjected to pressure filtration through filters set forth in Table 2 so that it was purified.

### Purification Examples 6 to 10; Purification Example 21

Adsorbents set forth in Table 3 were each put into a flask in a solution of an unpurified fluorine-based copolymer in a solvent had been charged. The mixture was stirred using a magnetic stirrer under the temperature and time conditions set forth in Table 3, and then filtered so that it was purified.

TABLE 2

| | | Purification conditions | | | | | |
|---|---|---|---|---|---|---|---|
| | Fluorine- | Solvent | | Conditions under which the | | | |
| | based | (copolymer | | solution is allowed to stand | | | |
| | copolymer | concentration) | Filter | Temperature | | Time | |
| Purification | P-1 | 1-Methoxy-2- | Pore diameter: 0.5 μm; | 5° | C. | 12 | hr |
| Example 1 | | propanol (3%) | Profile II (Nippon Pall) | | | | |
| Purification | P-12 | 1-Methoxy-2- | Pore diameter: 0.2 μm; | 25° | C. | 12 | hr |
| Example 2 | | propanol (30%) | FR-20 (Fuji Photo Film | | | | |
| | | | Co., Ltd.) | | | | |
| Purification | P-13 | 1-Methoxy-2- | Pore diameter: 0.5 μm; | 25° | C. | 24 | hr |
| Example 3 | | propanol (30%) | TO20A47A (ADVANTEC) | | | | |
| Purification | P-19 | Methyl ethyl | Pore diameter: 0.5 μm; | 25° | C. | 10 | hr |
| Example 4 | | ketone (20%) | Profile II (Nippon Pall) | | | | |
| Purification | R-1 | Methyl ethyl | Pore diameter: 0.5 μm; | 5° | C. | 8 | hr |
| Example 5 | | ketone (20%) | Profile II (Nippon Pall) | | | | |
| Purification | P-1 | 1-Methoxy-2- | Pore diameter: 2.5 μm; | 25° | C. | 8 | hr |
| Example 20 | | propanol (3%) | FR-250 (Fuji Photo Film | (5° | C.) | (12 | hr) |
| | | | Co., Ltd.) | | | | |

TABLE 3

| | | Purification conditions | | | | | | |
|---|---|---|---|---|---|---|---|---|
| | | | | | Conditions under | | | |
| | Fluorine- | Solvent | | | which the solution | | | |
| | based | (copolymer | Adsorbent | | is allowed to stand | | | |
| | copolymer | concentration) | Kind | Amount | Temp. | | Time | Filter |
| Purification | P-1 | 1-Methoxy-2- | Synthetic adsorbent/ | 20% | 5° | C. | 2 hr | Qualitative filter |
| Example 6 | | propanol (3%) | Sepabead SP-207 | | | | | No. 2 (ADVANTEC) |
| | | | (Mitsubishi Chemical | | | | | |
| | | | Corporation) | | | | | |
| Purification | R-1 | Methyl ethyl | Active clay NV | 30% | 25° | C. | 4 hr | Glass filter P16 |
| Example 7 | | ketone (20%) | (Mizusawa Chemical) | | | | | (SIBATA) (pore |
| | | | | | | | | diameter 10-16 μm) |
| Purification | P-13 | 1-Methoxy-2- | Diatomaceous | 20% | 25° | C. | 8 hr | FR-250 (Fuji |
| Example 8 | | propanol (10%) | earth/Cellite No. 500 | | | | | Photo Film Co., |
| | | | (Cellite Co., Ltd.) | | | | | Ltd.) (pore |
| | | | | | | | | diameter: 2.5 μm) |
| Purification | P-19 | Methyl ethyl | Diatomaceous | 10% | 25° | C. | 1 hr | FR-100 (Fuji |
| Example 9 | | ketone (20%) | earth/Radiolite #100 | | | | | Photo Film Co., |
| | | | | | | | | Ltd.) (pore |
| | | | | | | | | diameter: 1.0 μm) |
| Purification | P-12 | 1-Methoxy-2- | Active alumina A-11 | 10% | 25° | C. | 2 hr | TO20A047A |
| Example 10 | | propanol (10%) | (Sumitomo Chemical) | | | | | (ADVANTEC) |
| | | | | | | | | (pore diameter: |
| | | | | | | | | 0.2 μm) |
| Purification | R-1 | Methyl ethyl | Activated charcoal | 30% | 25° | C. | 4 hr | Glass filter P16 |
| Example 21 | | ketone (20%) | | | | | | (SIBATA) (pore |
| | | | | | | | | diameter: 10-16 μm) |

* Proportion in polymer

### [Preparation of Light Diffusion Film Coating Solutions (HCL-1A) and (HCL-1B)]

| {Formulation of light diffusion film coating solution (HCL-1A)} | | |
|---|---|---|
| UV-curing resin “PETA” | 500.0 | parts |
| {produced by Nippon Kayaku Corporation} | | |
| Irgacure 184 | 20.0 | parts |
| Toluene dispersion of particulate crosslinked polystyrene (30%) | 17.0 | parts |
| [30 wt-% toluene dispersion of SX-350H (average particle diameter: 3.5 μm; produced by Soken | | |
| Chemical & Engineering Co., Ltd.) | | |
| Toluene dispersion of particulate crosslinked acryl-styrene (30%) | 133.0 | parts |
| [30 wt-% toluene dispersion of SX-350HL (average particle diameter: 3.5 μm; produced by Soken | | |
| Chemical & Engineering Co., Ltd.) | | |
| KBM-5103 | 100.0 | parts |
| {produced by Shin-Etsu Chemical Co., Ltd.} | | |
| Toluene | 385.0 | parts |
| {Formulation of light diffusion film coating solution (HCL-1B)} | | |
| UV-curing resin “PETA” | 500.0 | parts |
| {produced by Nippon Kayaku Corporation} | | |
| Irgacure 184 | 20.0 | parts |
| Toluene dispersion of particulate crosslinked polystyrene (30%) | 17.0 | parts |
| [30 wt-% toluene dispersion of SX-350H (average particle diameter: 3.5 μm; produced by Soken | | |
| Chemical & Engineering Co., Ltd.) | | |
| Toluene dispersion of particulate crosslinked acryl-styrene (30%) | 133.0 | parts |
| [30 wt-% toluene dispersion of SX-350HL (average particle diameter: 3.5 μm; produced by Soken | | |
| Chemical & Engineering Co., Ltd.) | | |
| KBM-5103 | 100.0 | parts |
| {produced by Shin-Etsu Chemical Co., Ltd.} | | |
| Toluene | 287.0 | parts |
| Cyclohexanone | 98.0 | parts |

The aforementioned coating solutions (HCL-1A) and (HCL-1B) were each filtered through a polypropylene filter having a pore diameter of 30 μm to prepare light diffusion film coating solutions.

### Preparation of Light Diffusion Film

### Preparation of Light Diffusion Film of Example 1-1

To the aforementioned light diffusion film coating solution (HCL-1A) was added the purified fluorine-based copolymer (leveling agent) set forth in Purification Example 1 in such an amount that the solid content reached 0.3 parts.

The coating solution for light diffusion layer (HCL-1A) having the aforementioned fluorine-based copolymer product incorporated therein was spread directly over a triacetyl cellulose film having a width of 1,340 m and a length of 2,600 m “TD80U” {produced by Fuji Photo Film Co., Ltd.} while being unwound from roll as a support (substrate) using a gravure coater having a gravure pattern with 135 lines per inch and a depth of 60 μm and a diameter of 50 mm and a doctor blade at a conveying speed of 15 m/min. The coat layer was dried at 60° C. for 150 seconds, and then irradiated with ultraviolet rays at an illuminance of 400 mW/cm² and a dose of 250 mJ/cm² using a 160 W/cm air-cooled metal halide lamp (produced by EYE GRAPHICS CO., LTD.) while the air in the system was being purged with nitrogen such that the oxygen concentration of the atmosphere reached 1.0 vol-% or less so that it was cured to form a light diffusion layer (HC-1) which was then wound. During this procedure, the rotary speed of the gravure roll was adjusted such that the light diffusion layer thus dried had an average thickness of 6.0 μm.

The light diffusion layer had a width of 1,300 mm and a length of 2,300 m after wound. The sample thus prepared was then visually examined for point defects over an area having a crosswise central width of 1,250 mm and a length of 80 m (100 m²). The results are set forth in Table 4. The number of point defects is represented by the average number of point defects per length of 10 m². Pint defects were visually observed by transmitted light from a fluorescent lamp. The size of point defects was determined by magnifying visually observed point defects 10-fold in a stereomicroscope reflection mode. The point defects thus visually observed had a diameter of 100 μm or more at minimum.

The occurrence of point defect with respect to Examples 1-7 and 1-14 was observed in more detail.

Concretely, a sample of 1,600 m (corresponding to 2,000 m²) was taken and marked every 8 m (corresponding to 8 m×1250 mm=10 m²) so as to be divided into 200 blocks. The occurrence of point defect with respect to each block was observed.

The total number of point defects occurred in Example 1-7 was 17. According to blocks, 17 blocks each has one point defect per block, and remaining 183 blocks have no point defects. There is no block having two or more point defects per block. In a portion with the least occurrence of point defect in the sample, successive 63 blocks (corresponding to 630 m²) have no point defects.

In Example 1-14, all 200 blocks have no point defects.

The haze was measured according to JIS-K7136. The evaluation of unevenness was effected in the following manner.

### (Evaluation of Unevenness)

A specimen having a length of 1 m was sampled from each of the various samples. These specimens were each pained with an oil-based black ink. These specimens were each placed almost horizontally on a desk in such an arrangement that the unpainted side thereof faces the observer. These specimens were each then visually observed for scattered light in the direction of 160° with respect to the surface thereof while being irradiated with fluorescent light in the direction of 30° with respect to the surface thereof (direction of 60° with respect to the line normal to the surface thereof). Unevenness was then evaluated according to the following criterion.

G: No unevenness observed;

F: Little or no unevenness observed; and

P: Definite unevenness observed

### Preparation of Light Diffusion Film of Examples 1-2 to 1-15; Comparative Examples 1-1 to 1-12

Light diffusion films of Examples 1-2 to 1-15 and Comparative Examples 1-1 to 1-12 were prepared in the same manner as in Example 1-1 except that the fluorine-based copolymer and its mixing proportion were changed as set forth in Table 4. These light diffusion films were each then examined for point defects in the same manner as in Example 1-1. The results are set forth in Table 4.

In Examples 1-5 and 1-6 and Comparative Example 1-2, as the fluorine-based copolymer there was used a 4:1 (parts by weight) mixture of a polymer of (P-1) Purification Example 1 and unpurified product of (P-1). In Comparative Example 1-1, no fluorine-based copolymer was added.

### Preparation of Light Diffusion Film of Example 1-16; Comparative Example 1-13

Light diffusion films of Example 1-16 and Comparative Example 1-13 were prepared in the same manner as in Example 1-2 and Comparative Example 1-4, respectively, except that the fluorine-based copolymer was changed to (HCL-1B). These light diffusion films were each then examined for point defects in the same manner as in Example 1-2. The results are set forth in Table 4.

TABLE 4

| | | | | | Mixing | Number | |
|---|---|---|---|---|---|---|---|
| | Coating | Fluorine-based | | | proportion | of point | |
| | solution | copolymer | Impurities | Haze | (parts) | defects | Unevenness |
| Example 1-1 | HCL-1A | (P-1) Polymer of | 0% | 35% | 0.1 | 0.2 | F |
| | | Purification | | | | | |
| | | Example 1 | | | | | |
| Example 1-2 | ″ | (P-1) Polymer of | 0% | 36% | 0.3 | 0.2 | G |
| | | Purification | | | | | |
| | | Example 1 | | | | | |
| Example 1-3 | ″ | (P-1) Polymer of | 0% | 36% | 0.6 | 0.3 | G |
| | | Purification | | | | | |
| | | Example 1 | | | | | |
| Example 1-4 | ″ | (P-1) Polymer of | 0% | 36% | 1.2 | 0.7 | G |
| | | Purification | | | | | |
| | | Example 1 | | | | | |
| Example 1-5 | ″ | (P-1) Polymer of | 0.1% | 36% | 1.2 | 0.7 | G |
| | | Purification | | | | | |
| | | Example 1 and | | | | | |
| | | Unpurified (P-1) | | | | | |
| Example 1-6 | ″ | (P-1) Polymer of | 0.1% | 36% | 1.2 | 0.7 | G |
| | | Purification | | | | | |
| | | Example 1 and | | | | | |
| | | Unpurified (P-1) | | | | | |
| Example 1-7 | ″ | (P-12) Polymer of | 0% | 36% | 0.3 | 0.1 | G |
| | | Purification | | | | | |
| | | Example 2 | | | | | |
| Example 1-8 | ″ | (P-13) Polymer of | 0% | 35% | 0.3 | 0.3 | G |
| | | Purification | | | | | |
| | | Example 3 | | | | | |
| Example 1-9 | ″ | (P-19) Polymer of | 0% | 35% | 0.3 | 0.1 | G |
| | | Purification | | | | | |
| | | Example 1 | | | | | |
| Example 1-10 | ″ | (R-1) Polymer of | 0.1% | 35% | 0.3 | 0.5 | G |
| | | Purification | | | | | |
| | | Example 5 | | | | | |
| Example 1-11 | ″ | (P-1) Polymer of | 0% | 36% | 0.3 | 0.1 | G |
| | | Purification | | | | | |
| | | Example 6 | | | | | |
| Example 1-12 | ″ | (R-1) Polymer of | 0% | 36% | 0.3 | 0.3 | G |
| | | Purification | | | | | |
| | | Example 7 | | | | | |
| Example 1-13 | ″ | (P-13) Polymer of | 0% | 36% | 0.3 | 0.2 | G |
| | | Purification | | | | | |
| | | Example 8 | | | | | |
| Example 1-14 | ″ | (P-19) Polymer of | 0% | 36% | 0.3 | 0.0 | G |
| | | Purification | | | | | |
| | | Example 9 | | | | | |
| Example 1-15 | ″ | (P-12) Polymer of | 0% | 36% | 0.3 | 0.0 | G |
| | | Purification | | | | | |
| | | Example 10 | | | | | |
| Example 1-16 | HCL-1B | (P-12) Polymer of | 0% | 36% | 0.3 | 0.3 | G |
| | | Purification | | | | | |
| | | Example 10 | | | | | |
| Comparative | HCL-1A | No addition | — | 35% | 0.0 | 0.0 | P |
| Example 1-1 | | | | | | | |
| Comparative | ″ | (P-1) Polymer of | 0.1% | 36% | 1.2 | 2.5 | G |
| Example 1-2 | | Purification | | | | | |
| | | Example 1 and | | | | | |
| | | Unpurified (P-1) | | | | | |
| Comparative | ″ | (P-1) unpurified | 0.5% | 35% | 0.1 | 2.1 | G |
| Example 1-3 | | | | | | | |
| Comparative | ″ | (P-1) unpurified | 0.5% | 35% | 0.3 | 3.6 | F |
| Example 1-4 | | | | | | | |
| Comparative | ″ | (P-1) unpurified | 0.5% | 35% | 0.6 | 10.5 | G |
| Example 1-5 | | | | | | | |
| Comparative | ″ | (P-1) unpurified | 0.5% | 35% | 1.2 | 43.5 | F |
| Example 1-6 | | | | | | | |
| Comparative | ″ | (P-12) unpurified | 0.6% | 36% | 0.3 | 5.3 | G |
| Example 1-7 | | | | | | | |
| Comparative | ″ | (P-13) unpurified | 0.5% | 35% | 0.3 | 4.7 | G |
| Example 1-8 | | | | | | | |
| Comparative | ″ | (P-19) unpurified | 0.4% | 35% | 0.3 | 2.3 | G |
| Example 1-9 | | | | | | | |
| Comparative | ″ | (R-1) unpurified | 1.1% | 35% | 0.3 | 15.6 | G |
| Example 1-10 | | | | | | | |
| Comparative | ″ | (P-1) Polymer of | 0.5% | 36% | 0.3 | 3.2 | G |
| Example 1-11 | | Purification | | | | | |
| | | Example 20 | | | | | |
| Comparative | ″ | (R-1) Polymer of | 0.8% | 36% | 0.3 | 8.3 | G |
| Example 1-12 | | Purification | | | | | |
| | | Example 21 | | | | | |
| Comparative | HCL-1B | (P-1) unpurified | 0.7% | 36% | 0.3 | 7.8 | G |
| Example 1-13 | | | | | | | |

In Table 4, the column “Impurities” indicates the content of impurities having a repeating unit corresponding to fluoroaliphatic group-containing monomer in a proportion of 70 mol-% or more in the fluorine-based polymer.

The content of impurities was calculated from the residue of filtration of a solution of unpurified or purified fluorine-based polymer in methanol through a microfilter made of polytetraethylene having a pore diameter of 0.05 μm.

When the impurities collected as filtration residue were measured for fluorine content by alizarine complexon method, it was confirmed that the impurities contain a repeating unit corresponding to fluoroaliphatic group-containing monomer in a proportion of 70 mol-%.

The results set forth in Table 4 make the following facts obvious.

In Examples 1-1 to 1-4, 1-7 to 1-10 and 1-12 to 1-15, which comprised a fluorine-based copolymer substantially free of impurities, there occurred little point defects. On the contrary, in Comparative Examples 1-3 to 1-13, which comprised a fluorine-based copolymer comprising more than 0.1% of impurities, there occurred much point defects. As can be seen in the results of evaluation of unevenness in Examples 1-1 to 1-4 and Comparative Examples 1-3 to 1-6, the added amount of a fluorine-based copolymer is preferably more than 0.1.

On the other hand, the results of Examples 1-5 and 1-6 and Comparative Example 1-2 show that the amount of the point defects increases with the added amount of the fluorine-based copolymer and exceeds 2.0 when the added amount of the fluorine-based copolymer is more than 1.0 part, demonstrating that the added amount of the fluorine-based copolymer is preferably 1.0 part or less.

Comparative Example 1-13, which was composed of a coating solution containing a cyclohexanone having a solubility parameter (SP value) of 9.9, showed the occurrence of more point defects than Comparative Example 1-3, which was composed of a coating solution free of cyclohexanone. This demonstrates that a coating solution containing a solvent having a solubility parameter of 9.5 or more can exert a more remarkable effect of the invention of preventing the occurrence of point defects.

10 specimens of each of the samples of Examples 1-1 to 1-13 and 1-16 and Comparative Examples 1-2 to 1-13 to be examined for point defects were measured for point defects by TOF-SIMS (Time of Flight-Secondary Ion Mass Spectrometry) method using a Type TRIFT II TOF-SIMS (produced by Phi Evans Inc.). As a result, most of these samples were observed to have CF fragments related to fluoro group of the copolymer in a circle region having a diameter of 50 μm within the point defect range 10 or more times in a normal site 10 cm apart from the point defect.

These point defect samples were each examined for the number of resin beads in a transmission mode at 500× magnification under optical microscope. As a result, in most of the samples, the average number of the particles having an average particle diameter of 1.0 μm to 15 μm present in a circle having a diameter of 100 μm within the point defects was less than ½ of the number of those particles present in a circle having a diameter of 100 μm within a normal portion.

{Formulation of light diffusion film coating solution (HCL-2)}

| | |
|---|---|
| Particulate ziroconia-containing hard coat composition | 612.0 parts |
| solution [Desolite Z7404] {particle diameter: 20 nm; | |
| produced by JSR Co., Ltd.} | |
| UV-curing resin “DPHA” | 174.0 parts |
| (produced by Nippon Kayaku Corporation) | |
| Silane coupling agent “KBM-5103” | 60.0 parts |
| {produced by Shin-Etsu Chemical Co., Ltd.} | |
| Particulate silica “KE-P150” | 53.4 parts |
| {1.5 μm; produced by NIPPON SHOKUBAI CO., LTD.) | |
| Particulate crosslinked PMMA “MSX-300” | 20.4 parts |
| {produced by Soken Chemical & Engineering Co., Ltd.} | |
| Methyl ethyl ketone (MEK) | 174.0 parts |
| Methyl isobutyl ketone (MIBK) | 78.0 parts |

The aforementioned coating solution (HCL-2) were each filtered through a polypropylene filter having a pore diameter of 30 μm to prepare a light diffusion film coating solution.

### Preparation of Light Diffusion Film of Example 2-1

To the aforementioned light diffusion film coating solution (HCL-2) was added the purified fluorine-based copolymer (leveling agent) set forth in Purification Example 1 in such an amount that the solid content reached 0.3 parts.

The coating solution for light diffusion layer (HCL-2) having the aforementioned fluorine-based copolymer product incorporated therein was spread directly over a triacetyl cellulose film having a width of 1,340 m and a length of 2,600 m “TD80U” {produced by Fuji Photo Film Co., Ltd.) while being unwound from roll as a substrate using a gravure coater having a gravure pattern with 135 lines per inch and a depth of 60 μm and a diameter of 50 mm and a doctor blade at a conveying speed of 15 m/min. The coat layer was dried at 60° C. for 150 seconds, and then irradiated with ultraviolet rays at an illuminance of 400 mW/cm² and a dose of 250 mJ/cm² using a 160 W/cm air-cooled metal halide lamp (produced by EYE GRAPHICS CO., LTD.) while the air in the system was being purged with nitrogen such that the oxygen concentration of the atmosphere reached 1.0 vol-% or less so that it was cured to form a light diffusion layer which was then wound. During this procedure, the rotary speed of the gravure roll was adjusted such that the light diffusion layer thus dried had an average thickness of 8.0 μm.

The light diffusion layer had a width of 1,300 mm and a length of 2,300 m after wound. The sample thus prepared was then visually examined for point defects over an area having a crosswise central width of 1,250 mm and a length of 2,000 m. The results are set forth in Table 5. The number of point defects is represented by the average number of point defects per length of 10 m². Pint defects were visually observed in the same manner as in Example 1-1. The point defects thus visually observed had a diameter of 100 μm or more at minimum.

### Preparation of Light Diffusion Film of Comparative Example 2-1

A light diffusion film of Comparative Example 2-1 was prepared in the same manner as in Example 2-1 except that the fluorine-based copolymer to be incorporated in the light diffusion layer coating solution (HCL-2) was replaced by the unpurified fluorine-based copolymer (P-1).

The light diffusion film thus prepared was then examined for point defects in the same manner as in Example 2-1. The results are set forth in Table 5.

{Formulation of light diffusion film coating solution (HCL-3)}

| | |
|---|---|
| Particulate ziroconia-containing hard coat composition | 680.0 parts |
| solution {[Desolite 7526] (except that the solvent | |
| formulation is modified)}(produced by JSR Co., Ltd.) | |
| 25 wt-% MIBK dispersion of particulate crosslinked | 110.0 part |
| polystyrene (3.5 μm) {SX-350H, produced by | |
| Soken Chemical & Engineering Co., Ltd.} | |
| 25 wt-% MIBK dispersion of particulate crosslinked | 144.5 part |
| polystyrene (5.0 μm) {SX-500H, produced by Soken | |
| Chemical & Engineering Co., Ltd.} | |
| Methyl isobutyl ketone | 65.5 parts |
| Methyl ethyl ketone | 120.0 parts |

The aforementioned coating solution (HCL-3) were each filtered through a polypropylene filter having a pore diameter of 30 μm to prepare a light diffusion film coating solution.

### Preparation of Light Diffusion Film of Example 3-1

To the aforementioned light diffusion film coating solution (HCL-3) was added the purified fluorine-based copolymer (leveling agent) set forth in Purification Example 1 in such an amount that the solid content reached 0.3 parts.

The coating solution for light diffusion layer (HCL-3) having the aforementioned fluorine-based copolymer product incorporated therein was spread directly over a triacetyl cellulose film having a width of 1,340 m and a length of 2,600 m “TD80U” {produced by Fuji Photo Film Co., Ltd.} while being unwound from roll as a substrate using a gravure coater having a gravure pattern with 135 lines per inch and a depth of 60 μm and a diameter of 50 mm and a doctor blade at a conveying speed of 15 m/min. The coat layer was dried at 60° C. for 150 seconds, and then irradiated with ultraviolet rays at an illuminance of 400 mW/cm² and a dose of 250 mJ/cm² using a 160 W/cm air-cooled metal halide lamp (produced by EYE GRAPHICS CO., LTD.) while the air in the system was being purged with nitrogen such that the oxygen concentration of the atmosphere reached 1.0 vol-% or less so that it was cured to form a light diffusion layer which was then wound. During this procedure, the rotary speed of the gravure roll was adjusted such that the light diffusion layer thus dried had an average thickness of 3.0 μm.

The light diffusion layer had a width of 1,300 nm and a length of 2,300 m after wound. The sample thus prepared was then visually examined for point defects over an area having a crosswise central width of 1,250 mm and a length of 2,000 m. The results are set forth in Table 5. The number of point defects is represented by the average number of point defects per length of 10 m². Pint defects were visually observed in the same manner as in Example 1-1. The point defects thus visually observed had a diameter of 100 μm or more at minimum.

### Preparation of Light Diffusion Film of Comparative Example 3-1

A light diffusion film of Comparative Example 3-1 was prepared in the same manner as in Example 3-1 except that the fluorine-based copolymer to be incorporated in the light diffusion layer coating solution (HCL-3) was replaced by the unpurified fluorine-based copolymer (P-1).

The light diffusion film thus prepared was then examined for point defects in the same manner as in Example 2-1. The results are set forth in Table 5.

TABLE 5

| | | | | Mixing | Number |
|---|---|---|---|---|---|
| | Coating | Fluorine-based | | proportion | of point |
| | solution | copolymer | Haze | (parts) | defects |
| Example 2-1 | HLC-2 | (P-1) Polymer of | 59% | 0.3 | 0.1 |
| | | Purification | | | |
| | | Example 1 | | | |
| Example 3-1 | HLC-3 | (P-1) Polymer of | 42% | 0.3 | 0.1 |
| | | Purification | | | |
| | | Example 1 | | | |
| Comparative | HLC-2 | (P-1) Unpurified | 59% | 0.3 | 2.3 |
| Example 2-1 | | | | | |
| Comparative | HLC-3 | (P-1) Unpurified | 42% | 0.3 | 7.8 |
| Example 3-1 | | | | | |

The results set forth in Table 5 make the following facts obvious.

Examples 2-1 and 3-1, which comprised a purified fluorine-based copolymer, showed the occurrence of few point defects. On the other hand, Comparative Examples 2-1 and 3-1, which comprised an unpurified fluorine-based copolymer, showed the occurrence of many point defects.

### <Preparation of Anti-Reflection Film>

### [Preparation of Sol a]

Into a reaction vessel equipped with an agitator and a reflux condenser were charged 120 parts by weight of methyl ethyl ketone, 100 parts by weight of acryloxypropyl trimethoxysilane “KBM-5103” (produced by Shin-Etsu Chemical Co., Ltd.) and 3 parts by weight of diisopropoxy aluminum ethyl acetoacetate “Kelope EP-12” (produced by Hope Chemical Co., Ltd.). These components were then stirred. To the mixture were then added 30 parts of deionized water. The reaction mixture was then reacted at 60° C. for 4 hours. The reaction mixture was then allowed to cool to room temperature to obtain a sol a. The weight-average molecular weight of the sol a thus obtained was 1,600. The proportion of the components having a weight-average molecular weight of from 1,000 to 20,000 in the oligomer components and higher components was 100%. The gas chromatography of the reaction product showed that none of the acryloyloxy propyl trimethoxysilane as raw material remained. The product was adjusted with methyl ethyl ketone such that the solid content concentration reached 29% to obtain a sol a.

{Formulation of low refractive index layer coating solution (LLL-1)}

| | | |
|---|---|---|
| Heat-crosslinkable fluorine-containing polymer “Opstar | 1300.0 | parts |
| JTA-113” {refractive index: 1.44; solid content: 6%; | | |
| produced by JSR Co., Ltd.) | | |
| Hollow silica A | 150.0 | parts |
| MEK-ST-L | 30.0 | parts |
| [silica sol; average particle diameter: 15 nm; solid | | |
| content concentration: 30%; solvent: MEK; produced by | | |
| NISSAN CHEMICAL INDUSTRIES, LTD.] | | |
| Sol a | 29.0 | parts |
| Cyclohexanone | 60.0 | parts |
| MEK | 487.0 | parts |

The “hollow silica A” is a hollow silica sol surface-modified with KBM-5103 {silane coupling agent produced by Shin-Etsu Chemical Co., Ltd.) {surface-modified hollow silica (prepared according to Preparation Example 4 in JP-A-2002-79616; average particle diameter: 40 nm; shell thickness: about 7 nm; refractive index of particulate silica: 1.31), solid content concentration: 26% by weight; solid content concentration attributed to particulate silica: 20% by weight; solid content concentration attributed to surface modifier: 6% by weight; solvent: MEK}.

### Preparation of Anti-Reflection Film of Example 4-1

The coating solution for low refractive index layer (LLL-1) was spread over the light diffusion film of Example 1-1 prepared above while being unwound from roll using a gravure coater having a gravure pattern with 180 lines per inch and a depth of 40 μm and a diameter of 50 mm and a doctor blade at a gravure roll rotary speed of 30 rpm and a conveying speed of 15 m/min. The coat layer was dried at 120° C. for 150 seconds, dried at 140° C. for 8 minutes, and then irradiated with ultraviolet rays at an illuminance of 400 mW/cm² and a dose of 900 mJ/cm² while the air in the system was being purged with nitrogen to form a low refractive index layer (LL-1) having a thickness of 100 nm which was then wound. Thus, an anti-reflection film sample (101) was prepared.

### Preparation of anti-reflection films of Examples 4-2 and 4-3

Anti-reflection films (Sample Nos. 101 and 103) of Examples 4-2 and 4-3 were prepared in the same manner as in Example 4-1 except that the film for light diffusion layer was replaced by the light diffusion films of Examples 2-1 and 3-1, respectively.

### [Saponification of Anti-Reflection Film]

The anti-reflection film samples thus prepared were each then subjected to the following treatment.

A 1.5 mol/l aqueous solution of sodium hydroxide was prepared and kept at 55° C. A 0.01 mol/l diluted aqueous solution of sulfuric acid was prepared and kept at 35° C. The anti-reflection films prepared above were each dipped in the aqueous solution of sodium hydroxide for 2 minutes, and then dipped in water so that the aqueous solution of sodium hydroxide was thoroughly removed. Subsequently, the anti-reflection films were each dipped in the diluted sulfuric acid for 1 minute, and then dipped in water so that the diluted sulfuric acid was thoroughly removed. Finally, the samples were each thoroughly dried at 120° C.

### [Evaluation of Anti-Reflection Film]

### (1) Average Reflectance

Using a spectrophotometer (produced by JASCO), the anti-reflection film samples were each measured for specular reflectance at an incidence angle of 5° in a wavelength region of from 380 to 780 nm. The measurements of specular reflectance were then averaged over the range of from 450 nm to 650 nm.

### (2) Evaluation of Resistance to Steel Wool (SW) Scratch

Using a rubbing tester, the various anti-reflection film samples were each subjected to rubbing test under the following conditions.

Evaluation environmental conditions: 25° C., 60% RH

Rubbing material: A steel wool “Grade No. 0000” (produced by Japan Steel Wool Co., Ltd.) was wound on the rubbing tip (1 cm×1 cm) of the tester which comes in contact with the sample. The steel wool was fixed to the tip with a band.

Moving distance (one way): 13 cm; rubbing speed: 13 cm/sec; load: 500 g/cm²; contact area of tip: 1 cm×1 cm; number of times of rubbing: 10 reciprocating movements

The sample thus rubbed was then coated with an oil-based black ink on the back side thereof. The rubbed surface of the sample was then visually observed by reflected light. The measurements were then evaluated according to the following criterion.

E: No scratches seen even when observed very carefully;

G: Slight scratches seen when observed very carefully;

GF: Slight scratches seen;

F: Middle level of scratches seen;

FP-P: Scratches seen at a glance

(3) Resistance to Rubbing with Rubber Eraser

The anti-reflection film samples were each fixed to the surface of glass with an adhesive. A rubber eraser “MONO” (trade name; produced by Tombow Pencil Co., Ltd.) was punched into a piece having a diameter of 8 mm and a thickness of 4 mm which was then used as head of a rubbing tester. The rubbing head was moved over the anti-reflection film sample back and forth 200 times at a stroke length of 3.5 cm and a rubbing speed of 1.8 cm/sec while being pressed vertically against the surface of the anti-reflection film sample at a load of 500 g/cm² under the conditions of 25° C. and 60RH %. The rubber eraser particles attached to the anti-reflection film sample was then removed. The sample was then visually observed on the rubbed area thereof. This test was effected three times. The measurements of degree of damage on the surface of the anti-reflection film were averaged. The results were then evaluated according to the following four-stage criterion.

G: Little or no scratch observed

F: Slight scratch observed

P: Definite scratch observed

PP: Scratch observed all over the rubbed area

### (4) Magic Ink Wipability

The anti-reflection film sample was fixed to the surface of glass with an adhesive. Three circles having a diameter of 5 mm were drawn on the anti-reflection film sample with a magic ink pen “Mackey Gokuboso” (trade name: produced by ZEBRA CO., LTD.) (fine penpoint) under the conditions of 25° C. and 60RH %. After 5 minutes, the anti-reflection film sample was wiped with BEMCOT (trade name: produced by ASAHI KASEI FIBERS CORPORATION) which had been folded ten times back and forth 20 times at a load such that the bundle of BEMCOT was intended. The procedure of drawing and wiping was repeated under the same conditions as mentioned above until the magic mark disappeared no longer when wiped. The time of repetition by which the magic mark can be wiped out was determined. This test was effected four times. The measurements were then averaged. The results were then evaluated according to the following four-stage criterion.

G: Magic mark wiped out 10 or more times

F: Magic mark wiped out several to less than 10 times

P: Magic mark wiped out only once

PP: Magic mark not wiped out even once

TABLE 6

| | | | | | Resistance to | |
|---|---|---|---|---|---|---|
| | Sample | Light | | Resistance to | rubber eraser | Magic ink |
| | No. | diffusion film | % Reflectance | SW rubbing | rubbing | wipability |
| Example 4-1 | 101 | Example 1-1 | 1.6 | E | G | G |
| Example 4-2 | 102 | Example 2-1 | 1.9 | E | G | G |
| Example 4-3 | 103 | Example 3-1 | 2.0 | E | G | G |

As can be seen in the results of Table 6, the use of the light diffusion film of the invention makes it possible to prepare an excellent anti-reflection film.

### Preparation of Polarizing Plate

### Examples 11-1 to 11-3

Subsequently, a triacetyl cellulose film having a thickness of 80 μm (TAC-TD80U, produced by Fuji Photo Film Co., Ltd.) was dipped in a 1.5 mol/1 aqueous solution of NaOH at 55° C. for 2 minutes, neutralized and then rinsed to produce a saponified triacetyl cellulose film. A polyvinyl alcohol was made to absorb iodine and stretched to produce a polarizer. The saponified treaceryl cellulose film was bonded to one side of the polarizer, and the saponified anti-reflection film sample 101 of Example 4-1 of the invention was bonded to the other side of the polarizer to produce a polarizing plate having anti-reflection property. The polarizing plate was then used to prepare a liquid crystal display having an anti-reflection layer disposed as outermost layer. These liquid crystal displays had a low reflectance, caused little reflection of external light, gave no remarkable reflected image and exhibited an excellent viewability. The liquid crystal display also was excellent in stainproofness, which was important in actual use.

The saponified anti-reflection film samples 102 and 103 prepared in Examples 4-2 and 4-3 showed the same results in the sample 101.

### Examples 21-1 and 21-2

A triacetyl cellulose film having a thickness of 80 μm (TAC-TD80U, produced by Fuji Photo Film Co., Ltd.), which had been dipped in a 1.5 mol/1 aqueous solution of NaOH at 55° C. for 2 minutes, neutralized and then rinsed, and the saponified anti-reflection film sample 101 of Example 4-1 were bonded to sides of a polarizer prepared by allowing a polyvinyl alcohol film to adsorb iodine and then stretching the film to protect the polarizer. Thus, a polarizing plate was prepared. The polarizing plate thus prepared was then bonded to the liquid crystal display of a note personal computer having a transmission type TN liquid crystal display incorporated therein (comprising D-BEF, which is a polarization separating film having a polarization selective layer produced by Sumitomo 3M Co., Ltd., provided interposed between a backlight and a liquid crystal cell) with the anti-reflection layer disposed at outermost surface to replace the polarizing plate on the viewing side thereof. As a result, a display device which shows a high reflectance, causes extremely little reflection of background and exhibits a very high display quality and an excellent stainproofness was obtained.

The saponified anti-reflection film samples 102 and 103 prepared in Examples 4-2 and 4-3 showed the same results in the sample 101.

### Liquid Crystal Display

### Examples 31-1 to 31-3

As each of the protective film on the liquid crystal side of the polarizing plate on the viewing side and the protective film on the liquid crystal cell side of the polarizing plate on the backlight side of the transmission type TN liquid crystal cell comprising the anti-reflection film samples 101 to 103 bonded thereto there was used a wide view film (Wide View Film SA 12B, produced by Fuji Photo Film Co., Ltd.). As a result, a liquid crystal display having very wide vertical and horizontal viewing angles, an extremely excellent viewability and a high display quality was obtained.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-132238 filed Apr. 28 of 2005, the contents of which are incorporated herein by reference.

What is claimed is:

1. A method for producing a light diffusion film that comprises a transparent plastic film; a light diffusion layer formed from a curable composition comprising a leveling agent and particles having an average particle diameter of 1.0 μm to 15 μm, the light diffusion layer having an average thickness of 1.0 μm to 40 μm, wherein the light diffusion film has a haze of 3% or more,
wherein the leveling agent is a first copolymer that includes a repeating unit corresponding to a monomer represented by formula (1) in a proportion of 10 to 60 mol-% on average,
the method comprising, before adding the leveling agent into the curable composition, removing an amount of a second copolymer that includes the repeating unit corresponding to the monomer represented by formula (1) in a proportion of 70 mol-% or more so that an amount of the second copolymer is 0.1% or less in the leveling agent: 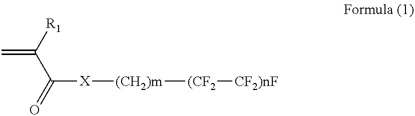
wherein R₁ represents a hydrogen atom or methyl group; X represents an oxygen atom, sulfur atom or —N(R₂)—; m represents an integer of 1 to 6; n represents an integer of 1 to 5;
and R₂ represents a hydrogen atom or C₁-C₄ alkyl group.

2. The method according to claim 1, wherein the removing of the second copolymer comprises: after synthesizing a copolymer including the repeating unit corresponding to the monomer represented by formula (1), dissolving the copolymer in a solvent; and bringing the solution into contact with an inorganic adsorbent comprising a silicon oxide, an aluminum oxide or a mixture thereof in an amount of 80% by weight or more.

3. The method according to claim 1, wherein the removing of the second copolymer comprises: after synthesizing a copolymer including the repeating unit corresponding to the monomer represented by formula (1), dissolving the copolymer in a solvent; and bringing the solution into contact with an organic adsorbent.

4. The method according to claim 1, wherein the removing of the second copolymer comprises: after synthesizing a copolymer including the repeating unit corresponding to the monomer represented by formula (1), dissolving the copolymer in a solvent, and filtering the solution through a filter having a pore diameter of 1 μm or less.
